(19) United States
(12) Patent Application Publication
(10) Pub. No.: US 2009/0141802 A1
(43) Pub. Date: Jun. 4, 2009

(54) MOTION VECTOR DETECTING APPARATUS, MOTION VECTOR DETECTING METHOD, AND PROGRAM

(75) Inventors: Hiroki TETSUKAWA, Kanagawa (JP); Tetsujiro KONDO, Tokyo (JP); Kenji TAKAHASHI, Kanagawa (JP); Kazushi YOSHIKAWA, Tokyo (JP); Naoki TAKEDA, Tokyo (JP); Takanori ISHIKAWA, Saitama (JP); Takashi HORISHI, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/255,079

(22) Filed: Oct. 21, 2008

(30) Foreign Application Priority Data
Nov. 29, 2007 (JP) 2007-309220
Aug. 27, 2008 (JP) 2008-218803

(51) Int. Cl. H04N 11/02; H04B 1/66; H04N 7/12

(52) U.S. Cl. 375/240.16; 348/699; 348/E05.066; 375/E07.1; 375/E07.104

(57) ABSTRACT

A motion vector detecting apparatus includes an evaluation value information forming unit, a motion vector extracting unit, and a motion vector deciding unit. The evaluation value information forming unit is configured to form evaluation value information on motion vectors evaluating that a reference pixel is a potential movement destination candidate for a focus pixel. The evaluation value information on the motion vectors is generated from pixel value correlation information that has been one of generated and limited using a movement direction of the pixels. The motion vector extracting unit is configured to extract motion vectors as candidates from a plurality of motion vectors based on the evaluation value information formed by the evaluation value information forming unit. The motion vector deciding unit is configured to decide motion vectors to be assigned to pixels in a frame from the motion vectors extracted as the candidates by the motion vector extracting unit.

### CROSS REFERENCES TO RELATED APPLICATIONS

The present invention contains subject matter related to Japanese Patent Application JP 2007-309220 filed on Nov. 29, 2007 and Japanese Patent Application JP 2008-218803 filed on Aug. 27, 2008 in the Japanese Patent Office respectively, the entire contents of which being incorporated herein by reference.

### BACKGROUND OF THE INVENTION

1. Field of the Invention

The present invention relates to a motion vector detecting apparatus and a motion vector detecting method that are suitably applied when detecting a motion vector from moving image data and carrying out image processing such as high-efficiency encoding, and also to a program that carries out a motion vector detecting process.

2. Description of the Related Art

In the past, in the field of moving image processing, motion information, that is, information on the direction of motion and the size of an object in images at different points in time, has been used to efficiently carry out image processing. For example, motion detection results are used during motion-compensated interframe encoding as part of high-efficiency encoding of images or during motion-based parameter control by a television noise reduction apparatus that uses an interframe time domain filter. Block matching is known as one method of calculating motion. During block matching, a one-frame image is divided into blocks that are units of a predetermined number of pixels and a search is conducted to find regions to which such blocks have moved. A motion vector detecting process that uses block matching has been commercialized by MPEG methods and the like, and image processing that uses motion vectors has become established as the most typical type of processing.

However, since block matching is processing that is carried out in block units, the detection of motion in each frame image will not necessarily be carried out with very high precision. For this reason, the present applicant proposed the motion vector detecting process disclosed in Japanese Unexamined Patent Application Publication No. 2005-175869. In this motion vector detecting process, evaluation values relating to motion for each pixel position are detected from an image signal, the detected evaluation values are held as an evaluation value table, and a plurality of vectors are extracted from the data in the evaluation value table as candidate vectors for the image. After this, for the plurality of candidate vectors that have been extracted, the correlation of pixels across frames that are associated by candidate vectors is determined for each pixel in every frame, and candidate vectors that connect pixels determined to have the highest correlation are decided as the motion vectors for such pixels. Such processing will be described in detail later in the embodiments of the invention.

FIG. 1 is a diagram showing the configuration of an evaluation value table forming unit that has been proposed for the case where motion vectors are decided using such evaluation value table. With the configuration shown in FIG. 1, an image signal obtained at an input terminal 1 is supplied to a correlation calculating unit 2. The correlation calculating unit 2 includes a focus pixel memory 2a, a subtractor 2b, and an absolute value calculating unit 2c. Out of the image signal obtained at the input terminal 1, the pixel values of focus pixels are stored in the focus pixel memory 2a. A difference across frames between a pixel value of a focus pixel stored in the focus pixel memory 2a and a pixel value of a reference pixel input into the input terminal 1 is calculated by the subtractor 2b. The detected difference data is supplied to the absolute value calculating unit 2c and data showing the absolute value of the difference is supplied to a correlation determining unit 3. The correlation determining unit 3 includes a comparator unit 3a and compares the difference with a set threshold to obtain an evaluation value. As one example of the evaluation value, it is possible to use a correlation value, and when the difference is equal to or below the threshold, as one example the correlation value may be set as “high”.

The evaluation value obtained by the correlation determining unit 3 is supplied to an evaluation value table calculating unit 4 where the evaluation value is totaled by an evaluation value totaling unit 4a and the totaling result is stored in an evaluation value table memory 4b. The stored data of the evaluation value table memory 4b is supplied from an output terminal 5 as evaluation value table data to a circuit that forms the next stage.

FIGS. 2A and 2B show an overview of processing that decides a motion vector using the existing evaluation value table according to FIG. 1. As shown in FIG. 2A, first, a pixel position, which forms a standard for determining a motion vector, inside a previous frame F0 that is image data of one frame preceding the present frame F1 is set as a focus pixel d0. Once the focus pixel d0 has been decided, a search area SA with a predetermined range in the periphery of the pixel position of the focus pixel d0 is set in the present frame F1. Once the search area SA has been set, evaluation values are calculated with each pixel inside the search area SA as the reference pixel d1 and the evaluation values are recorded in the evaluation value table. Out of the values registered in the evaluation value table, the reference pixel with the highest evaluation value in the search area SA is found as the pixel position in the present frame to which the focus pixel in the previous frame has moved. By calculating the reference pixel with the highest evaluation value in this way, as shown in FIG. 2B, a motion vector is decided from the amount of movement between the reference pixel with the highest evaluation value and the focus pixel.

By carrying out the processing shown in FIGS. 1 to 2B, it is possible to detect motion vectors based on the evaluation value table data.

### SUMMARY OF THE INVENTION

When motion vectors are detected based on the evaluation value table data, the extent to which optimal motion vectors are decided will depend on the performance of the evaluation value table. According to the existing method shown in FIG. 1, the correlation between the focus pixel and candidate motion destination pixels in the search area in a future frame (i.e., the present frame) is determined and more specifically when the absolute value of the difference in luminance values is equal to or below the threshold, a count value in the evaluation value table is counted up to show a motion candidate.

However, in the processing by the existing method, for an image where there is almost no spatial gradient in some directions or in every direction, such as at positions where stripes or flat blocks of color appear in the image, if the evaluation value table is produced by merely determining the correlation as described above, there is the possibility of erroneous movements being included, which reduces the reliability of the evaluation value table. If the reliability of the evaluation value table falls, the precision of the motion vectors that are detected will also fall.

Also, if an existing evaluation value table is used, since erroneous movements will also be included when a plurality of different movements occur in the same image, the evaluation values caused by the actual movements will no longer stand out, which makes it difficult to detect the respective motion vectors.

It is desirable to improve the precision when detecting motion vectors using evaluation value information for motion vectors. It is further desirable to make it possible to detect a plurality of movements when a plurality of different movements are present.

The present invention is applied in the case where motion vectors are detected from moving image data. As the processing, evaluation value information is generated based on pixel value correlation information across a plurality of frames, and motion vectors are extracted for pixels that compose a frame in the moving image data based on the evaluation value table. After this, motion vectors are decided out of the motion vectors extracted as candidates. According to an embodiment of the present invention, evaluation value information can be formed from pixel value correlation information generated based on the movement direction of pixels.

According to an embodiment of the present invention, when the motion vectors are detected from the candidate vectors, information based on the movement direction of the pixel is used as the evaluation value information for obtaining the candidate vectors. This makes it possible to obtain pixel value correlation information that is narrowed to actual candidates and therefore a suitable evaluation value table can be obtained.

According to an embodiment of the present invention, when generating evaluation value information that is a frequency distribution of a correlation determination result, by considering information based on the movement direction or orientation of motion of the focus pixel and/or information based on the movement direction of a pixel that is a movement destination candidate, it is possible to reduce the number of erroneous movements for flat blocks of color or repeated patterns in an image. Accordingly, it is possible to generate evaluation value information that is highly reliable and to improve the precision of the detected motion vectors. In the case where a plurality of movements are present in the search area, for example, it is possible to obtain suitable evaluation values for the respective movements and simultaneously calculate the plurality of movements.

### BRIEF DESCRIPTION OF THE DRAWINGS

FIG. 1 is a block diagram showing one example of existing processing that generates evaluation value table data;

FIGS. 2A and 2B are diagrams useful in explaining an overview of the existing processing that generates evaluation value table data;

FIG. 3 is a block diagram showing one example of the overall configuration of a motion vector detecting apparatus according to an embodiment of the present invention;

FIG. 4 is a flowchart showing one example of the overall processing according to an embodiment of the present invention;

FIG. 5 is a block diagram showing an example of processing that obtains evaluation value table data according to a first embodiment of the present invention (example 1: where a spatial gradient in the orientation of motion at the focus pixel is taken into account);

FIG. 6 is a flowchart showing an example of processing with the example shown in FIG. 5;

FIGS. 7A to 7C are diagrams useful in explaining an overview of processing with the example shown in FIG. 5;

FIG. 8 is a block diagram showing an example of processing that obtains evaluation value table data according to a first embodiment of the present invention (example 2: where an LUT is used when a spatial gradient in the orientation of motion of the focus pixel is taken into account);

FIG. 9 is a flowchart showing an example of processing with the example shown in FIG. 8;

FIG. 10 is a diagram useful in explaining an example of a test image;

FIG. 11 is a characteristics graph showing an example of an evaluation value table generated by an existing determination of correlation for the test image in FIG. 10;

FIG. 12 is a characteristics graph showing an example of an evaluation value table generated with the example shown in FIG. 5 for the test image in FIG. 10;

FIG. 13 is a block diagram showing an example of processing that obtains evaluation value table data according to a second embodiment of the present invention (example 1: where spatial gradients in the orientation of motion at the focus pixel and the reference pixel are taken into account);

FIG. 14 is a flowchart showing an example of processing with the example shown in FIG. 13;

FIGS. 15A to 15B are diagrams useful in explaining an overview of processing with the example shown in FIG. 13;

FIG. 16 is a block diagram showing an example of processing that obtains evaluation value table data according to a second embodiment of the present invention (example 2: where an LUT is used when spatial gradients in the orientation of motion at the focus pixel and the reference pixel are taken into account);

FIG. 17 is a flowchart showing an example of processing with the example shown in FIG. 16;

FIG. 18 is a characteristics graph showing an example of an evaluation value table generated with the example shown in FIG. 13 for the test image in FIG. 10;

FIG. 19 is a block diagram showing an example of processing that obtains evaluation value table data according to a third embodiment of the present invention (example 1: where spatial gradients in the orientation of motion at the focus pixel and the reference pixel are taken into account);

FIG. 20 is a flowchart showing an example of processing with the example shown in FIG. 19;

FIGS. 21A to 21C are diagrams useful in explaining an overview of processing with the example shown in FIG. 20;

FIG. 22 is a block diagram showing an example of processing that obtains evaluation value table data according to a third embodiment of the present invention (example 2: where an LUT is used when spatial gradients in the orientation of motion at the focus pixel and the reference pixel are taken into account);

FIG. 23 is a flowchart showing an example of processing with the example shown in FIG. 22;

FIG. 24 is a flowchart showing an example (example 1) of processing according to a fourth embodiment of the present invention where spatial gradients in the orientation of motion and the directions of normals at the focus pixel and the reference pixel are taken into account;

FIGS. 25A to 25C are diagrams useful in explaining an overview of processing with the example shown in FIG. 24;

FIG. 26 is a flowchart showing an example (example 2) of processing according to a fourth embodiment of the present invention that uses an LUT and where spatial gradients in the orientation of motion and the directions of normals at the focus pixel and the reference pixel are taken into account;

FIGS. 27A to 27C are diagrams useful in explaining an overview of processing with the example shown in FIG. 26;

FIG. 28 is a characteristics graph showing an example of an evaluation value table generated with the example shown in FIG. 19;

FIG. 29 is a characteristics graph showing an example of an evaluation value table generated with the example shown in FIG. 24;

FIG. 30 is a block diagram showing an example of processing that obtains evaluation value table data according to a fifth embodiment of the present invention (example 1: where spatial gradients in the opposite direction at the focus pixel and the reference pixel are taken into account);

FIG. 31 is a flowchart showing an example of processing with the example shown in FIG. 30;

FIGS. 32A to 32C are diagrams useful in explaining an overview of processing with the example shown in FIG. 30;

FIG. 33 is a block diagram showing an example of processing that obtains evaluation value table data according to a fifth embodiment of the present invention (example 2: where an LUT is used when spatial gradients in the opposite direction at the focus pixel and the reference pixel are taken into account);

FIG. 34 is a flowchart showing an example of processing with the example shown in FIG. 33;

FIGS. 35A to 35C are diagrams useful in explaining an overview of processing with the example shown in FIG. 33;

FIG. 36 is a characteristics graph showing an example of an evaluation value table generated with the example shown in FIG. 33;

FIG. 37 is a flowchart showing a processing example that takes into account spatial gradients in the opposite direction to the movement of the focus pixel and in the directions of normals;

FIGS. 38A to 38C are diagrams useful in explaining an overview of processing with the example shown in FIG. 37;

FIG. 39 is a block diagram showing an example of processing that obtains evaluation value table data according to a sixth embodiment of the present invention (example 1: where spatial gradients on levels in the orientation of motion at the focus pixel and the reference pixel are taken into account);

FIG. 40 is a flowchart showing an example of processing with the example shown in FIG. 39;

FIGS. 41A and 41B are diagrams showing examples of levels at the focus pixel;

FIGS. 42A and 42B are diagrams showing examples of levels at the reference pixel;

FIGS. 43A and 43B are diagrams useful in explaining an overview of processing with the example shown in FIG. 39;

FIG. 44 is a block diagram showing an example of processing that obtains evaluation value table data according to a sixth embodiment of the present invention (example 2: where an LUT is used when spatial gradients on levels in the orientation of motion at the focus pixel and the reference pixel are taken into account);

FIG. 45 is a flowchart showing an example of processing with the example shown in FIG. 44;

FIG. 46 is a characteristics graph showing an example of an evaluation value table generated with the example shown in FIG. 39 for the test image in FIG. 10;

FIG. 47 is a block diagram showing an example configuration of a motion vector extracting unit according to an embodiment of the present invention;

FIG. 48 is a flowchart showing an example of processing with the example shown in FIG. 47;

FIG. 49 is a block diagram showing an example configuration of a motion vector deciding unit according to an embodiment of the present invention;

FIG. 50 is a flowchart showing an example of processing with the example shown in FIG. 49; and

FIG. 51 is a diagram useful in showing an example of a motion vector deciding process with the example shown in FIG. 49.

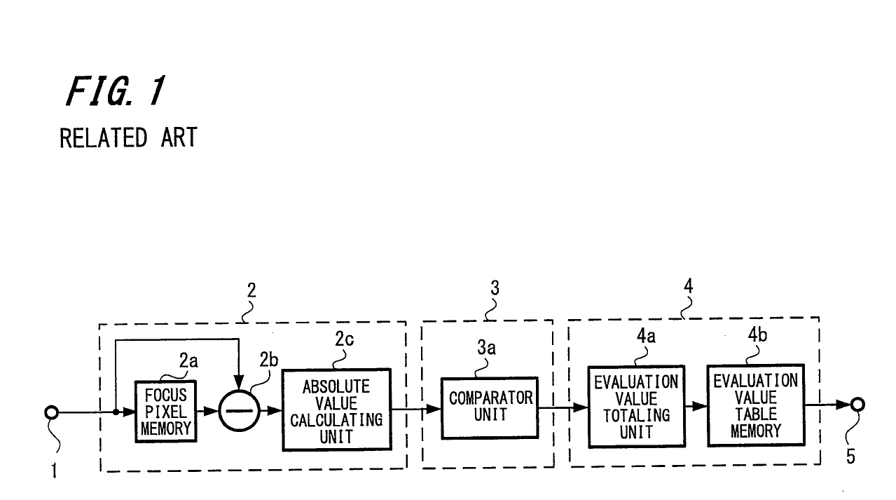

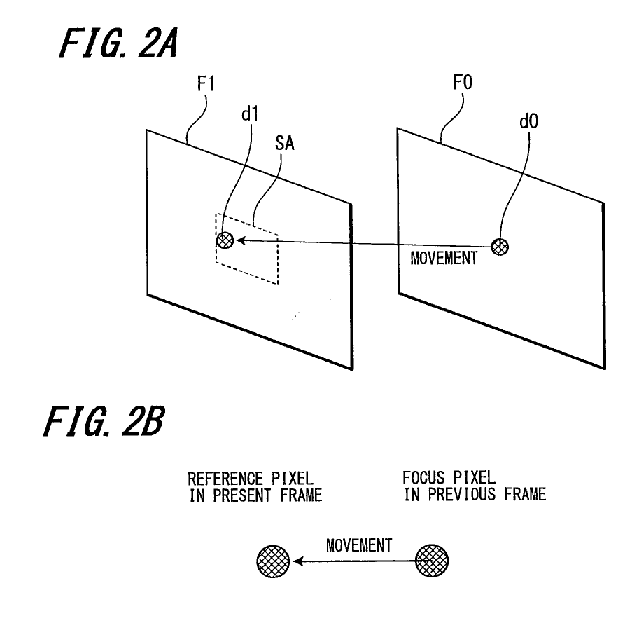

### DETAILED DESCRIPTION OF THE PREFERRED EMBODIMENTS

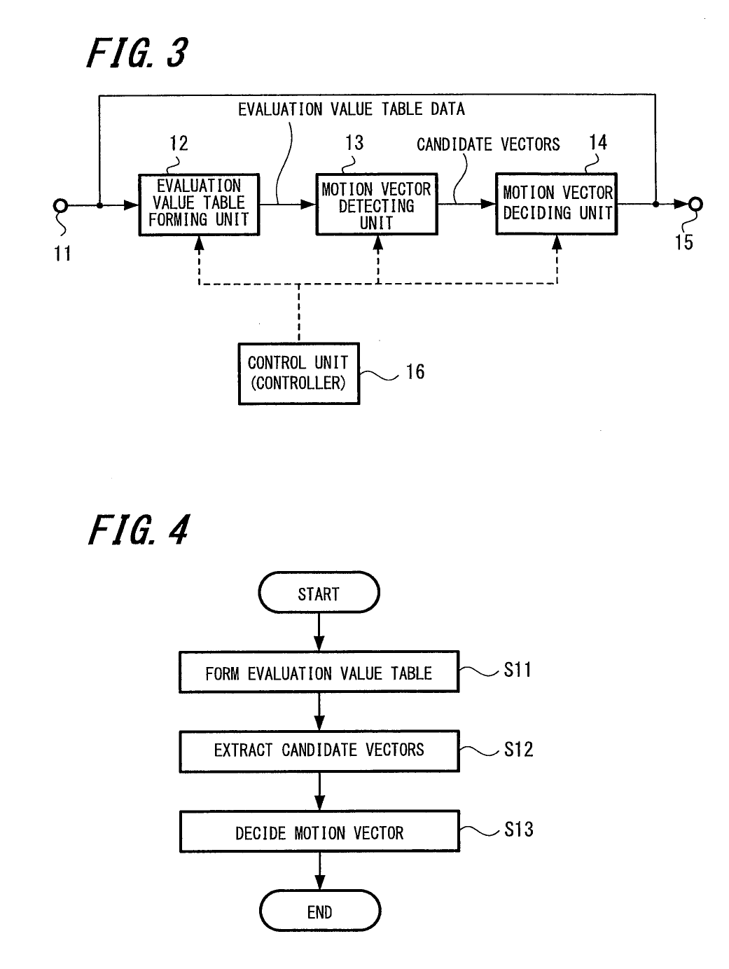

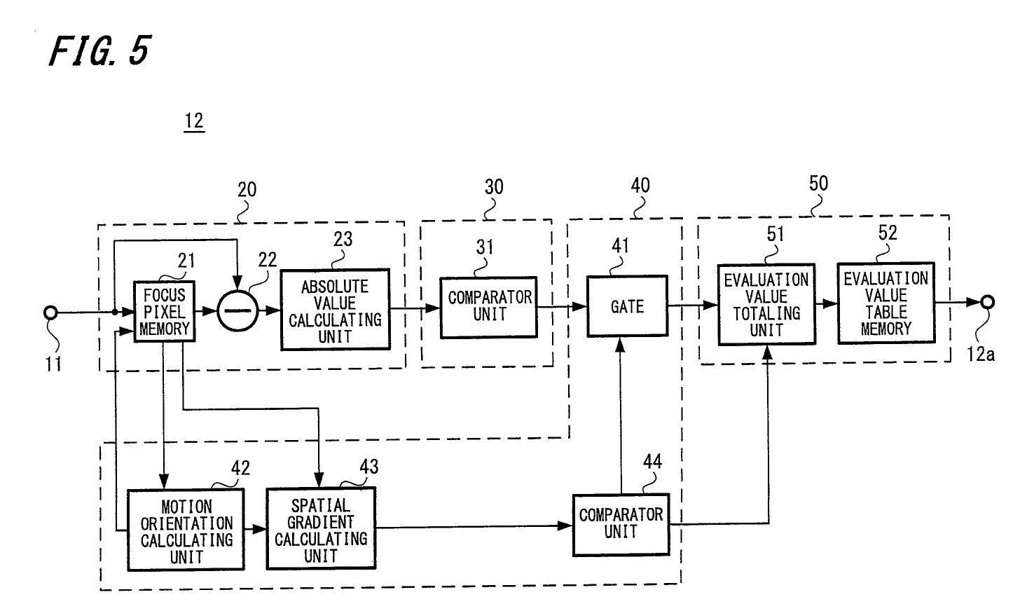

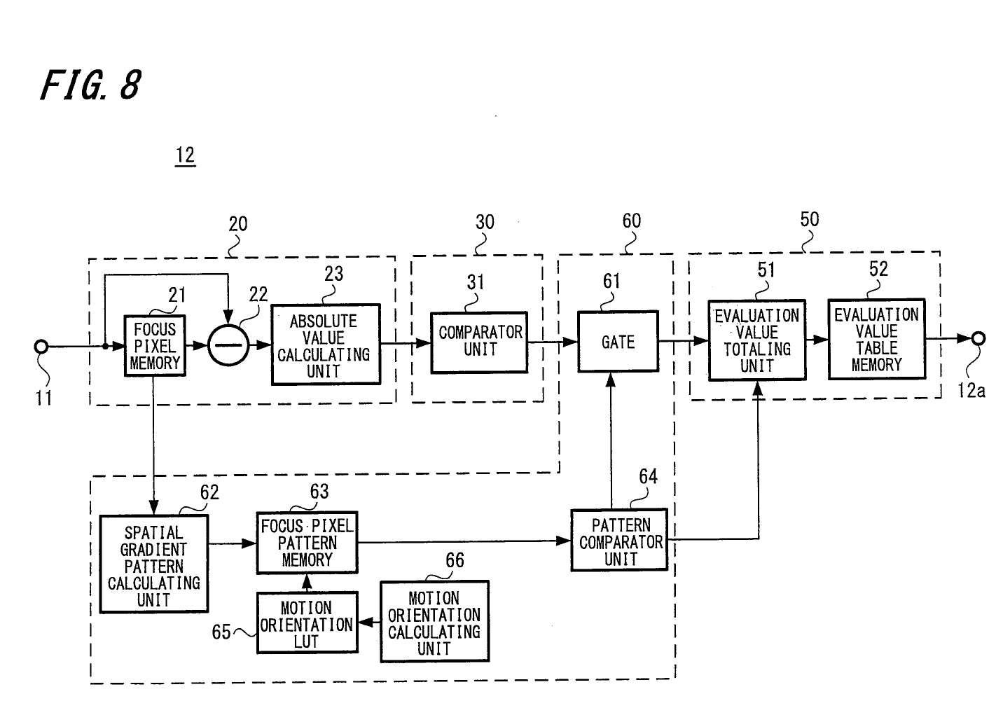

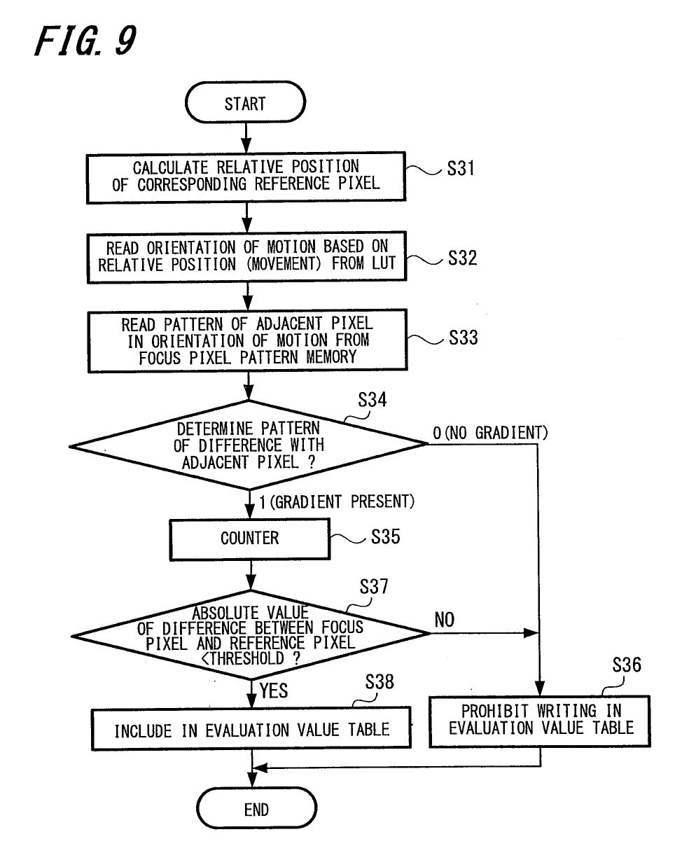

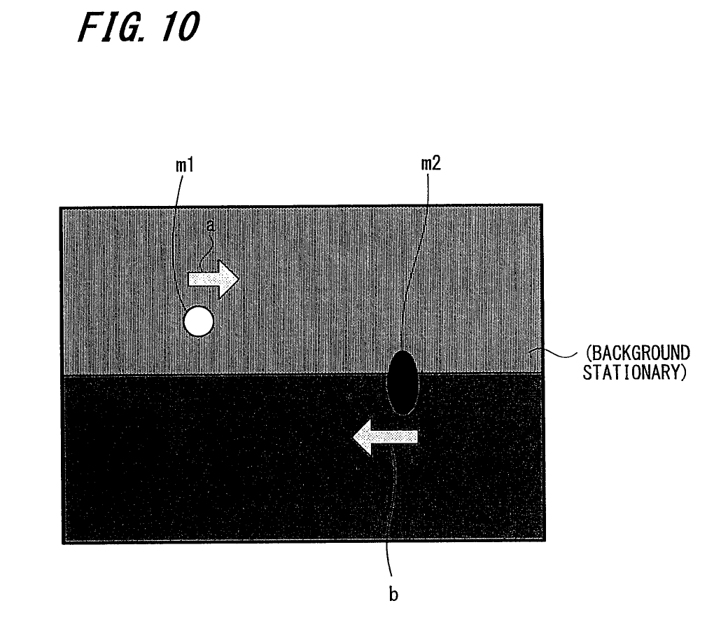

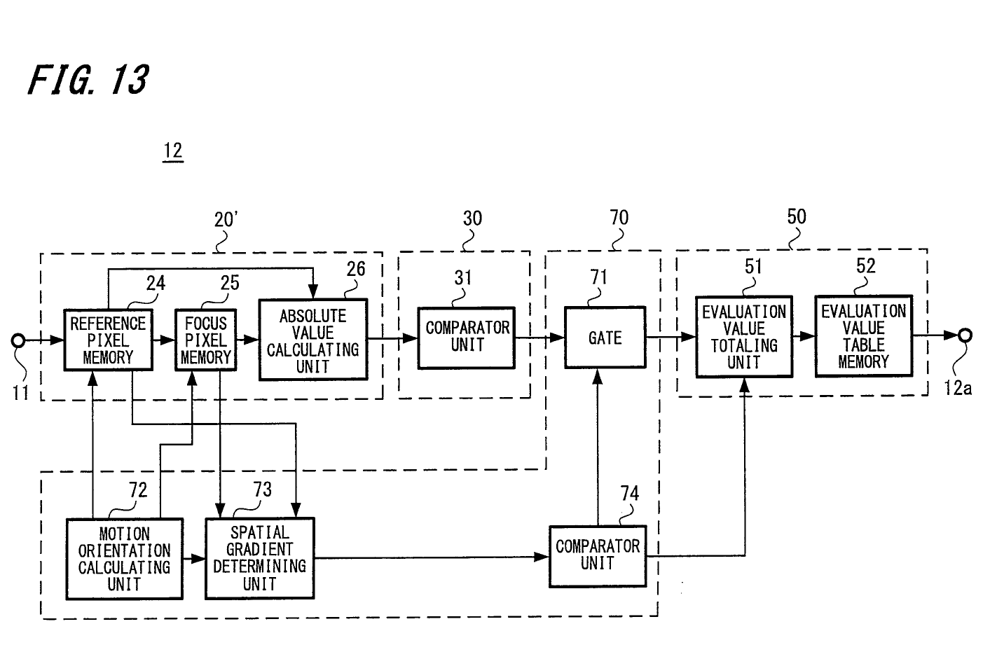

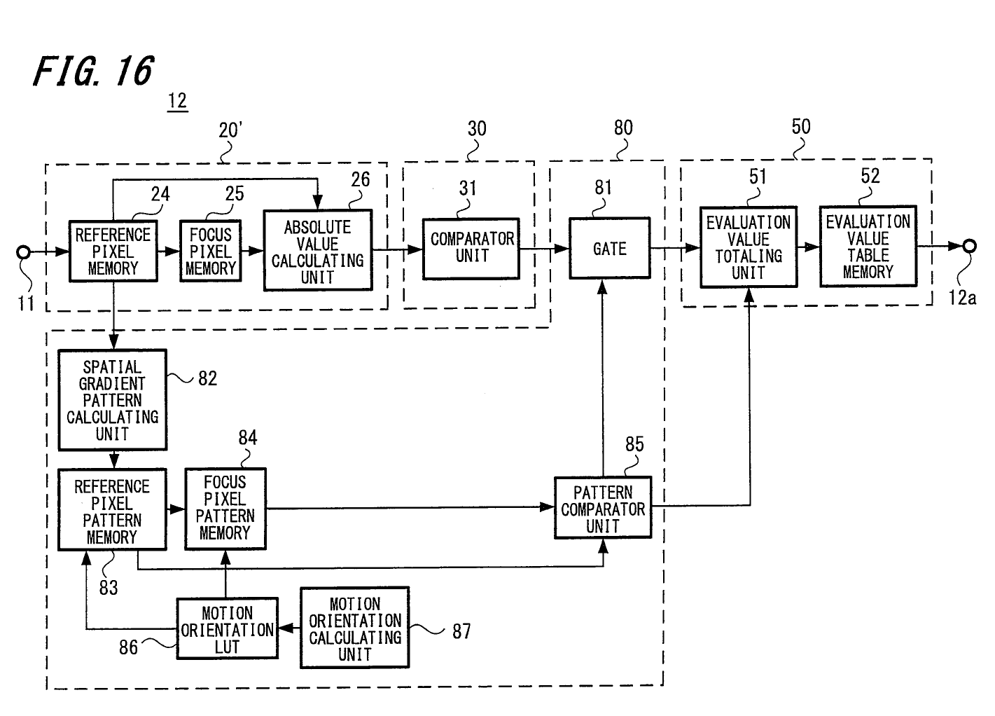

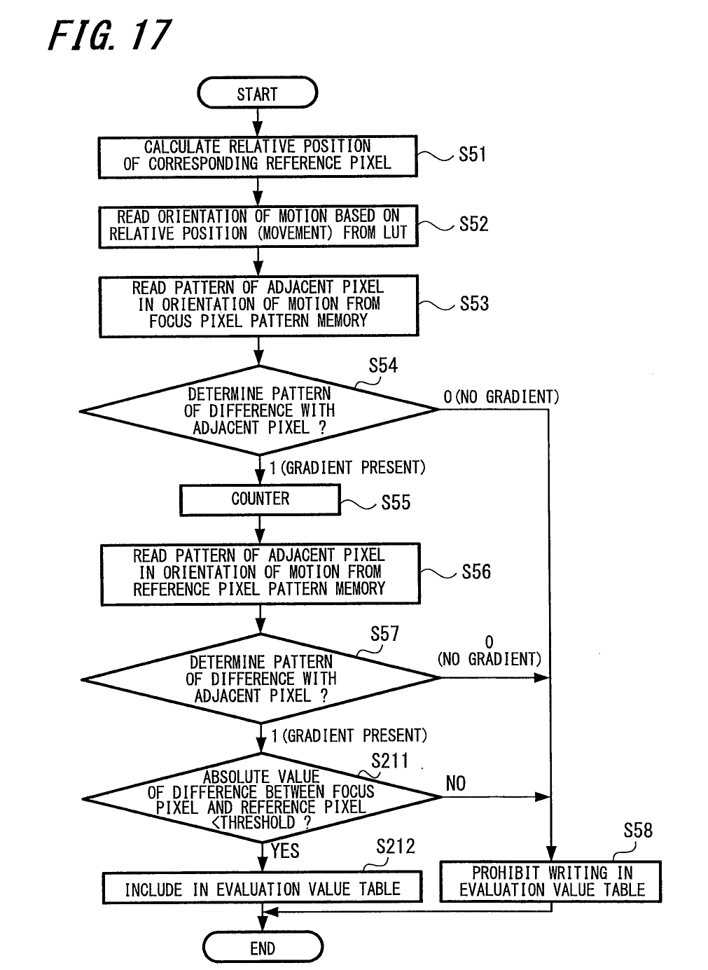

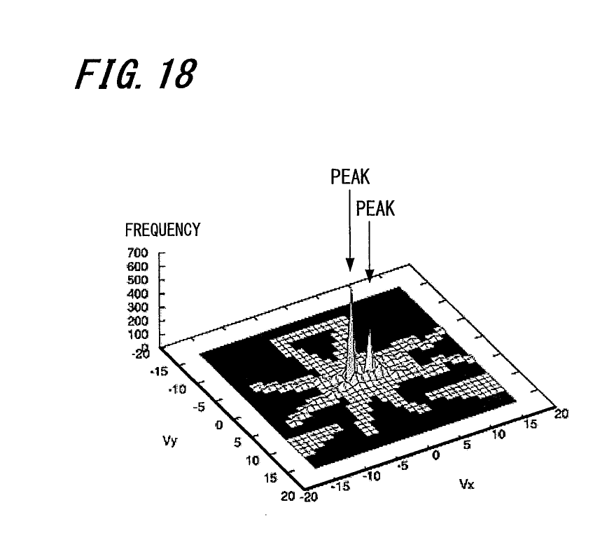

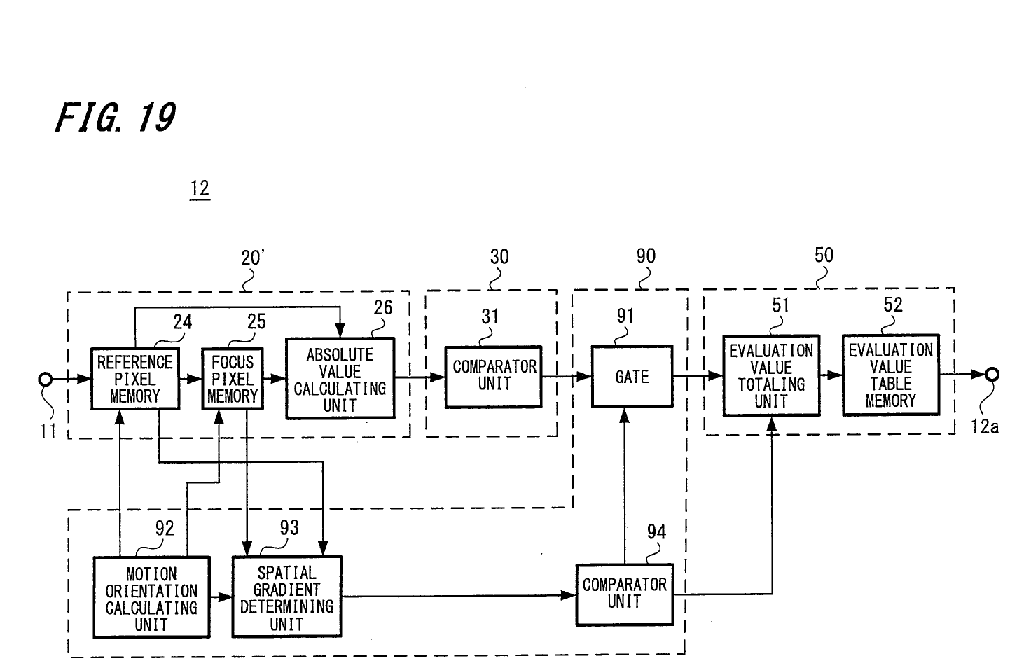

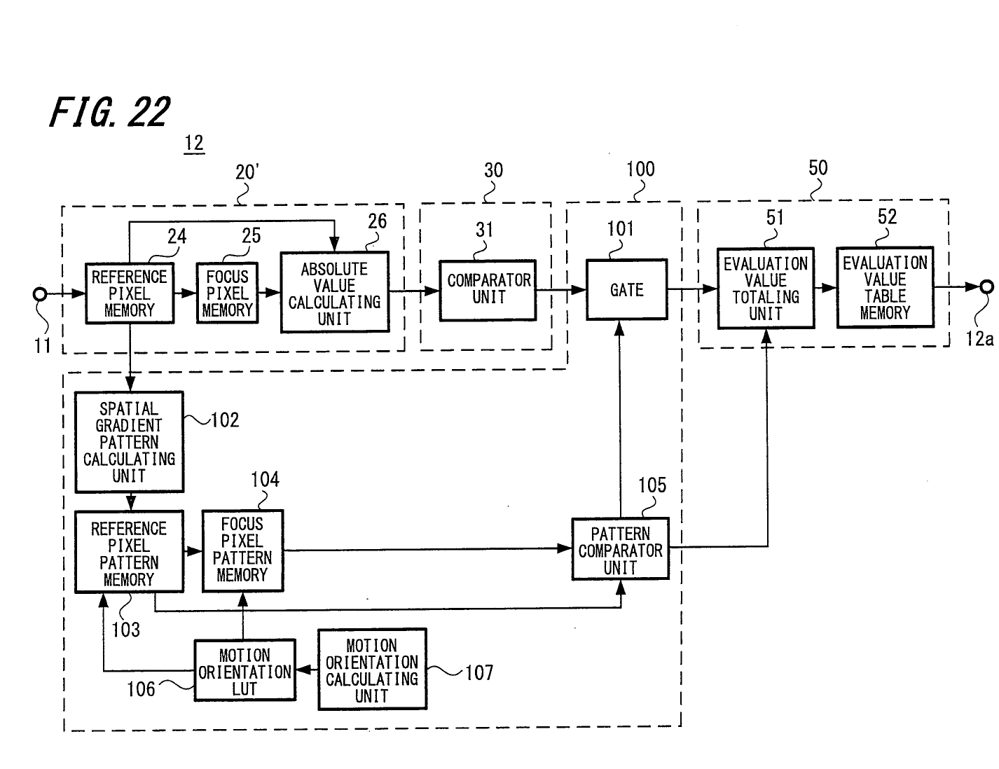

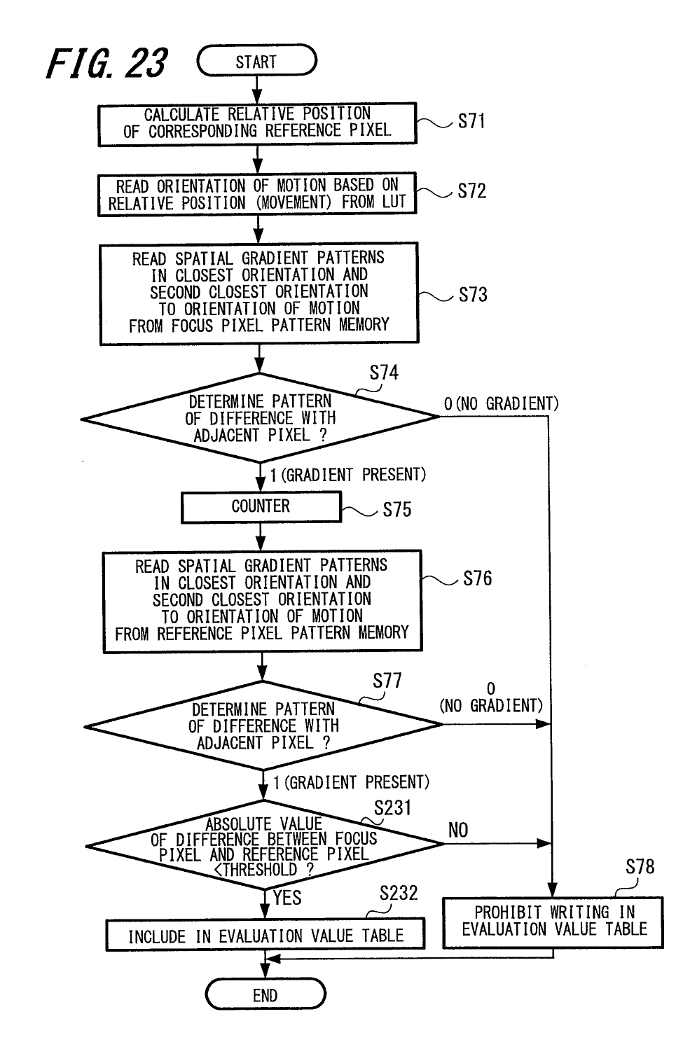

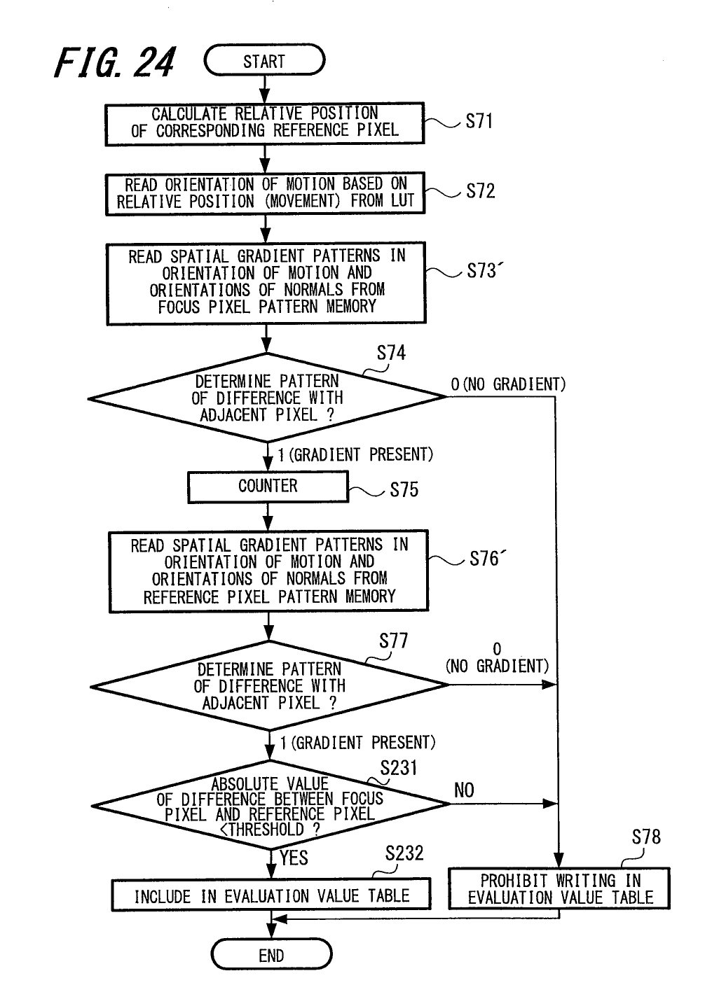

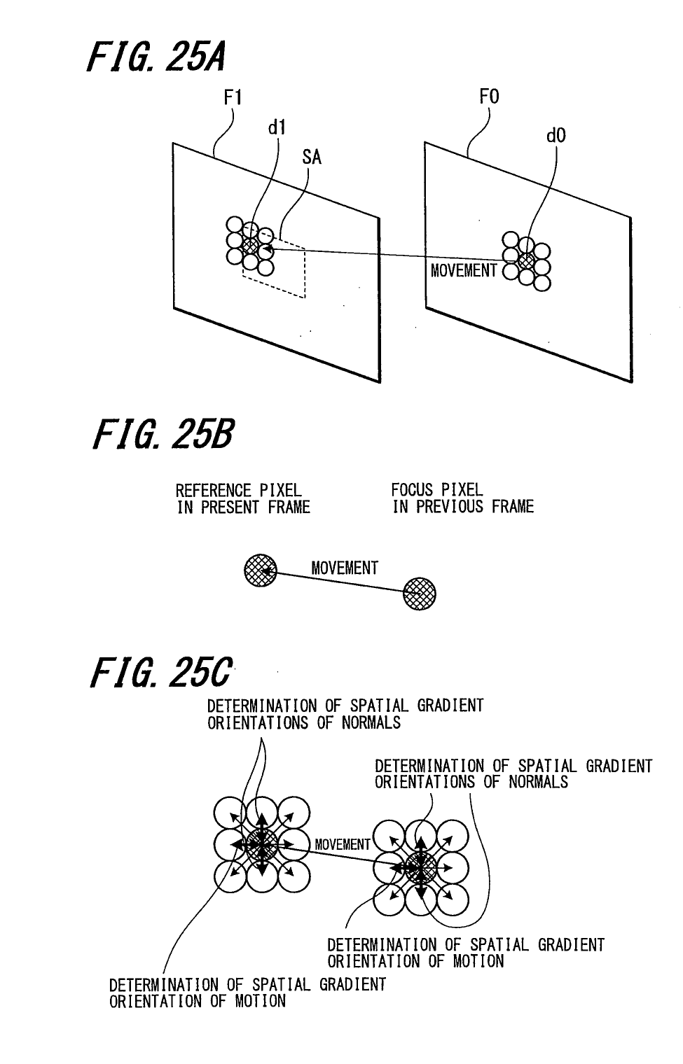

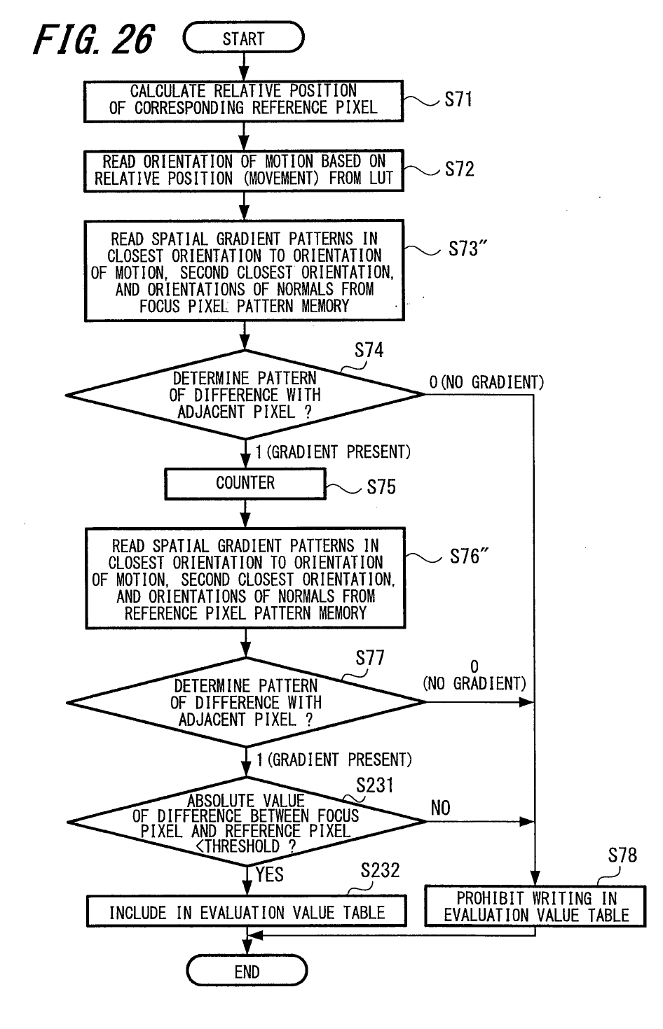

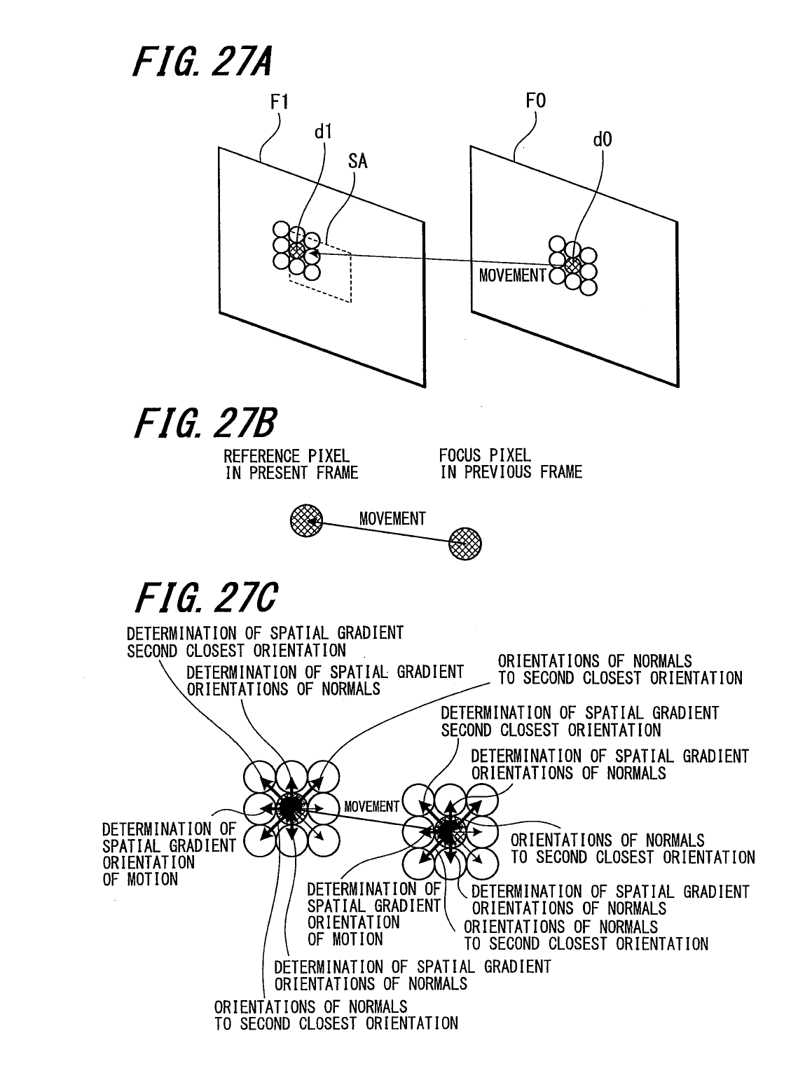

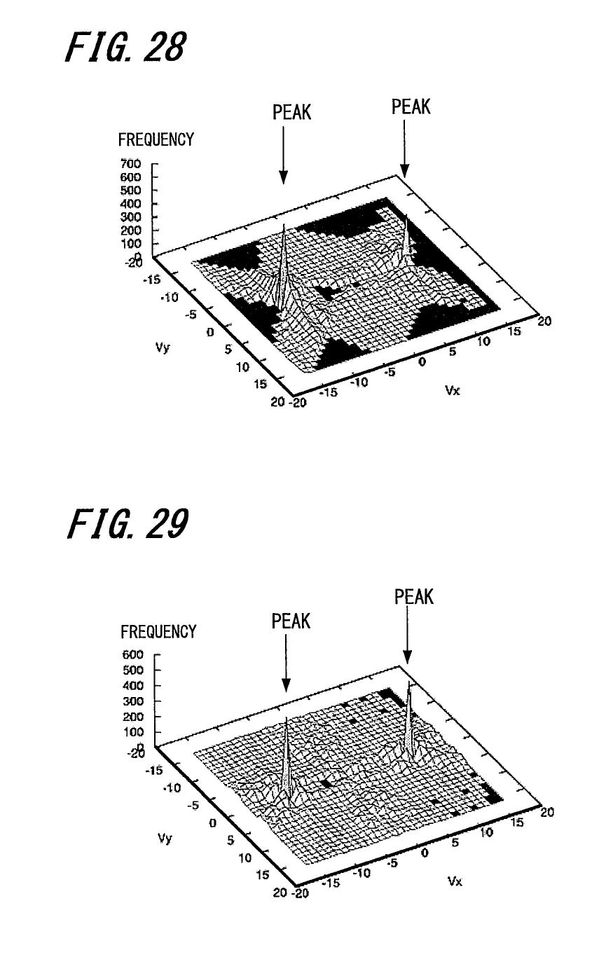

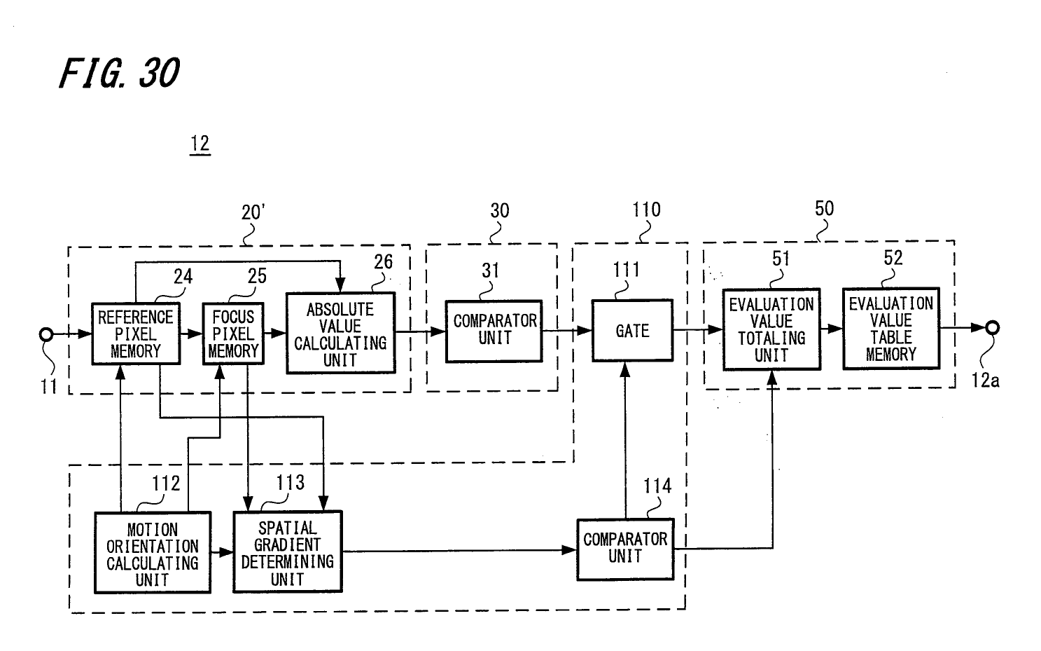

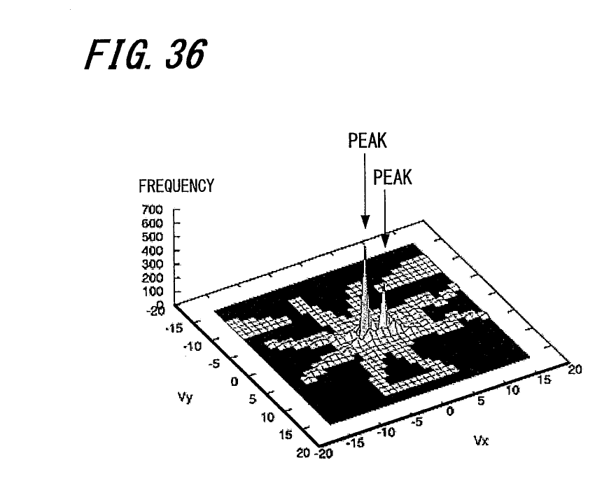

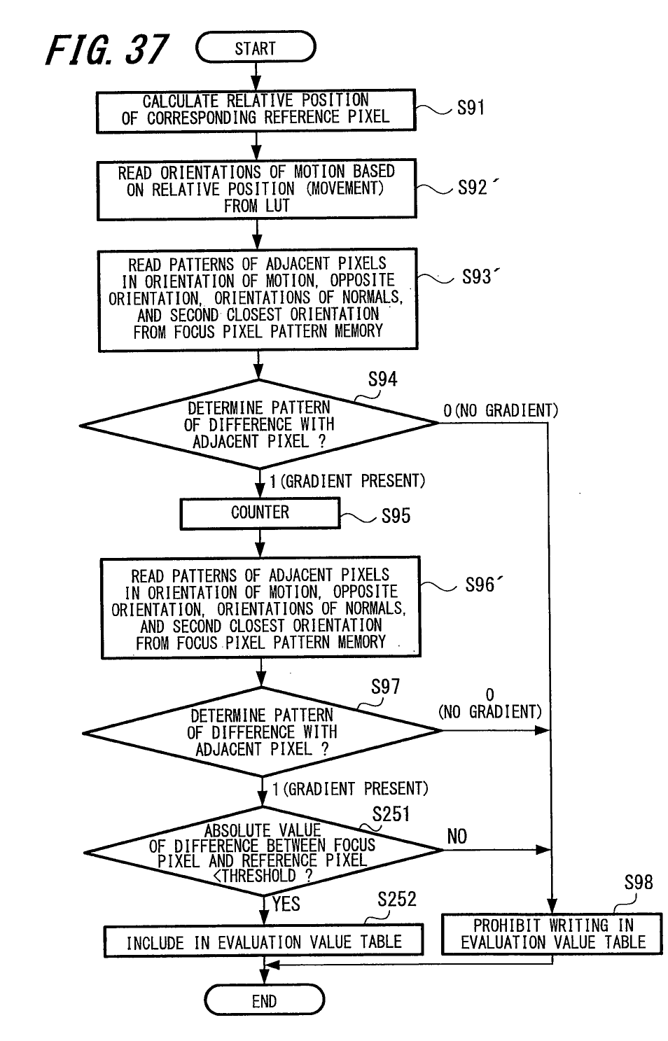

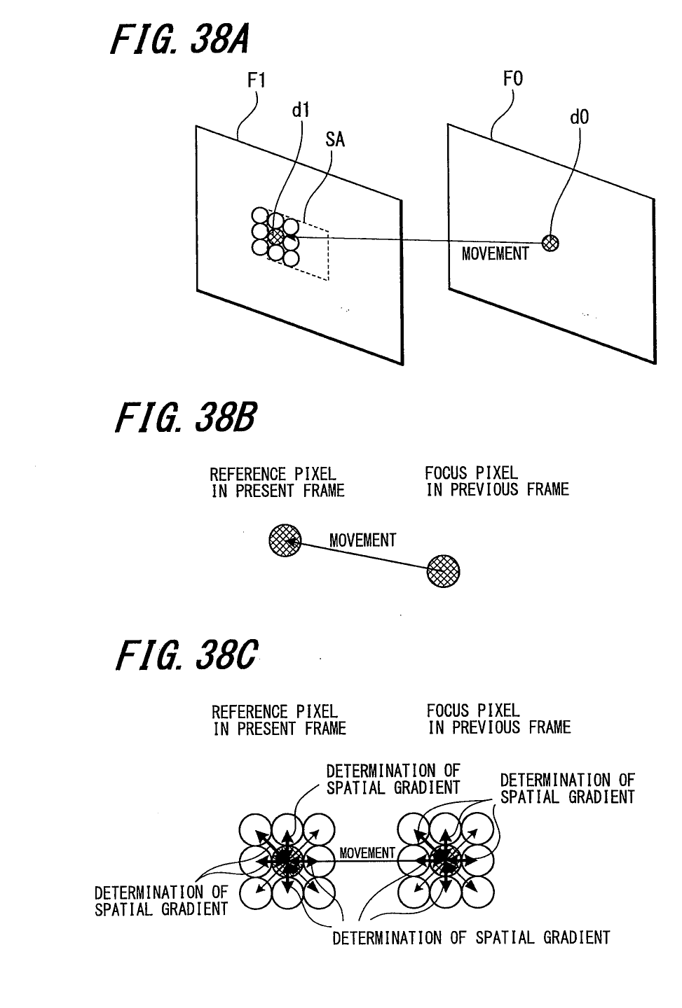

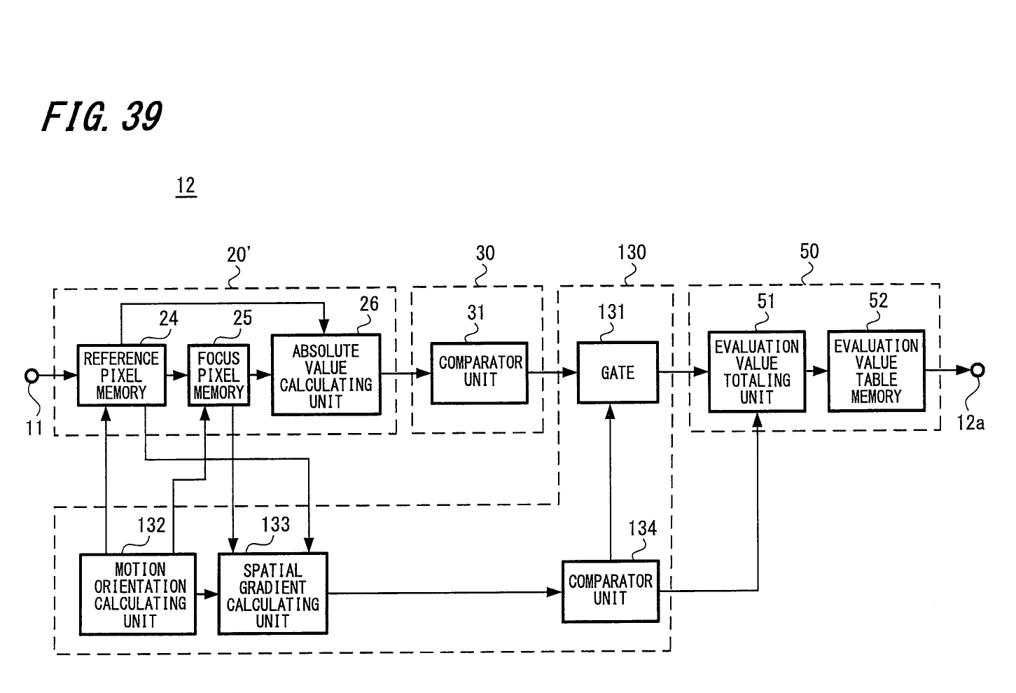

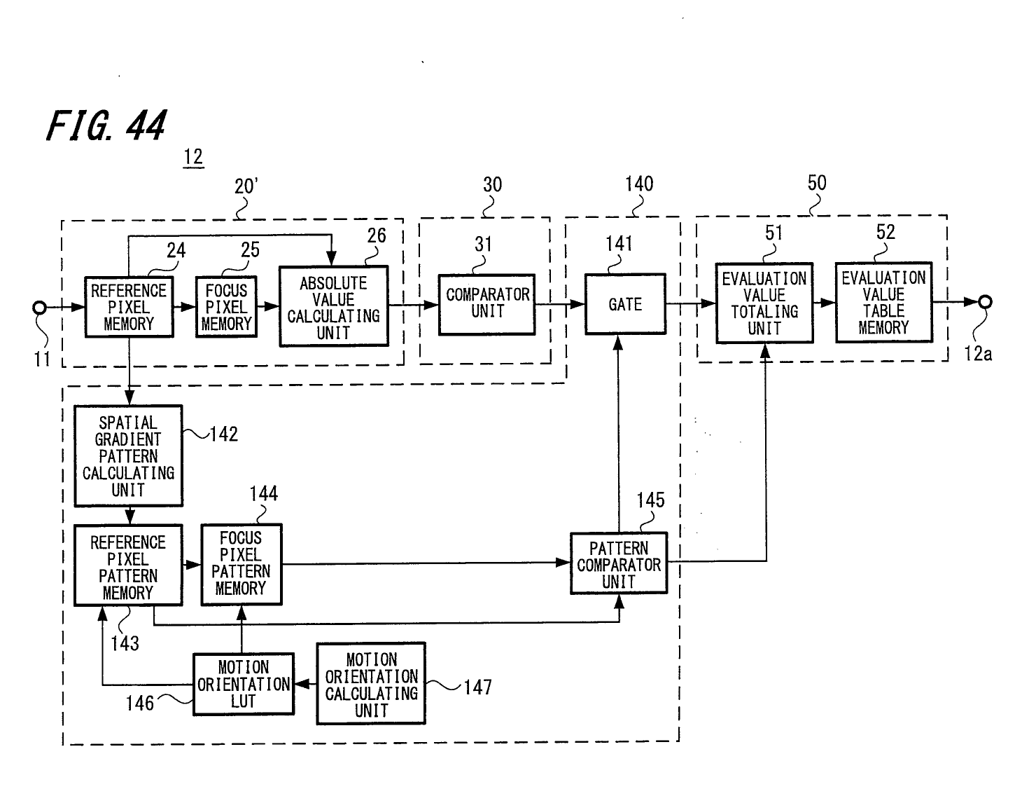

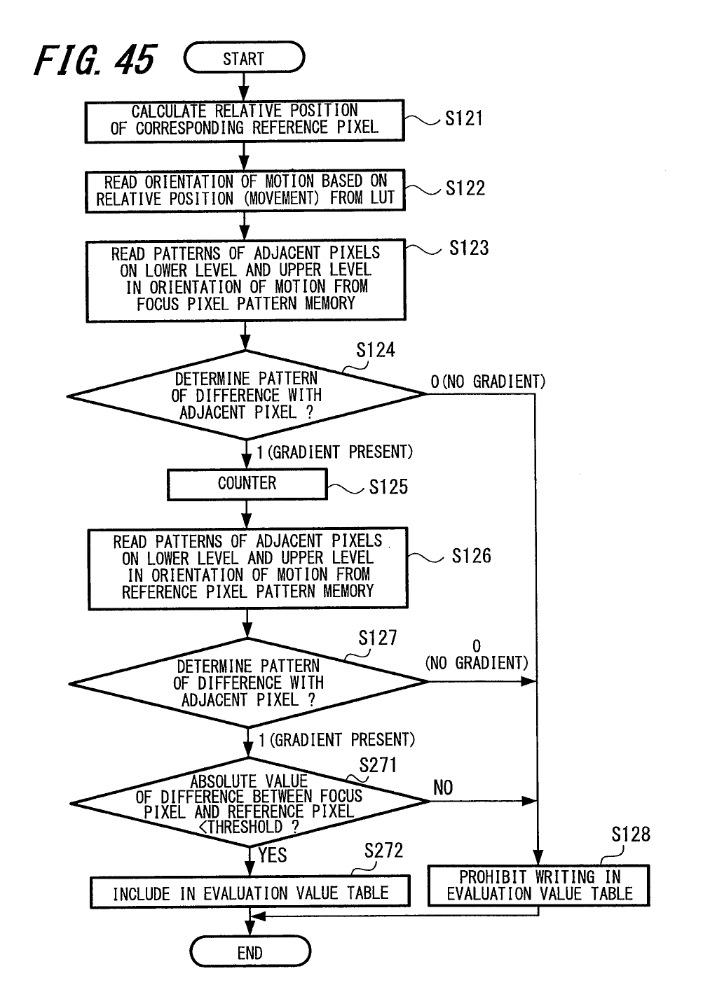

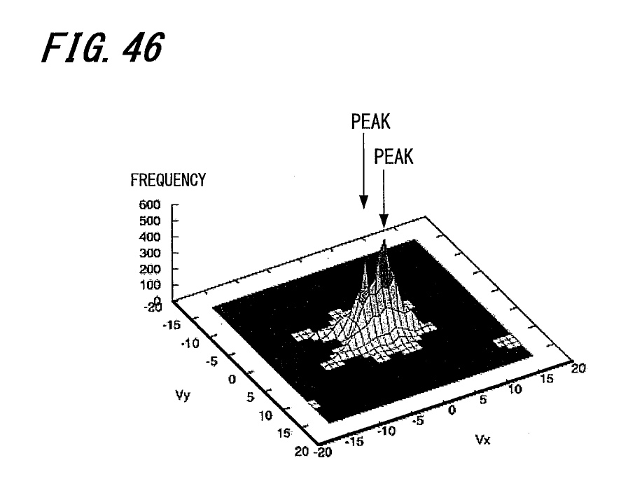

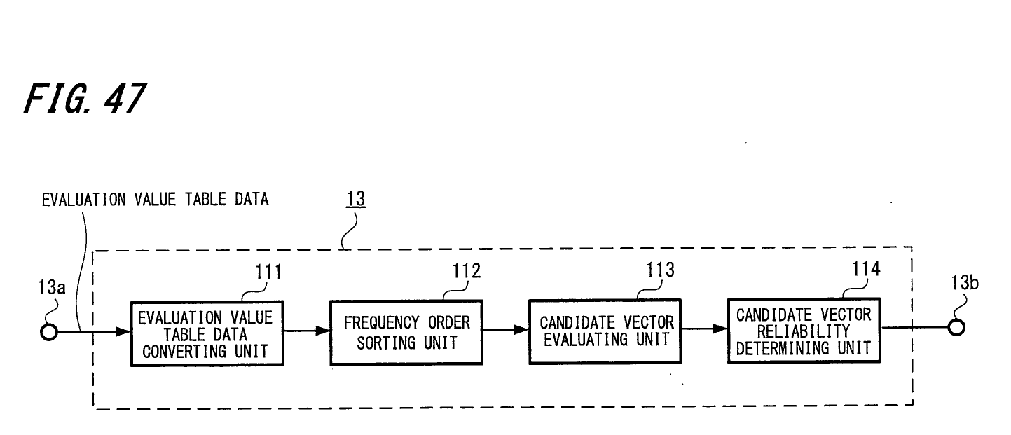

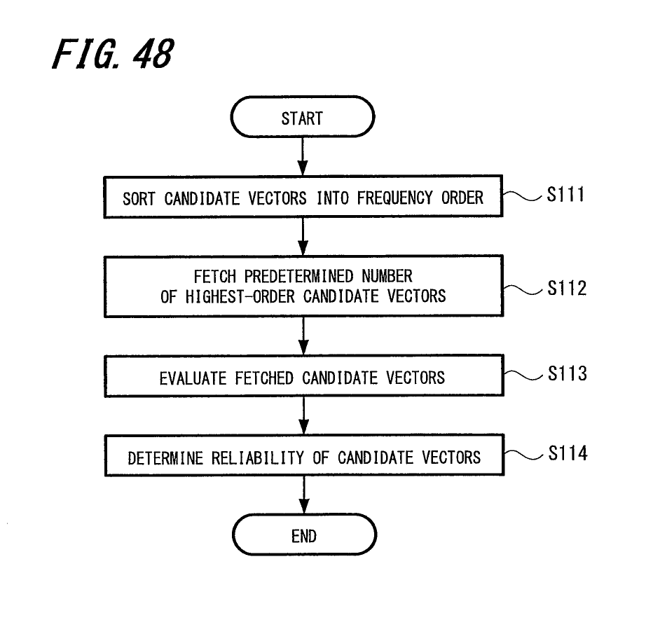

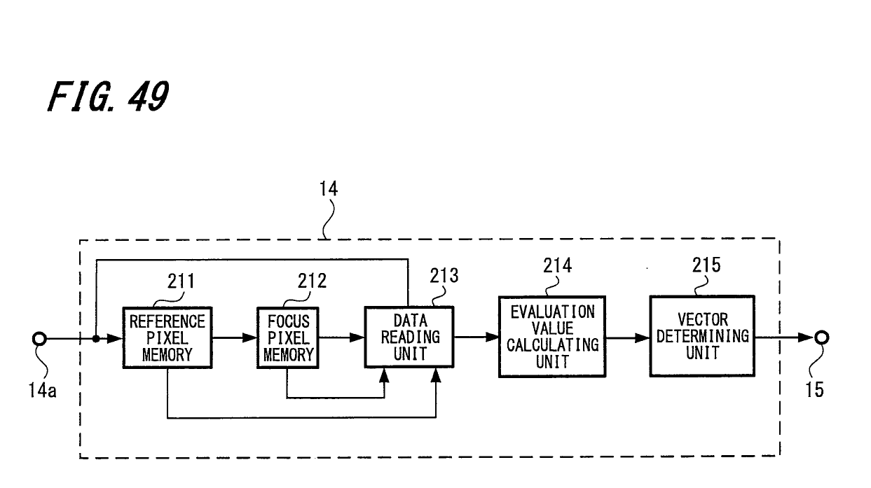

Preferred embodiments of the present invention will now be described in the following order.
1. Overview of Overall Configuration for Detecting Motion Vectors: FIG. 3
2. Overview of Overall Processing for Detecting Motion Vectors: FIG. 4
3. First Embodiment: FIGS. 5 to 7
4. Example Where an LUT is Used in the First Embodiment: FIGS. 8 to 9
5. Example of Evaluation Value Table Generated by the First Embodiment: FIGS. 10 to 12
6. Second Embodiment: FIGS. 13 to 15
7. Example where an LUT is Used in the Second Embodiment: FIGS. 16 to 17
8. Example of Evaluation Value Table Generated by the Second Embodiment: FIG. 18
9. Third Embodiment: FIGS. 19 to 21
10. Example Where an LUT is Used in the Third Embodiment: FIGS. 22 to 23
11. Fourth Embodiment: FIGS. 24 to 25
12. Modification to the Fourth Embodiment: FIGS. 26 to 27
13. Example of Evaluation Value Table Generated by the Fourth Embodiment: FIGS. 28 to 29
14. Fifth Embodiment: FIGS. 30 to 32
15. Alternative Example for the Fifth Embodiment: FIGS. 33 to 35
16. Example of Evaluation Value Table Generated by the Fifth Embodiment: FIG. 36
17. Modification to the Fifth Embodiment: FIGS. 37 to 38
18. Sixth Embodiment: FIGS. 39 to 43
19. Example Where an LUT is Used in the Sixth Embodiment: FIGS. 44 to 45
20. Example of an Evaluation Value Table Generated by the Sixth Embodiment: FIG. 46
21. Configuration and Example Operation of Motion Vector Detecting Unit: FIGS. 47 to 48
22. Configuration and Example Operation of Motion Vector Deciding Unit: FIGS. 49 to 51
23. Modifications to the Embodiments

### 1. Overview of Overall Configuration for Detecting Motion Vectors

A first embodiment of the present invention will now be described with reference to FIGS. 3 to 12.

This embodiment is a motion vector detecting apparatus that detects motion vectors from moving image data. As the detection processing, an evaluation value table for motion vectors is formed, data in the evaluation value table is totaled, and motion vectors are determined. Note that although a stored set of evaluation value information for the motion vectors is referred to as an “evaluation value table” in the following description, the evaluation value table may not need to be constructed of stored information in the form of a table, and may simply be information showing evaluation values for motion vectors. For example, the evaluation values may be converted into a histogram and evaluation value information in the form of a histogram may be stored thereafter.

FIG. 3 is a diagram showing the overall configuration of a motion vector detecting apparatus. An image signal obtained at an image signal input terminal 11 is supplied to an evaluation value table forming unit 12 to form an evaluation value table. The image signal is a digital image signal where individual luminance values are obtained for each pixel in a frame, for example. In the evaluation value table forming unit 12, an evaluation value table of the same size as the search area is generated, for example.

The evaluation value table data generated by the evaluation value table forming unit 12 is supplied to a motion vector detecting unit 13 where a plurality of motion vectors are extracted from the evaluation value table as candidate vectors inside one image (i.e., inside one frame). Here, a plurality of candidate vectors are extracted based on peaks appearing in the evaluation value table. The plurality of candidate vectors extracted at the motion vector detecting unit 13 are supplied to a motion vector deciding unit 14. For each pixel in every image, the motion vector deciding unit 14 carries out region matching or the like to determine the correlation between pixels across frames that are associated by the respective vectors in the plurality of candidate vectors that have been extracted at the motion vector detecting unit 13, and sets a candidate vector that connects blocks with the highest correlation as the motion vector corresponding to each pixel. The processing that obtains such motion vectors is executed by control carried out by a control unit (controller) 16.

Data on the set motion vectors is output from a motion vector output terminal 15. When doing so, as necessary the data may be appended to the image signal obtained at the image signal input terminal 11. The output motion vector data is used in high-efficiency encoding of the image data, for example. Alternatively, the motion vectors may be used in high-definition processing when the images are displayed on a television set. The motion vectors detected by the processing in this embodiment may also be used in other image processing.

### 2. Overview of Overall Processing for Detecting Motion Vectors

The flowchart in FIG. 4 shows one example of processing up to the deciding of the motion vectors. First, an evaluation value table is formed from the input image signal (step S11) and a plurality of vectors used as candidates are extracted from the formed evaluation value table (step S12). After this, the most optimal motion vectors are decided from the plurality of candidate vectors that have been extracted (step S13). The processing in the flowchart in FIG. 4 is carried out for each frame. The processing up to this point is typical for a motion vector detecting configuration that uses an evaluation value table.

### 3. First Embodiment

In the present embodiment, the evaluation value table forming processing at the evaluation value table forming unit 12 is carried out using the configuration shown in FIG. 5. In the example in FIG. 5, the evaluation value table is formed having taken into account a spatial gradient in the orientation of motion at the focus pixel. Here, the expression “focus pixel” refers to a pixel position of a point (standard point) used as a standard for determining motion vectors and the expression “reference pixel” refers to a pixel position that is a potential destination for movement from the focus pixel. A reference pixel is a pixel in the periphery of (i.e., inside the search area for) the pixel position of the focus pixel in an earlier or later frame than the focus pixel. Also, the expression “direction of motion” in this specification refers to the direction of the relative position (i.e., motion) between the focus pixel and a reference pixel, and the expression “orientation of motion” is a direction that is closest to the direction of motion and defines a vector between the focus pixel and a predetermined adjacent pixel.

The example configuration in FIG. 5 will now be described. An image signal obtained at the input terminal 11 is supplied to a correlation calculating unit 20 inside the evaluation value table forming unit 12. The correlation calculating unit 20 includes a focus pixel memory 21, a subtractor 22, and an absolute value calculating unit 23. Out of the image signal obtained at the input terminal 11, a pixel value of the focus pixel is stored in the focus pixel memory 21. When doing so, in order to determine a spatial gradient, described later, values of peripheral pixels for the focus pixel are also stored.

The difference across frames between the pixel value of the focus pixel stored in the focus pixel memory 21 and a pixel value input into the input terminal 11 is detected by the subtractor 22. Data on the detected difference is supplied to the absolute value calculating unit 23 and data on an absolute value of the difference is supplied to a correlation determining unit 30. The correlation determining unit 30 includes a comparator unit 31 that compares the supplied difference with a set threshold to obtain an evaluation value. As the evaluation value, as one example a binary value is set so that the correlation is “high” when the difference is equal to or below the threshold and so that the correlation is “low” when the difference exceeds the threshold.

The evaluation value obtained at the correlation determining unit 30 is supplied to a pixel selecting unit 40. The pixel selecting unit 40 includes a gate unit 41 that selects the binary value output from the correlation determining unit 30. As a configuration for controlling the gate unit 41, the pixel selecting unit 40 includes an motion orientation calculating unit 42, a spatial gradient determining unit 43, and a comparator unit 44. The motion orientation calculating unit 42 calculates the relative position of the focus pixel and the reference pixel from the data stored in the focus pixel memory 21 and calculates the orientation of motion from the relative position. When the orientation of motion has been calculated, the spatial gradient determining unit 43 reads data on the adjacent pixel in the orientation of motion from the focus pixel inside the same frame as the focus pixel from the focus pixel memory 21 and calculates the difference in pixel values between the pixel data of the focus pixel and the adjacent pixel data. Here, the difference in pixel values is the difference in luminance values between the pixels. The calculated difference values are sent to the comparator unit 44 that compares the difference value with an adjacent difference determining threshold set in advance, and when the comparison result is that the difference does not exceed the threshold, the evaluation value supplied to the gate unit 41 is prevented from passing through the gate. Conversely, when the comparison result is that the difference exceeds the threshold, the evaluation value supplied to the gate unit 41 is allowed to pass through the gate. The number of adjacent pixels, where the spatial gradient determining unit 43 has determined that a spatial gradient is present, is counted by a counter (not shown) provided in the pixel selecting unit 40.

The evaluation values that have passed the gate unit 41 included in the pixel selecting unit 40 are supplied to an evaluation value table calculating unit 50, are totaled at an evaluation value totaling unit 51, and the totaled result is stored in an evaluation value table memory 52. After this, the data stored in the evaluation value table memory 52 is supplied as evaluation value table data from an output terminal 12a to a circuit that forms the next stage.

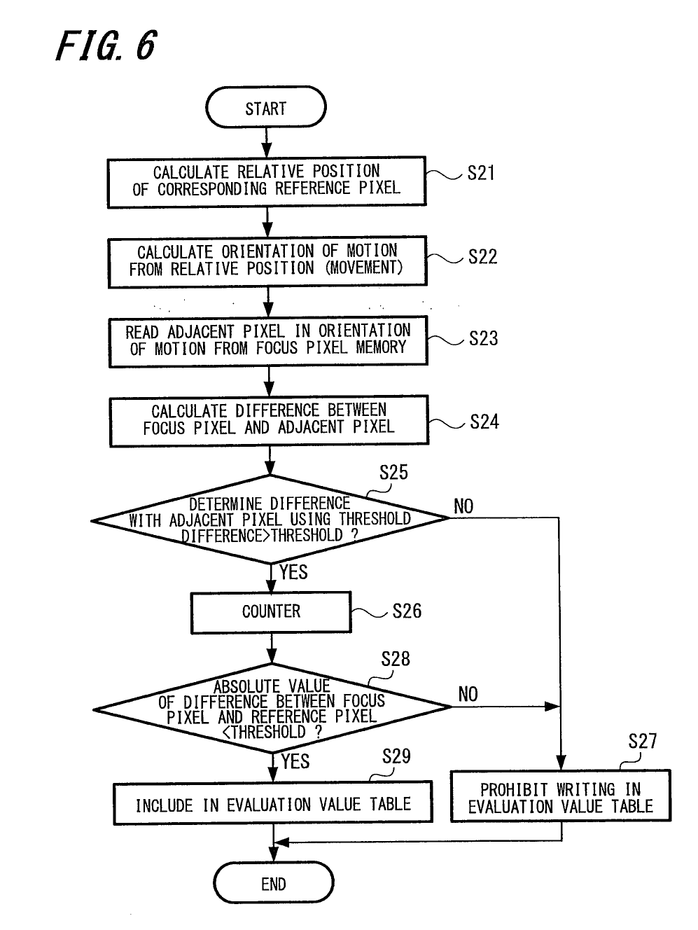

FIG. 6 is a flowchart showing a processing operation with the configuration shown in FIG. 5.

As shown in FIG. 6, the processing carried out with the configuration shown in FIG. 5 includes: candidate detecting processing based on the pixel correlation detected by the correlation calculating unit 20 and the correlation determining unit 30 and also processing where the pixel selecting unit 40 selects a candidate obtained at the correlation determining unit 30. This flowchart will now be described focusing on the processing by the pixel selecting unit 40.

First, the motion orientation calculating unit 42 uses the data stored in the focus pixel memory 21 to calculate the relative position of the focus pixel in the previous frame and a reference pixel in the present frame (step S21). Once the relative position has been calculated, the relative position seen from the focus pixel is regarded as motion, and the orientation of such motion from the focus pixel is obtained by the motion orientation calculating unit 42 (step S22).

After this, an adjacent pixel in the orientation of motion in the same frame when looking from the focus pixel is read from the focus pixel memory 21 (step S23) and the difference between the pixel value of the adjacent pixel that has been read out and the pixel value of the focus pixel is calculated by the spatial gradient determining unit 43. When the difference value has been calculated, the difference value is compared with a threshold by the comparator unit 44 (step S25) and when the difference value exceeds the threshold, the evaluation value of the present focus pixel is allowed to pass through the gate unit 41, and the counter that counts the number of pixels where it is determined that a spatial gradient is present counts up by one (step S26). When the difference value does not exceed the threshold, the evaluation value of the present focus pixel is prevented from being passed through the gate unit 41 to prohibit the writing of such evaluation value in the evaluation value table (step S27).

The absolute value of the difference between the focus pixel and the reference pixel is detected by the correlation calculating unit 20 and it is determined whether the absolute value of the difference is below a threshold (step S28). When this determination finds that the difference is below the threshold, the evaluation value is sent from the correlation determining unit 30 to the gate unit 41 included in the pixel selecting unit 40. Conversely, when the difference is not below the threshold, the evaluation value is not sent to the gate unit 41 to prohibit the writing of the evaluation value in the evaluation value table (step S27).

When the processing up to this point has been carried out, out of the data that has been sent from the correlation determining unit 30 to the gate unit 41 in the pixel selecting unit 40 (i.e., out of the data where there is pixel correlation), the number (i.e., frequency) of the pixels allowed in the pixel selecting to pass the gate unit 41 is written into the evaluation value table (step S29). By writing in the evaluation value table in this way, information showing the number of pixels where there is a spatial gradient and where correlation has been determined is written in the evaluation value table. The number of pixels where correlation has been determined is the “frequency”, and is used as the evaluation value. Note that the frequency may be used as it is as the evaluation value or as another example, a value produced by dividing the frequency by the count value in step S26 may be used as a normalized evaluation value. Similarly, in the other example flowcharts that will be described later, when obtaining the evaluation values, it is possible to use the frequency as it is as an evaluation value or to use a value normalized by the count value.

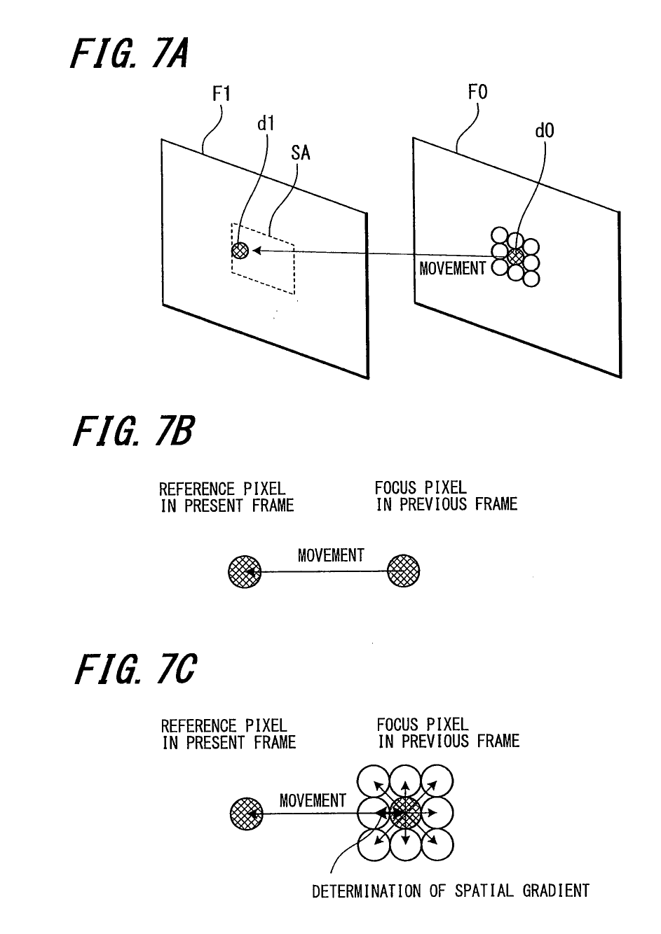

An overview of the processing with the configuration shown in FIG. 5 and the flowchart shown in FIG. 6 is given in FIGS. 7A to 7C.

First, as shown in FIG. 7A, a pixel position used as the standard for determining the motion vectors in a previous frame F0 that is image data for one frame before the present frame F1 is set as the focus pixel do. When the focus pixel d0 has been decided, the search area SA that is a predetermined range in the periphery of the pixel position of the focus pixel d0 is set inside the present frame F1. When the search area SA has been set, evaluation values are calculated with each pixel inside the search area SA as the reference pixel d1.

Here, in the present embodiment, as shown in FIG. 7B, the orientation of motion is determined from the relative position of the focus pixel d0 in the previous frame F0 and the reference pixel d1. In the example shown in FIG. 7B, the example of movement to the left in the horizontal direction is shown.

When the orientation of motion has been determined, as shown in FIG. 7C, the focus pixel and the pixel that is adjacent in the direction indicated by the orientation of motion out of the eight pixels in the range that are adjacent to the focus pixel are read out from the previous frame F0, the difference between the read adjacent pixel and the focus pixel d0 is determined, and it is determined whether a spatial gradient is present at the focus pixel. In this determination, only when it has been determined that there is a spatial frequency, the evaluation value of the reference pixel d1 at this time is written into the evaluation value table.

Note that although counting is executed when totaling is carried out at the evaluation value totaling unit 51 under the control of the pixel selecting unit 40 in the example in FIGS. 5 and 6, it is possible to normalize frequency values in the evaluation value table using such count values. For example, when eight possible orientations of motion are set for a 3×3 area centered on the focus pixel and a count of spatial gradients at the focus pixel is used, the count values of “spatial gradient present” for the eight orientations at the focus pixel are totaled for the entire frame (i.e., for every focus pixel). After this, the respective frequencies of each eight-orientation area in the evaluation value table are normalized using the count values for the eight orientations. By normalizing in this way, more suitable evaluation values are obtained.

### 4. One Example Where an LUT is Used in the First Embodiment

In the examples shown in FIGS. 5 and 6, it is determined whether a spatial gradient is present based on the determination for the adjacent pixel in the orientation of motion for the focus pixel. However, as one example, it is also possible to provide (i) a table (a look up table: hereinafter “LUT”) where relationships between relative positions (movement) and orientations of motion are calculated in advance and (ii) a pattern memory that stores values calculated in advance so that the presence of a spatial gradient at each peripheral pixel for a point is expressed as “0”or “1” (or “0”, “1” or “2”), and to restrict writing into the evaluation value table based on a comparison with the LUT and the pattern memory. Using the LUT and the pattern memory, it is possible to reduce the amount of calculation processing and the like. This effect when an LUT and a pattern memory are used is the same for the processing of the second and later embodiments that will be described later.

FIG. 8 shows an example configuration of the evaluation value table forming unit 12 when using an LUT and a pattern memory for a case where a spatial gradient in the orientation of motion at the focus pixel is taken into account.

Such configuration will now be described with reference to FIG. 8. In the evaluation value table forming unit 12 shown in FIG. 8, the configuration of a pixel selecting unit 60 differs from the pixel selecting unit 40 in the evaluation value table forming unit 12 shown in FIG. 5, but the other parts of the configuration (i.e., the correlation calculating unit 20, the correlation determining unit 30, and the evaluation value table calculating unit 50) are the same as in the configuration shown in FIG. 5. In the evaluation value table forming unit 12 shown in FIG. 8, parts that are the same as in the evaluation value table forming unit 12 shown in FIG. 5 have been assigned the same reference numerals.

In the configuration shown in FIG. 8, the pixel selecting unit 60 includes a gate unit 61 and selects the binary value output from the correlation determining unit 30 using the gate unit 61. As a configuration for controlling the gate unit 61, the pixel selecting unit 60 includes a spatial gradient pattern calculating unit 62, a focus pixel pattern memory 63, a pattern comparator unit 64, an motion orientation LUT 65, and an motion orientation calculating unit 66.

Whenever the pixel data of a frame is supplied, the spatial gradient pattern calculating unit 62 expresses, for each pixel, whether a spatial gradient is present between the focus pixel and a peripheral pixel using the value “0” or “1”, and stores such values as flags in the focus pixel pattern memory 63. After this, by referring to the flags, it is determined whether a spatial gradient is present based on an orientation in which movement has been detected. Flags showing whether a spatial gradient is present at each pixel generated for the present frame (i.e., at each reference pixel) at a given time t can be used at a time t+1 when the next frame is obtained as flags showing whether a spatial gradient is present at each pixel in the previous frame (i.e., at each focus pixel).

In the motion orientation calculating unit 66, relationships between relative positions (movement) inside the search area and closest directions are calculated in advance, and the calculated data is stored as the motion orientation LUT 65. The values of the stored LUT are sent to the focus pixel pattern memory 63, and the spatial gradient calculated by the spatial gradient pattern calculating unit 62 and the pattern for the adjacent pixel in the orientation of motion read out from the motion orientation LUT 65 are compared at the pattern comparator unit 64. When, as the comparison result, it is determined that a gradient is present, control is carried out to allow the evaluation value to pass the gate unit 61. Conversely, when it is determined that no gradient is present, control is carried out to prevent the evaluation value from passing the gate unit 61. When it has been determined at the pattern comparator unit 64 that there is a spatial gradient, the counter that counts up the number of pixels where there is a spatial gradient counts up by one.

FIG. 9 is a flowchart showing an example of processing with the configuration shown in FIG. 8.

As shown in FIG. 9, the processing carried out with the configuration shown in FIG. 8 includes: candidate detecting processing based on the pixel correlation detected by the correlation calculating unit 20 and the correlation determining unit 30 and also processing where the pixel selecting unit 60 selects a candidate obtained at the correlation determining unit 30. This flowchart will now be described focusing on the processing by the pixel selecting unit 60.

First, the spatial gradient pattern calculating unit 62 uses the data stored in the focus pixel memory 21 to calculate the relative position of the focus pixel in the previous frame and a reference pixel in the present frame (step S31) and determines the orientation of motion from the relative position. Data on the determined orientation of motion is read from the motion orientation LUT 65 (step S32), a pattern of the adjacent pixel in the orientation of motion is read from the focus pixel pattern memory 63 (step S33), and the pattern of the difference with the adjacent pixel is determined (step S34). When this determination determines that a spatial gradient is present, the counter for a value that shows that a spatial gradient is present counts up by one (step S35).

It is also determined whether the absolute value of the difference between the focus pixel and the reference pixel obtained at the correlation calculating unit 20 is below a threshold (step S37). When the determination finds that the difference is below the threshold, the evaluation value is sent from the correlation determining unit 30 to the gate unit 61 in the pixel selecting unit 60. Conversely, when it is determined in step S34 that there is no spatial gradient or when it is determined in step S37 that the difference between the focus pixel and the reference pixel exceeds a threshold, the evaluation value is prevented from passing the gate unit 61 and the evaluation value in question is not written in the evaluation value table memory 52 (step S36).

After this, the number (i.e., frequency) of values that have been allowed in the pixel selection to pass the gate unit 61 out of the data sent from the correlation determining unit 30 to the gate unit 61 in the pixel selecting unit 60 (i.e., the data where there is pixel correlation) is written into the evaluation value table (step S38).

As shown in FIGS. 8 and 9, even if an LUT is used, it will still be possible to generate an evaluation value table using the orientation of motion at a focus pixel.

### 5. Example of an Evaluation Value Table Generated in the First Embodiment

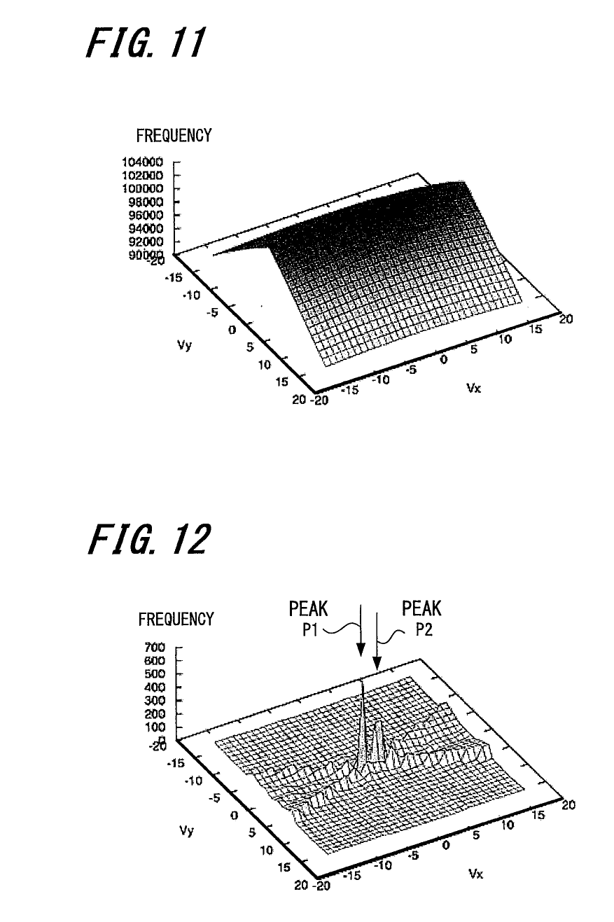

FIGS. 11 and 12 show examples of the results of totaling in the evaluation value table. FIG. 11 shows an evaluation value table obtained with only a determination of correlation (that is, a table which corresponds to an evaluation value table obtained by existing technology) and FIG. 12 shows an evaluation value table according to the present embodiment obtained with the configuration shown in FIG. 5, with both diagrams showing evaluation values calculated for a test image shown in FIG. 10. That is, examples are shown where evaluation value tables have been calculated for a test image produced by processing on the same image signal, which shows two objects moving along a boundary between two background colors. In the test image shown in FIG. 10, the background is stationary, a circular object m1 of a color (i.e., white) that is different from the background color moves in order in each frame in the direction shown by the arrow a and another circular object m2 of a color (i.e., black) that is similar to the background color moves in order in each frame in the direction shown by the arrow b (i.e., the opposite direction to the direction shown by the arrow a). Here, the two objects m1, m2 shown by the arrows a, b have different areas and the direction of motion of both objects is along the boundary between two background colors.

FIG. 11 shows an example where an evaluation value table has been obtained by being totaled with only a determination of correlation and corresponds to a correlation value table of evaluation values obtained by existing processing. Since the areas inside the objects (m1, m2) that move within the image in FIG. 10 and both parts of the background are all flat blocks of color, which is to say, are areas with the same luminance value, if totaling into the evaluation value table is carried out using only a determination of correlation, as shown in FIG. 11, a large number of erroneous movements will be included in the evaluation value table. Accordingly, the correct motion vectors may become lost in the erroneous movements, and it may be difficult to calculate such motion vectors from the evaluation value table.

FIG. 12 shows an example of an evaluation value table where totaling has been carried out by the processing with the configuration shown in FIG. 5 that takes into account a spatial gradient at the focus pixel. As shown in FIG. 12, according to the present embodiment, peak positions P1, P2 are clearly indicated. In addition, the two peak positions P1, P2 are correctly shown as candidates. This means that the pixel position to which a focus pixel has moved can be correctly determined and a motion vector can be correctly decided from the values registered in the evaluation value table. In addition, there is an effect that even when there are multiple movements, it will still be possible to determine the individual movements.

### 6. Second Embodiment

A second embodiment of the present invention will now be described with reference to FIGS. 13 to 18.

The present embodiment also relates to a motion vector detecting apparatus that detects motion vectors from moving image data. This motion vector detecting apparatus is the same as the first embodiment described above in that an evaluation value table is formed from pixel value correlation information and motion vectors are determined from the data of such evaluation value table.

The overall configuration and overall processing of the motion vector detecting apparatus are the same as the configuration shown in FIG. 3 and the flowchart shown in FIG. 4 described earlier in the first embodiment.

In the present embodiment, the evaluation value table forming unit 12 included in the motion vector detecting apparatus shown in FIG. 3 is configured as shown in FIG. 13. In the evaluation value table forming unit 12 shown in FIG. 13, parts that are the same as in the evaluation value table forming unit 12 of the first embodiment shown in FIG. 5 and described earlier have been assigned the same reference numerals.

In the present embodiment, the spatial gradients in the orientation of motion at both the focus pixel and the reference pixel are taken into account when obtaining pixel value correlation information and forming the evaluation value table. The definitions of “focus pixel” and “reference pixel” are the same as those given above in the first embodiment. That is, a focus pixel is a pixel position of a point (standard point) used as a standard for determining a motion vector and a reference pixel is a pixel within a search area in an earlier or later frame than the focus pixel.

The example configuration shown in FIG. 13 will now be described. An image signal obtained at the input terminal 11 is supplied to a correlation calculating unit 20′ inside the evaluation value table forming unit 12. The correlation calculating unit 20′ includes a reference pixel memory 24, a focus pixel memory 25, and an absolute value calculating unit 26. The reference pixel memory 24 stores pixel values of the image signal of the present frame obtained at the input terminal 11 and when one frame period has passed, the stored data is moved to the focus pixel memory 25. In this way, pixel data of the reference pixels and the pixel data of the focus pixels are stored in the two memories 24, 25. In the absolute value calculating unit 26, the pixel value of the focus pixel read from the focus pixel memory 25 is compared with a pixel value of a reference pixel read from the reference pixel memory 24 and the absolute value of the difference is calculated.

After this, data on the detected difference is supplied to the correlation determining unit 30. The correlation determining unit 30 includes a comparator unit 31 that compares the supplied difference with a set threshold to obtain an evaluation value. As the evaluation value, as one example a binary value is set so that the correlation is “high” when the difference is equal to or below the threshold and so that the correlation is “low” when the difference exceeds the threshold.

The evaluation value obtained at the correlation determining unit 30 is supplied to a pixel selecting unit 70. The pixel selecting unit 70 includes a gate unit 71 that selects the binary value output from the correlation determining unit 30. As a configuration for controlling the gate unit 71, the pixel selecting unit 70 includes an motion orientation calculating unit 72, a spatial gradient determining unit 73, and a comparator unit 74. The motion orientation calculating unit 72 calculates the relative position of the focus pixel and the reference pixel from the data stored in the reference pixel memory 24 and the data stored in the focus pixel memory 25 and calculates the orientation of motion from the relative position.

When the orientation of motion has been calculated, the spatial gradient determining unit 73 reads the pixel data of the reference pixel and the adjacent pixel in the orientation of motion from the reference pixel memory 24 and calculates the difference in pixel values between the pixel data of the reference pixel and the adjacent pixel data. The spatial gradient determining unit 73 also reads the pixel data of the focus pixel and the adjacent pixel in the orientation of motion from the focus pixel memory 25 and calculates the difference in pixel values between the pixel data of the focus pixel and the adjacent pixel data.

The comparator unit 74 determines if the difference with the adjacent pixel in the orientation of motion exceeds a threshold for both the focus pixel and the reference pixel, and when both differences exceed the threshold, the evaluation value supplied to the gate unit 71 is allowed to pass. When the difference does not exceed the threshold for either of the focus pixel and the reference pixel, the evaluation value supplied to the gate unit 71 is prevented from passing. When the spatial gradient determining unit 73 has determined that a spatial gradient is present, a counter, not shown that counts the number of pixels where it is determined that a spatial gradient is present counts up by one.

The evaluation values that have passed the gate unit 71 included in the pixel selecting unit 70 are supplied to an evaluation value table calculating unit 50, are totaled by an evaluation value totaling unit 51, and the totaled result is stored in an evaluation value table memory 52. After this, the stored data of the evaluation value table memory 52 is supplied as evaluation value table data from an output terminal 12a to a circuit that forms the next stage.

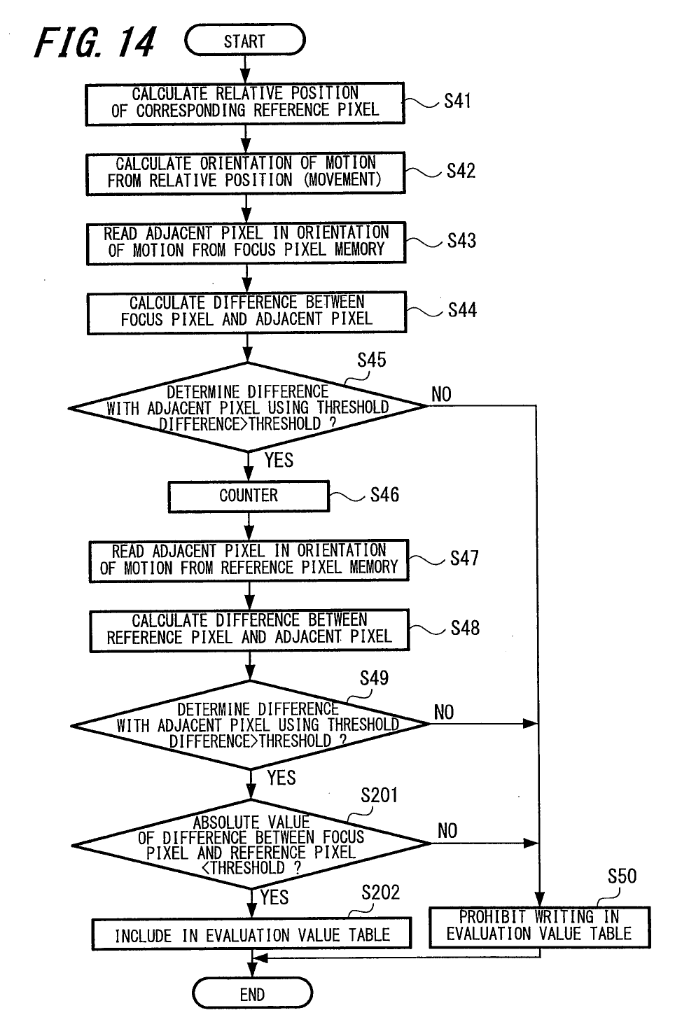

FIG. 14 is a flowchart showing a processing operation with the configuration shown in FIG. 13.

As shown in FIG. 14, the processing carried out with the configuration shown in FIG. 13 includes: candidate detecting processing based on the pixel correlation detected by the correlation calculating unit 20′ and the correlation determining unit 30 and also processing where the pixel selecting unit 70 selects a candidate obtained at the correlation determining unit 30. This flowchart will now be described focusing on the processing by the pixel selecting unit 70.

First, the motion orientation calculating unit 72 calculates the relative position of the reference pixel and the focus pixel corresponding to such reference pixel (step S41) and calculates the orientation of motion from such relative position (step S42). After this, the pixel data of the adjacent pixel in the orientation of motion is read from the focus pixel memory 25 (step S43) and the difference between the read adjacent pixel and the focus pixel is calculated (step S44). Once the difference with the adjacent pixel has been calculated, it is determined whether the difference exceeds a threshold set in advance (step S45), and when the threshold is not exceeded in such determination, the present evaluation value is prevented from passing the gate unit 71 and writing into the evaluation value table is prohibited (step S50).

In step S45, when it has been determined that the difference between the focus pixel and the adjacent pixel exceeds the threshold, a counter for a value showing that a spatial gradient is present in the determination for the adjacent pixel counts up by one (step S46), the adjacent pixel in the orientation of motion is read from the reference pixel memory 24 (step S47), and the difference between the read adjacent pixel and the reference pixel is calculated (step S48). Once the difference with the adjacent pixel has been calculated, it is determined whether the difference exceeds a threshold set in advance (step S49), and when it is determined that the difference does not exceed the threshold, the present evaluation value is prevented from passing the gate unit 71 and writing into the evaluation value table is prohibited (step S50).

In addition, it is determined whether the absolute value of the difference between the focus pixel and the reference pixel obtained by detecting the pixel correlation at the correlation calculating unit 20′ and the correlation determining unit 30 is below a threshold (step S201). When this determination finds that the difference is below the threshold, the evaluation value is sent from the correlation determining unit 30 to the gate unit 71 included in the pixel selecting unit 70. When the difference is not below the threshold, writing into the evaluation value table is prohibited (step S50).

After this, out of the data sent from the correlation determining unit 30 to the gate unit 71 in the pixel selecting unit 70 (i.e., the data where there is pixel correlation), the number (frequency) of evaluation values that have passed the gate unit 71 in the pixel selecting processing is written in the evaluation value table (step S202).

Note that in the flowchart shown in FIG. 14, although writing is carried out in the evaluation value table when the conditions are satisfied in both of the determination of a spatial gradient at the focus pixel and the determination of a spatial gradient at the reference pixel, it is also possible to allow the evaluation value to pass the gate unit 71 and carry out writing in the evaluation value table when the conditions are satisfied in one of the determination of a spatial gradient at the focus pixel and the determination of a spatial gradient at the reference pixel.

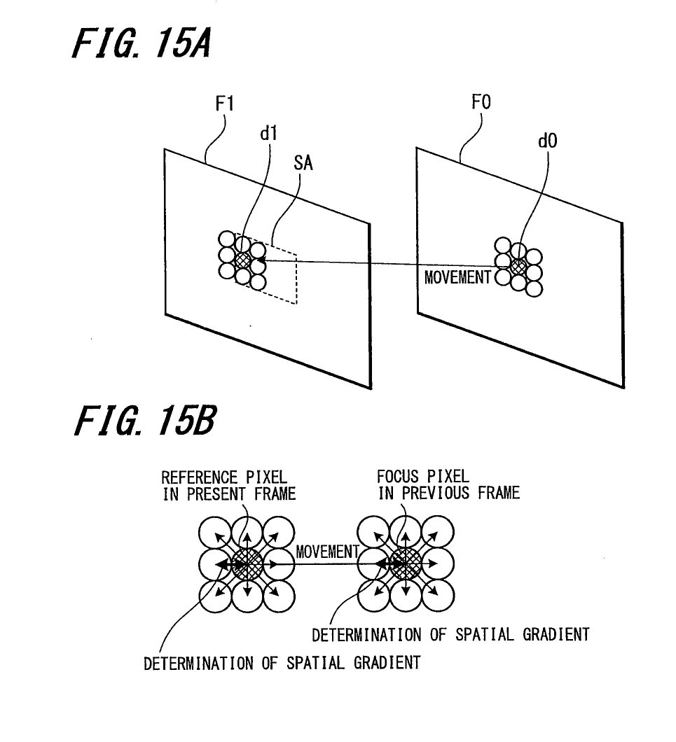

An overview of the processing with the configuration shown in FIG. 13 and the flowchart shown in FIG. 14 is given in FIGS. 15A and 15B.

First, as shown in FIG. 15A, a pixel position used as a standard for determining the motion vectors in a previous frame F0 that is image data for one frame before the present frame F1 is set as the focus pixel do. When the focus pixel do has been decided, the search area SA that is a predetermined range in the periphery of the pixel position of the focus pixel do is set inside the present frame F1. When the search area SA has been set, evaluation values are calculated with each pixel inside the search area SA as the reference pixel d1.

Here in the present embodiment, as shown in FIG. 15B, the orientation of motion is determined from the relative position of the focus pixel do in the previous frame F0 and the reference pixel d1. In the example shown in FIG. 15B, the example of movement to the left in the horizontal direction is shown.

When the orientation of motion has been determined, as shown by the arrow drawn with a thick line in FIG. 15B, the focus pixel and the pixel that is adjacent in the direction indicated by the orientation of motion out of the eight pixels in the range that are adjacent to the focus pixel are read out from the previous frame F0, the difference between the read adjacent pixel and the focus pixel d0 is determined, and it is determined whether a spatial gradient is present at the focus pixel. In addition, as shown by the arrow drawn with a thick line shown in FIG. 15B, the reference pixel and the pixel that is adjacent in the direction indicated by the orientation of motion out of the eight pixels in the range that are adjacent to the reference pixel are read out from the present frame F1, the difference between the read adjacent pixel and the reference pixel d1 is determined, and it is determined whether a spatial gradient is present at the reference pixel.

In this determination, only when it has been determined that there is a spatial gradient at both the focus pixel and the reference pixel, the evaluation value of the reference pixel d1 at this time is written into the evaluation value table.

### 7. One Example Where an LUT is Used in the Second Embodiment

Although it is determined whether a spatial gradient is present in the calculation processing in the example shown in FIG. 13, in the present embodiment also, it is possible to use a configuration where the presence of a spatial gradient is determined using an LUT and a pattern memory.

FIG. 16 shows an example configuration that uses an LUT and a pattern memory in the case where it is determined whether spatial gradients are present at both the focus pixel and the reference pixel from the difference with an adjacent pixel in the orientation of motion.

This configuration will now be described with reference to FIG. 16. In the evaluation value table forming unit 12 shown in FIG. 16, the configuration of a pixel selecting unit 80 differs from that of the pixel selecting unit 70 included in the evaluation value table forming unit 12 shown in FIG. 13, but the other parts (that is, the correlation calculating unit 20′, the correlation determining unit 30, and the evaluation value table calculating unit 50) are the same as in the configuration shown in FIG. 13. In the evaluation value table forming unit 12 shown in FIG. 16, parts that are the same as in the evaluation value table forming unit 12 shown in FIG. 13 have been assigned the same reference numerals.

In the configuration shown in FIG. 16, the pixel selecting unit 80 includes a gate unit 81 and an evaluation value output from the correlation determining unit 30 is selected at the gate unit 81. As a configuration for controlling the gate unit 81, the pixel selecting unit 80 includes a spatial gradient pattern calculating unit 82, a reference pixel pattern memory 83, a focus pixel pattern memory 84, a pattern comparator unit 85, an motion orientation LUT 86, and an motion orientation calculating unit 87.

Whenever the pixel data of a frame is supplied, the spatial gradient pattern calculating unit 82 expresses, for each pixel, whether a spatial gradient is present between the focus pixel and a peripheral pixel using the value “0” or “1”, and stores such values as flags in the reference pixel pattern memory 83. After this, by referring to the flags, it is determined whether a spatial gradient is present based on an orientation in which movement has been detected. Flags showing whether a spatial gradient is present at each pixel generated for the present frame (i.e., at each reference pixel) at a given time t can be used at a time t+1 when the next frame is obtained as flags showing whether a spatial gradient is present at each pixel in the previous frame (i.e., at each focus pixel). To do so, a configuration is used where the data stored in the reference pixel pattern memory 83 is moved to the focus pixel pattern memory 84.

In the motion orientation calculating unit 87, relationships between relative positions (movement) inside the search area and closest directions are calculated in advance, and the calculated data is stored as the motion orientation LUT 86. The values of the stored LUT are sent to the reference pixel pattern memory 83 and the focus pixel pattern memory 84, and the spatial gradient pattern calculated by the spatial gradient pattern calculating unit 82 and the pattern for the adjacent pixel in the orientation of motion read out from the motion orientation LUT 86 are compared at both the reference pixel and the focus pixel at the pattern comparator unit 85. When, as the comparison result, it is determined that a spatial gradient is present at both the focus pixel and the reference pixel, control is carried out to allow the evaluation value to pass the gate unit 81. Conversely, when it is determined that a spatial gradient is not present, control is carried out to prevent the evaluation value from passing the gate unit 81. When it has been determined by the pattern comparator unit 85 that spatial gradients are present, a counter (not shown) that counts up the number of pixels where there is a spatial gradient counts up by one.

FIG. 17 is a flowchart showing an example of processing with the configuration shown in FIG. 16.

As shown in FIG. 17, the processing carried out with the configuration shown in FIG. 16 includes: candidate detecting processing based on the pixel correlation detected by the correlation calculating unit 20′ and the correlation determining unit 30 and also processing where the pixel selecting unit 80 selects a candidate obtained at the correlation determining unit 30. This flowchart will now be described focusing on the processing by the pixel selecting unit 80.

First, the spatial gradient pattern calculating unit 82 calculates the relative position of the focus pixel in the previous frame and a reference pixel in the present frame (step S51) and determines the orientation of motion from the relative position. Data on the determined orientation of motion is read from the motion orientation LUT 86 (step S52), a pattern of the adjacent pixel in the orientation of motion is read from the focus pixel pattern memory 84 (step S53), and the pattern of the difference with the adjacent pixel is determined (step S54). When this determination determines that a spatial gradient is not present at the focus pixel, the evaluation value is prevented from passing the gate unit 81 so that the evaluation value in question is not written into the evaluation value table memory 52 (step S58).

Conversely, when the determination determines that a spatial gradient is present, the counter that counts a value showing that a spatial gradient is present counts up by one (step S55), the pattern of the adjacent pixel in the orientation of motion is read from the reference pixel pattern memory 83 (step S56), and the pattern of the difference with the adjacent pixel is determined (step S57). When the determination determines that there is no spatial gradient at the reference pixel, the evaluation value is prevented from passing the gate unit 81 and the evaluation value in question is not written into the evaluation value table memory 52 (step S58).

It is also determined whether the absolute value of the difference between the focus pixel and the reference pixel obtained by detecting the pixel correlation at the correlation calculating unit 20′ and the correlation determining unit 30 is below a threshold (step S211). When the determination finds that the difference is below the threshold, the evaluation value is sent from the correlation determining unit 30 to the gate unit 81 included in the pixel selecting unit 80. Conversely, when it is determined that the difference between the focus pixel and the reference pixel is not below the threshold, the evaluation value is not sent to the gate unit 81 and the evaluation value in question is not written in the evaluation value table memory 52 (step S58).

After this, the number (i.e., frequency) of values that have been allowed by the pixel selection to pass the gate unit 81 out of the data sent from the correlation determining unit 30 to the gate unit 81 in the pixel selecting unit 80 (i.e., the data where there is pixel correlation) is written into the evaluation value table (step S212).

As shown in FIGS. 16 and 17, even if an LUT and a pattern memory are used, it will still be possible to generate an evaluation value table using the orientation of motion at a focus pixel and the orientation of motion at a reference pixel. Using an LUT and a pattern memory in this way, it is possible to reduce the load of the calculation processing.

Note that in the flowchart shown in FIG. 17 also, although writing is carried out in the evaluation value table when the conditions are satisfied for both the determination of a spatial gradient at the focus pixel and the determination of a spatial gradient at the reference pixel, it is also possible to allow the evaluation value to pass the gate unit 81 and carry out writing in the evaluation value table when the conditions are satisfied in one of the determination of a spatial gradient at the focus pixel and the determination of a spatial gradient at the reference pixel.

### 8. Example of an Evaluation Value Table Generated in the Second Embodiment

FIG. 18 shows one example of an evaluation value table produced according to the present embodiment. FIG. 18 shows evaluation values calculated for a test image shown in FIG. 10 (an image showing two objects moving along a boundary between two background colors) that was explained earlier.

As shown in FIG. 18, according to the present embodiment also, two peak positions P1, P2 are clearly indicated and are correctly shown as candidates. This means that even when there are multiple movements, it will still be possible to determine the individual movements.

### 9. Third Embodiment

A third embodiment of the present invention will now be described with reference to FIGS. 19 to 23.

The present embodiment also relates to a motion vector detecting apparatus that detects motion vectors from moving image data. This motion vector detecting apparatus is the same as the first embodiment described above in that an evaluation value table is formed from pixel value correlation information and motion vectors are determined from the data of such evaluation value table.

The overall configuration and overall processing of the motion vector detecting apparatus are the same as the configuration shown in FIG. 3 and the flowchart shown in FIG. 4 described earlier in the first embodiment.

In the present embodiment, the evaluation value table forming unit 12 included in the motion vector detecting apparatus shown in FIG. 3 is configured as shown in FIG. 19. In the evaluation value table forming unit 12 shown in FIG. 19, parts that are the same as the evaluation value table forming unit 12 in the first and second embodiments shown in FIGS. 5 and 13 and described earlier have been assigned the same reference numerals.

In the present embodiment, a plurality of spatial gradients in the orientation of motion at both the focus pixel and the reference pixel are taken into account when forming the evaluation value table. The plurality of spatial gradients referred to here are, for example, a closest orientation to the orientation of motion and a second closest orientation that is the next closest orientation following the closest orientation. The definitions of “focus pixel” and “reference pixel” are the same as those given earlier in the first and second embodiments. That is, a focus pixel is a pixel position of a point (standard point) used as a standard for determining a motion vector and a reference pixel is a pixel within a search area in an earlier or later frame than the focus pixel.

The example configuration shown in FIG. 19 will now be described. An image signal obtained at the input terminal 11 is supplied to a correlation calculating unit 20′ inside the evaluation value table forming unit 12. The correlation calculating unit 20′ includes a reference pixel memory 24, a focus pixel memory 25, and an absolute value calculating unit 26. The reference pixel memory 24 stores pixel values of the image signal of the present frame obtained at the input terminal 11 and when one frame period has passed, the stored data is moved to the focus pixel memory 25. In the absolute value calculating unit 26, the pixel value of the focus pixel read from the focus pixel memory 25 is compared with a pixel value of the reference pixel read from the reference pixel memory 24 and the absolute value of the difference is calculated.

After this, the detected difference data is supplied to the correlation determining unit 30. The correlation determining unit 30 includes a comparator unit 31 that compares the supplied difference with a set threshold to obtain an evaluation value. As the evaluation value, as one example a binary value is set so that the correlation is “high” when the difference is equal to or below the threshold and so that the correlation is “low” when the difference exceeds the threshold.

The evaluation value obtained at the correlation determining unit 30 is supplied to a pixel selecting unit 90. The pixel selecting unit 90 includes a gate unit 91 that selects the binary value output from the correlation determining unit 30. As a configuration for controlling the gate unit 91, the pixel selecting unit 90 includes an motion orientation calculating unit 92, a spatial gradient determining unit 93, and a comparator unit 94. The motion orientation calculating unit 92 calculates the relative position of the focus pixel and the reference pixel from the data stored in the reference pixel memory 24 and the data stored in the focus pixel memory 25 and calculates the orientation of motion from the relative position.

When the orientation of motion has been calculated, the spatial gradient determining unit 93 reads the pixel data of the reference pixel and the adjacent pixels in the orientation of motion from the reference pixel memory 24 and calculates the differences in pixel values between the pixel data of the reference pixel and the adjacent pixel data. In the present embodiment, as the adjacent pixels, data of two pixels, that is, the adjacent pixel in the closest orientation to the orientation of motion and the adjacent pixel in the second closest orientation that is the next closest orientation to the orientation of motion, is read and the difference between the reference pixel and the adjacent pixel in the closest orientation and the difference between the reference pixel and the adjacent pixel in the second closest orientation are respectively calculated.

The spatial gradient determining unit 93 also reads the pixel data of the focus pixel and the adjacent pixels in the orientation of motion from the focus pixel memory 25 and calculates the differences in pixel values between the pixel data of the focus pixel and the adjacent pixel data. In this case also, two pixels, that is, the adjacent pixel in the closest orientation to the orientation of motion and the adjacent pixel in the second closest orientation that is the next closest orientation to the orientation of motion, are read as the adjacent pixels, and the difference between the focus pixel and the adjacent pixel in the closest orientation and the difference between the focus pixel and the adjacent pixel in the second closest orientation are respectively calculated.

The comparator unit 94 determines if the differences with the adjacent pixels in the closest orientation and the second closest orientation exceed a threshold for both the focus pixel and the reference pixel, and when all such differences exceed the threshold, the evaluation value supplied to the gate unit 91 is allowed to pass. When even just one of such differences does not exceed the threshold for either of the focus pixel and the reference pixel, the evaluation value supplied to the gate unit 91 is prevented from passing. When the comparator unit 94 has determined that there are differences that exceed the threshold (i.e., has determined that a spatial gradient is present), a counter, not shown, that counts the number of pixels where it is determined that a spatial gradient is present counts up by one.

The evaluation values that have passed the gate unit 91 included in the pixel selecting unit 90 are supplied to an evaluation value table calculating unit 50, are totaled by an evaluation value totaling unit 51, and the totaled result is stored in an evaluation value table memory 52. After this, the data stored in the evaluation value table memory 52 is supplied as evaluation value table data from an output terminal 12a to a circuit that forms the next stage.

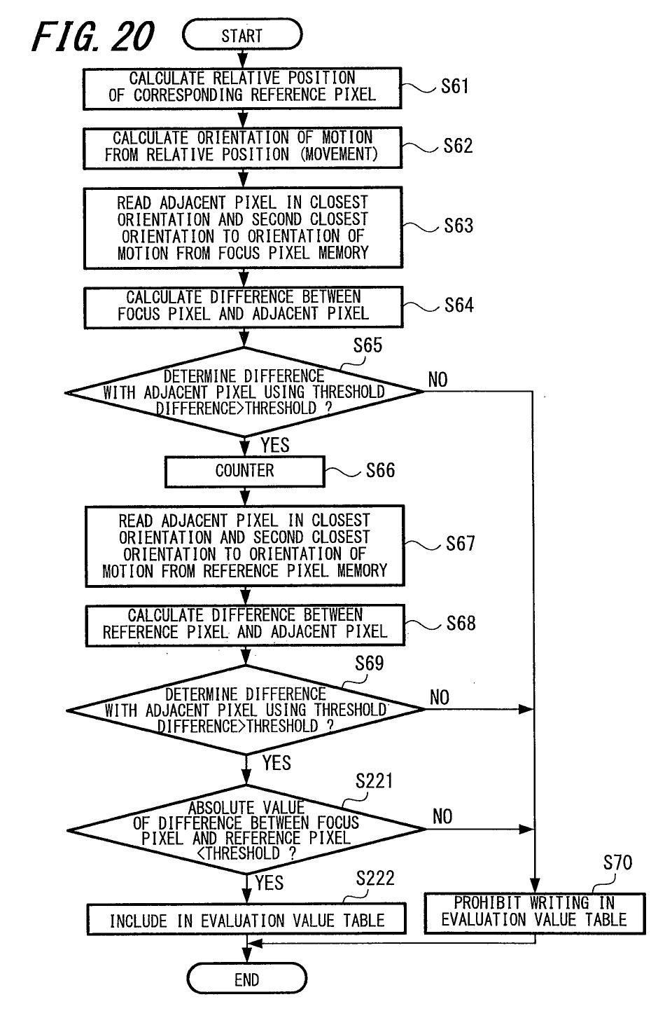

FIG. 20 is a flowchart showing a processing operation with the configuration shown in FIG. 19.

As shown in FIG. 20, the processing carried out with the configuration shown in FIG. 19 includes: candidate detecting processing based on the pixel correlation detected by the correlation calculating unit 20′ and the correlation determining unit 30 and also processing where the pixel selecting unit 90 selects a candidate obtained at the correlation determining unit 30. This flowchart will now be described focusing on the processing by the pixel selecting unit 90.

First, the motion orientation calculating unit 92 calculates the relative position of the reference pixel and the focus pixel corresponding to such reference pixel (step S61) and calculates the orientation of motion from such relative position (step S62). After this, the pixel data of the adjacent pixels in the closest orientation and the second closest orientation to the orientation of motion are read from the focus pixel memory 25 (step S63) and the differences between the read adjacent pixels in the closest orientation and the second closest orientation and the focus pixel are calculated (step S64). Once the differences with the adjacent pixels have been calculated, it is determined whether the respective differences exceed a threshold set in advance (step S65), and when the threshold is not exceeded in either of such determinations, the present evaluation value is prevented from passing the gate unit 91 and is prohibited from being written into the evaluation value table (step S70).

When it is determined in step S65 that the differences between the focus pixel and the adjacent pixels in both the closest orientation and the second closest orientation exceed the threshold, a counter for a value showing that a spatial gradient is present counts up by one (step S66), the adjacent pixels in the closest orientation and the second closest orientation are read from the reference pixel memory 24 (step S67), and the differences between the read adjacent pixels in the closest orientation and the second closest orientation and the reference pixel are calculated (step S68). Once the differences with the adjacent pixels have been calculated, it is determined whether the respective differences exceed a threshold set in advance (step S69), and when the threshold is not exceeded in either of such determinations, the present evaluation value is prevented from passing the gate unit 91 and is prohibited from being written in the evaluation value table (step S70).

In addition, it is determined whether the absolute value of the difference between the focus pixel and the reference pixel obtained by detecting the pixel correlation at the correlation calculating unit 20′ and the correlation determining unit 30 is below a threshold (step S221). When this determination finds that the difference is below the threshold, the evaluation value is sent from the correlation determining unit 30 to the gate unit 91 included in the pixel selecting unit 90. After this, out of the data sent from the correlation determining unit 30 to the gate unit 91 in the pixel selecting unit 90 (i.e., the data where there is pixel correlation), the number (frequency) of evaluation values that have passed the gate unit 91 in the pixel selecting processing is written in the evaluation value table (step S222).

Note that in the flowchart shown in FIG. 20 also, although writing is carried out in the evaluation value table when the conditions are satisfied in both of the determination of a spatial gradient at the focus pixel and the determination of a spatial gradient at the reference pixel, it is also possible to allow the evaluation value to pass the gate unit 91 and carry out writing in the evaluation value table when the conditions are satisfied in one of the determination of a spatial gradient at the focus pixel and the determination of a spatial gradient at the reference pixel.

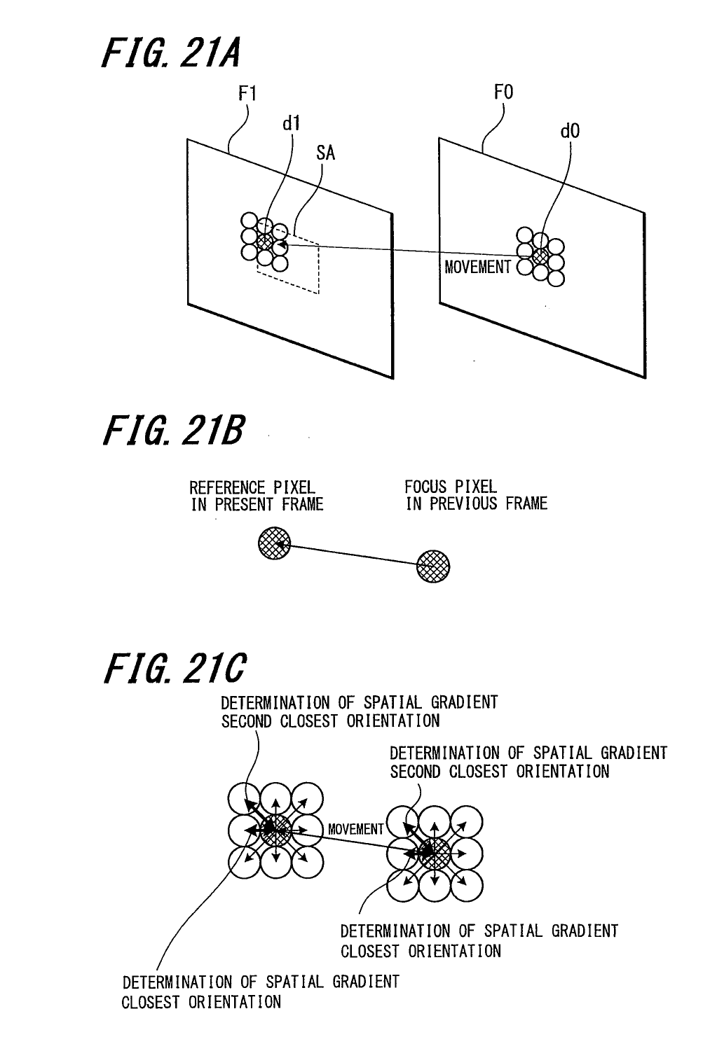

An overview of the processing with the configuration shown in FIG. 19 and the flowchart shown in FIG. 20 is given in FIGS. 21A, 21B, and 21C.

First, as shown in FIG. 21A, a pixel position used as a standard for determining the motion vectors in a previous frame F0 that is image data for one frame before the present frame F1 is set as the focus pixel d0. When the focus pixel d0 has been decided, the search area SA that is a predetermined range in the periphery of the pixel position of the focus pixel do is set inside the present frame F1. When the search area SA has been set, evaluation values are calculated with each pixel inside the search area SA as the reference pixel d1.

Next, as shown in FIG. 21B, the orientation of motion is determined from the relative position of the focus pixel d0 in the previous frame F0 and the reference pixel d1. In the example shown in FIG. 21B, an example of movement to the left and diagonally slightly upward to the horizontal is shown.

When the orientation of motion has been determined, as shown by the arrows drawn with thick lines in FIG. 21C, the focus pixel and the pixel that is adjacent in the closest orientation (in this example, horizontally to the left) to the orientation of motion out of the eight pixels in the range that are adjacent to the focus pixel are read out from the previous frame F0, and the difference between the read adjacent pixel and the focus pixel d0 is determined. The pixel that is adjacent in the second closest orientation (in this example, diagonally upward to the left) to the orientation of motion is also read out, and the difference between this read adjacent pixel and the focus pixel do is also determined.

In addition, for the pixels adjacent to the reference pixel, the pixel that is adjacent in the closest orientation (in this example, horizontally to the left) to the orientation of motion and the pixel that is adjacent in the second closest orientation (in this example, diagonally upward to the left) to the orientation of motion are read out, and the respective differences between the read adjacent pixels and the reference pixel d1 are determined.

In this determination, only when it has been determined that there is a spatial gradient in any of the closest orientation and the second closest orientation at the focus pixel and there is also a spatial gradient in any of the closest orientation and the second closest orientation at the reference pixel, the evaluation value of the reference pixel d1 at this time is written into the evaluation value table.

### 10. Example Where an LUT is Used in the Third Embodiment

Although it is determined whether there is a spatial gradient in the calculation processing in the example shown in FIGS. 19 and 20, in the present embodiment also, it is possible to use a configuration where the presence of a spatial gradient is determined using an LUT and a pattern memory.

FIG. 22 shows an example configuration that uses an LUT and a pattern memory in the case where it is determined whether spatial gradients are present at both the focus pixel and the reference pixel from the differences with adjacent pixels in the closest orientation and the second closest orientation to the orientation of motion.

This configuration will now be described with reference to FIG. 22. In the evaluation value table forming unit 12 shown in FIG. 22, the configuration of a pixel selecting unit 100 differs from that of the pixel selecting unit 90 in the evaluation value table forming unit 12 shown in FIG. 19, but the other parts (that is, the correlation calculating unit 20′, the correlation determining unit 30, and the evaluation value table calculating unit 50) are the same as the configuration shown in FIG. 19. In the evaluation value table forming unit 12 shown in FIG. 22, parts that are the same as in the evaluation value table forming unit 12 shown in FIG. 19 have been assigned the same reference numerals.

In the configuration shown in FIG. 22, the pixel selecting unit 100 includes a gate unit 101 and an evaluation value output from the correlation determining unit 30 is selected at the gate unit 101. As a configuration for controlling the gate unit 101, the pixel selecting unit 100 includes a spatial gradient pattern calculating unit 102, a reference pixel pattern memory 103, a focus pixel pattern memory 104, a pattern comparator unit 105, an motion orientation LUT 106, and an motion orientation calculating unit 107.

Whenever the pixel data of a frame is supplied, the spatial gradient pattern calculating unit 102 expresses, for each pixel, whether a spatial gradient is present between the focus pixel and a peripheral pixel using the value “0” or “1”, and stores such values as flags in the reference pixel pattern memory 103. After this, by referring to the flags, it is determined whether a spatial gradient is present based on an orientation where movement has been detected. Flags showing whether a spatial gradient is present at each pixel generated for the present frame (i.e., at each reference pixel) at a given time t can be used at a time t+1 when the next frame is obtained as flags showing whether a spatial gradient is present at each pixel in the previous frame (i.e., at each focus pixel). To do so, a configuration is used where the data stored in the reference pixel pattern memory 103 is moved to the focus pixel pattern memory 104.

In the motion orientation calculating unit 107, relationships between relative positions (movement) inside the search area and closest directions are calculated in advance, and the calculated data is stored as the motion orientation LUT 106. The values of the stored LUT are sent to the reference pixel pattern memory 103 and the focus pixel pattern memory 104, and the spatial gradient patterns for the closest orientation and the second closest orientation calculated by the spatial gradient pattern calculating unit 102 and the patterns for the two adjacent pixels in the orientation of motion read out from the motion orientation LUT 106 are compared for both the reference pixel and the focus pixel at the pattern comparator unit 105. When, as the comparison result, it is determined that a spatial gradient is present at both the focus pixel and the reference pixel, control is carried out to allow the evaluation value to pass the gate unit 101. Conversely, when it is determined that a spatial gradient is not present, control is carried out to prevent the evaluation value from passing the gate unit 101. When it has been determined by the pattern comparator unit 105 that spatial gradients are present, a counter (not shown) that counts up the number of pixels where there is a spatial gradient counts up by one.

FIG. 23 is a flowchart showing an example of processing with the configuration shown in FIG. 22.

As shown in FIG. 23, the processing carried out with the configuration shown in FIG. 22 includes: candidate detecting processing based on the pixel correlation detected by the correlation calculating unit 20′ and the correlation determining unit 30 and also processing where the pixel selecting unit 100 selects a candidate obtained at the correlation determining unit 30. This flowchart will now be described focusing on the processing by the pixel selecting unit 100.

First, the spatial gradient pattern calculating unit 102 calculates the relative position of the focus pixel in the previous frame and a reference pixel in the present frame (step S71) and determines the orientation of motion from the relative position. Data on the determined orientation of motion is read from the motion orientation LUT 106 (step S72), patterns of the adjacent pixels in the orientation of motion (here, the closest orientation and the second closest orientation) are read from the focus pixel pattern memory 104 (step S73), and the patterns of the differences with the adjacent pixels are determined (step S74). When this determination determines that a spatial gradient is not present at the focus pixel, the evaluation value is prevented from passing the gate unit 101 so that the evaluation value in question is not written into the evaluation value table memory 52 (step S78).

Conversely, when the determination determines that a spatial gradient is present, the counter that counts a value showing that a spatial gradient is present counts up by one (step S75), patterns of the adjacent pixels in the orientation of motion (here, the closest orientation and the second closest orientation) are read from the reference pixel pattern memory 103 (step S76), and the patterns of the differences with the adjacent pixel are determined (step S77). When the determination determines that there is no spatial gradient at the reference pixel, the evaluation value is prevented from passing the gate unit 101 and the evaluation value in question is not written into the evaluation value table memory 52 (step S78).

It is also determined whether the absolute value of the difference between the focus pixel and the reference pixel obtained by detecting the pixel correlation at the correlation calculating unit 20′ and the correlation determining unit 30 is below a threshold (step S231). When the determination finds that the difference is below the threshold, the evaluation value is sent from the correlation determining unit 30 to the gate unit 101 included in the pixel selecting unit 100. Conversely, when it is determined that the difference between the focus pixel and the reference pixel is not below the threshold, the evaluation value is not sent to the gate unit 101 and the evaluation value in question is not written in the evaluation value table memory 52 (step S78).

After this, the number (i.e., frequency) of values that have been allowed in the pixel selection to pass the gate unit 101 out of the data sent from the correlation determining unit 30 to the gate unit 101 in the pixel selecting unit 100 (i.e., the data where there is pixel correlation) is written into the evaluation value table (step S232).

As shown in FIGS. 22 and 23, even if an LUT and a pattern memory are used, it will still be possible to generate an evaluation value table using the orientation of motion at a focus pixel and the orientation of motion at a reference pixel. Using an LUT and a pattern memory, it is possible to reduce the load of the calculation processing.

Note that in the flowchart shown in FIG. 23 also, although writing is carried out in the evaluation value table when the conditions are satisfied for both the determination of a spatial gradient at the focus pixel and the determination of a spatial gradient at the reference pixel, it is also possible to allow the evaluation value to pass the gate unit 101 and carry out writing in the evaluation value table when the conditions are satisfied in one of the determination of a spatial gradient at the focus pixel and the determination of a spatial gradient at the reference pixel.

### 11. Fourth Embodiment

A fourth embodiment of the present invention will now be described with reference to FIGS. 24 to 27.

The present embodiment also relates to a motion vector detecting apparatus that detects motion vectors from moving image data. This motion vector detecting apparatus is the same as the first embodiment described above in that an evaluation value table is formed from pixel value correlation information and motion vectors are determined from the data of such evaluation value table.

The overall configuration and overall processing of the motion vector detecting apparatus are the same as the configuration shown in FIG. 3 and the flowchart shown in FIG. 4 described earlier in the first embodiment. The configuration of the evaluation value table forming unit 12 in the motion vector detecting apparatus shown in FIG. 3 is fundamentally the same as the evaluation value table forming unit 12 in the respective embodiments described above, but the data processing carried out at the various units is the processing shown by the flowchart in FIG. 24. In the following description, it is assumed that the evaluation value table forming unit 12 has the configuration shown in FIG. 22.

In the present embodiment, an evaluation value table is formed having taken into account a plurality of spatial gradients in the orientation of motion at both the focus pixel and the reference pixel. Here, as the plurality of spatial gradients, reference is made to the closest orientation to the orientation of motion and the orientations of normals to the orientation of motion. The definitions of “focus pixel” and “reference pixel” are the same as those described above earlier in the first and second embodiments. That is, a focus pixel is a pixel position of a point (standard point) used as a standard for determining a motion vector and a reference pixel is a pixel within a search area in an earlier or later frame than the focus pixel.

In the flowchart shown in FIG. 24, processing steps that are the same as in the flowchart in FIG. 23 have been assigned the same reference numerals. In the present embodiment, the read orientations in step S73′ and step S76′ differ from the previous flowchart.

That is, it is determined whether the absolute value of the difference between the focus pixel and the reference pixel is below a threshold (step S231). When this determination finds that the difference is below the threshold, the evaluation value is sent from the correlation determining unit 30 to the gate unit 101 included in the pixel selecting unit 100.

As the processing of the pixel selecting unit 100, the spatial gradient pattern calculating unit 102 calculates the relative position of the focus pixel in the previous frame and a reference pixel in the present frame (step S71) and determines the orientation of motion from the relative position. Data on the determined orientation of motion is read from the motion orientation LUT 106 (step S72).

After this, spatial gradient patterns of an adjacent pixel in the orientation of motion and adjacent pixels in the orientation of normals that are perpendicular to the orientation of motion are read from the focus pixel pattern memory 104 (step S73′). Patterns of the differences between the adjacent pixels read in this way and the pattern read from the motion orientation LUT 106 are then determined (step S74). When this determination determines that a spatial gradient is not present at the focus pixel, the evaluation value is prevented from passing the gate unit 101 so that the evaluation value in question is not written into the evaluation value table memory 52 (step S78). Conversely, when the determination determines that a spatial gradient is present, the counter that counts a value showing that a spatial gradient is present counts up by one (step S75).

In addition, the spatial gradient patterns of the adjacent pixel in the orientation of motion and the adjacent pixels in the orientations of normals that are perpendicular to the orientation of motion are read from the reference pixel pattern memory 103 (step S76′). Patterns of the differences between the adjacent pixels read in this way and the pattern read from the motion orientation LUT 106 are then determined (step S77). When the determination determines that there is no spatial gradient at the reference pixel, the evaluation value is prevented from passing the gate unit 101 and the evaluation value in question is not written into the evaluation value table memory 52 (step S78).

It is also determined whether the absolute value of the difference between the focus pixel and the reference pixel obtained by detecting the pixel correlation at the correlation calculating unit 20′ and the correlation determining unit 30 is below a threshold (step S231). When the determination finds that the difference is below the threshold, the evaluation value is sent from the correlation determining unit 30 to the gate unit 101 included in the pixel selecting unit 100. Conversely, when it is determined that the difference is not below the threshold, the evaluation value is not sent to the gate unit 101 and the evaluation value in question is not written in the evaluation value table memory 52 (step S78).

After this, the number (i.e., frequency) of values that have been allowed in the pixel selection to pass the gate unit 101 out of the data sent from the correlation determining unit 30 to the gate unit 101 in the pixel selecting unit 100 (i.e., the data where there is pixel correlation) is written into the evaluation value table (step S232).

Note that in the flowchart shown in FIG. 24 also, although writing is carried out in the evaluation value table when the conditions are satisfied for both the determination of a spatial gradient at the focus pixel and the determination of a spatial gradient at the reference pixel, it is also possible to allow the evaluation value to pass the gate unit 101 and carry out writing in the evaluation value table when the conditions are satisfied in one of the determination of a spatial gradient at the focus pixel and the determination of a spatial gradient at the reference pixel.

An overview of the processing in the flowchart shown in FIG. 24 is given in FIGS. 25A, 25B, and 25C.

First, as shown in FIG. 25A, the focus pixel d0 is set in the previous frame F0 and a reference point d1 is set in the search area SA in the present frame F1 in the same way as in the embodiments described above. As shown in FIG. 25B, the orientation of motion is determined from the relative position of the focus pixel d0 in the previous frame F0 and the reference pixel d1, which is also the same as in the embodiments described above. In the example shown in FIG. 25B, an example of movement to the left and diagonally slightly upward to the horizontal is shown.

In the present embodiment, when the orientation of motion has been determined, as shown by the arrows drawn with thick lines in FIG. 25C, the focus pixel and the pixel that is adjacent in the closest orientation (in this example, horizontally to the left) to the orientation of motion out of the eight pixels in the range that are adjacent to the focus pixel are read out from the previous frame F0, and the difference between the read adjacent pixel and the focus pixel do is determined. In addition, pixels that are adjacent in the orientations of normals that are perpendicular to the orientation of motion (in this example, directly above and directly below the focus pixel) are also read out, and the differences between these read adjacent pixels and the focus pixel d0 are determined.

In addition, among the pixels adjacent to the reference pixel also, the pixel that is adjacent in the closest orientation to the orientation of motion (in this example, horizontally to the left) and pixels that are adjacent in the orientations of normals that are perpendicular to the orientation of motion (in this example, directly above and directly below the reference pixel) are read out, and the respective differences between the read adjacent pixels and the reference pixel d1 are determined.

In this determination, only when it has been determined that there are spatial gradients for all of the adjacent pixels in the closest orientation and the orientations of normals at the focus pixel and there is a spatial gradient for any of the adjacent pixels in the closest orientation and the orientations of normals at the reference pixel, the evaluation value of the reference pixel d1 at this time is written into the evaluation value table.

In this way, it is possible to make a suitable determination of whether a spatial gradient is present by determining spatial gradients in the orientation of motion and the orientations of normals.

### 12. Modification to the Fourth Embodiment

An adjacent pixel in one orientation that is closest to the orientation of motion is selected as the adjacent pixel in the orientation of motion in the examples shown in FIGS. 24 and 25A to 25C. However, as described above in the third embodiment, as the adjacent pixels in the orientation of motion, it is possible to read an adjacent pixel in the closest orientation to the orientation of motion and to further read an adjacent pixel in the second closest orientation to the orientation of motion, and then to further read adjacent pixels in the orientations of normals to both the closest orientation and the second closest orientation.

The flowchart in FIG. 26 shows an example of processing in this case. In the flowchart shown in FIG. 26, processing steps that are the same as in the flowcharts shown in FIGS. 23 and 24 have been assigned the same reference numerals. In the present embodiment, the orientations read in steps S73″ and S76″ differ from the previous flowcharts.

That is, it is determined whether the absolute value of the difference between the focus pixel and the reference pixel is below a threshold (step S231). When this determination finds that the difference is below the threshold, the evaluation value is sent from the correlation determining unit 30 to the gate unit 101 included in the pixel selecting unit 100.

As the processing of the pixel selecting unit 100, the spatial gradient pattern calculating unit 102 calculates the relative position of the focus pixel in the previous frame and a reference pixel in the present frame (step S71) and determines the orientation of motion from the relative position. Data on the determined orientation of motion is read from the motion orientation LUT 106 (step S72).

After this, an adjacent pixel in the closest orientation to the orientation of motion, an adjacent pixel in the second closest orientation to the orientation of motion, spatial gradient patterns of adjacent pixels in the orientations of normals that are perpendicular to the closest orientation to the orientation of motion, and spatial gradient patterns of adjacent pixels in the orientations of normals that are perpendicular to the second closest orientation to the orientation of motion are read from the focus pixel pattern memory 104 (step S73″). Patterns of the differences between the adjacent pixels read in this way and the pattern read from the motion orientation LUT 106 are then determined (step S74). When this determination determines that a spatial gradient is not present at the focus pixel, the evaluation value is prevented from passing the gate unit 101 so that the evaluation value in question is not written into the evaluation value table memory 52 (step S78). Conversely, when the determination determines that a spatial gradient is present, the counter that counts a value showing that a spatial gradient is present counts up by one (step S75).

In addition, an adjacent pixel in the closest orientation to the orientation of motion, an adjacent pixel in the second closest orientation to the orientation of motion, spatial gradient patterns of adjacent pixels in the orientations of normals that are perpendicular to the closest orientation to the orientation of motion, and spatial gradient patterns of adjacent pixels in the orientations of normals that are perpendicular to the second closest orientation to the orientation of motion are read from the reference pixel pattern memory 103 (step S76″). Patterns of the differences between the adjacent pixels read in this way and the pattern read from the motion orientation LUT 106 are then determined (step S77) When the determination determines that there is no spatial gradient at the reference pixel, the evaluation value is prevented from passing the gate unit 101 and the evaluation value in question is not written into the evaluation value table memory 52 (step S78).

It is also determined whether the absolute value of the difference between the focus pixel and the reference pixel obtained by detecting the pixel correlation at the correlation calculating unit 20′ and the correlation determining unit 30 is below a threshold (step S231). When the determination finds that the difference is below the threshold, the evaluation value is sent from the correlation determining unit 30 to the gate unit 101 included in the pixel selecting unit 100. Conversely, when it is determined that the difference is not below the threshold, the evaluation value is not sent to the gate unit 101 and the evaluation value in question is not written in the evaluation value table memory 52 (step S78).

After this, the number (i.e., frequency) of values that have been allowed in the pixel selection to pass the gate unit 101 out of the data sent from the correlation determining unit 30 to the gate unit 101 in the pixel selecting unit 100 (i.e., the data where there is pixel correlation) is written into the evaluation value table (step S232).

Note that in the flowchart shown in FIG. 26 also, although writing is carried out in the evaluation value table when the conditions are satisfied for both the determination of a spatial gradient at the focus pixel and the determination of a spatial gradient at the reference pixel, it is also possible to allow the evaluation value to pass the gate unit 101 and carry out writing in the evaluation value table when the conditions are satisfied in one of the determination of a spatial gradient at the focus pixel and the determination of a spatial gradient at the reference pixel.

Also, although the adjacent pixels in the orientations of normals to the closest orientation and the adjacent pixels in the orientations of normals to the second closest orientation are read in the flowchart in FIG. 26, it is also possible to read the adjacent pixels in the orientations of normals to the closest orientation but not read adjacent pixels in the orientations of normals to the second closest orientation.

Alternatively, it is possible to determine whether a spatial gradient is present by reading only the adjacent pixel in the second closest orientation at only one of the focus pixel and the reference pixel.

An overview of the processing in the flowchart shown in FIG. 26 is given in FIGS. 27A , 27B, and 27C.

First, as shown in FIG. 27A, the focus pixel d0 is set in the previous frame F0 and a reference pixel d1 is set in the search area SA in the present frame F1 in the same way as in the embodiments described above. Also, as shown in FIG. 27B, the orientation of motion (i.e., a movement to the left and diagonally slightly upward to the horizontal) is determined from the relative position of the focus pixel do in the previous frame F0 and the reference pixel d1 in the same way as in the embodiments described above.

In the present embodiment, when the orientation of motion has been determined, as shown by the arrows drawn with thick lines in FIG. 27C, the focus pixel and the pixel that is adjacent in the closest orientation (in this example, horizontally to the left) to the orientation of motion out of the eight pixels in the range that are adjacent to the focus pixel are read out from the previous frame F0. The pixel that is adjacent in the second closest orientation (in this example, diagonally upward to the left) to the orientation of motion is also read out, and the respective differences between the read adjacent pixels and the focus pixel d0 are determined. Pixels that are adjacent in the orientations of normals that are perpendicular to the orientation of motion (in this example, directly above and directly below the focus pixel) are also read out and the differences between the read adjacent pixels and the focus pixel d0 are determined. Similarly, pixels that are adjacent in the orientations of normals to the second closest orientation (in this example, diagonally below to the left and diagonally above to the right of the focus pixel) are read out and the differences between the read adjacent pixels and the focus pixel d0 are determined.

Among the pixels adjacent to the reference pixel also, a pixel that is adjacent in the closest orientation (in this example, horizontally to the left) to the orientation of motion is read out, and the pixel that is adjacent in the second closest orientation (in this example, diagonally upward to the left) is also read out. Among the pixels adjacent to the reference pixel, pixels that are adjacent in the orientations of normals that are perpendicular to the closest orientation (in this example, directly above and directly below the reference pixel) are read out, and pixels that are adjacent in the orientations of normals that are perpendicular to the second closest orientation (in this example, diagonally below to the left and diagonally above to the right of the focus pixel) are also read out. The respective differences between the read adjacent pixels and the reference pixel d1 are determined.

In this determination, only when it has been determined that there is a spatial gradient for an adjacent pixel in any of the closest orientations and the orientations of normals at the focus pixel and there is a spatial gradient for an adjacent pixel in any of the closest orientations and the orientations of normals at the reference pixel also, the evaluation value of the reference pixel d1 at this time is written into the evaluation value table.

In this way, it is possible to make a suitable determination of whether a spatial gradient is present by determining spatial gradients in the orientation of motion and the orientations of normals.

Note that in the above description, although it is determined that there is a spatial gradient when there is a difference that exceeds the threshold for the adjacent pixels in the closest orientation to the orientation of motion and in the orientations of normals to the closest orientation, it is also possible to determine that there is a spatial gradient when there is a difference that exceeds the threshold for any of the adjacent pixel in the closest orientation to the orientation of motion or one or two of the adjacent pixels in the orientations of normals to such orientation.

### 13. Example of an Evaluation Value Table Generated in the Fourth Embodiment

FIGS. 28 and 29 show examples of evaluation value tables formed by the processing in the third and fourth embodiments for a test image (a different image to the example image in FIG. 10).

FIG. 28 shows one example of an evaluation value table produced according to the third embodiment, that is, an evaluation value table that has been totaled after carrying out a determination of whether spatial gradients are present in the closest orientation and the second closest orientation at both the focus pixel and the reference pixel. In this example test image, there are two moving objects, and peaks showing the positions of the two moving objects correctly show the respective positions of the objects.

FIG. 29 shows one example of an evaluation value table produced according to the fourth embodiment, that is, an evaluation value table that has been totaled after carrying out a determination of whether spatial gradients are present in the orientation of motion and the orientations of normals at both the focus pixel and the reference pixel. In this example also, peaks showing the positions of the two moving objects correctly show the respective positions of the objects.

### 14. Fifth Embodiment

A fifth embodiment of the present invention will now be described with reference to FIGS. 30 to 38.

The present embodiment also relates to a motion vector detecting apparatus that detects motion vectors from moving image data. This motion vector detecting apparatus is the same as the first embodiment described above in that an evaluation value table is formed from pixel value correlation information and motion vectors are determined from the data of such evaluation value table.

The overall configuration and overall processing of the motion vector detecting apparatus are the same as the configuration shown in FIG. 3 and the flowchart shown in FIG. 4 described earlier in the first embodiment.

In the present embodiment, the evaluation value table forming unit 12 in the motion vector detecting apparatus shown in FIG. 3 is configured as shown in FIG. 30. In the evaluation value table forming unit 12 shown in FIG. 30, parts that are the same as the evaluation value table forming unit 12 of the first to third embodiments shown in FIGS. 5, 13, and 19 and described earlier have been assigned the same reference numerals.

In the present embodiment, as an adjacent pixel relating to the orientation of motion, an adjacent pixel in an opposite orientation to the orientation of motion is read and a difference with such adjacent pixel is determined. The definitions of “focus pixel” and “reference pixel” are the same as those given above in the earlier embodiments. That is, a focus pixel is a pixel position of a point (standard point) used as a standard for determining a motion vector and a reference pixel is a pixel within a search area in an earlier or later frame than the focus pixel.

The example configuration shown in FIG. 30 will now be described. An image signal obtained at the input terminal 11 is supplied to a correlation calculating unit 20′ inside the evaluation value table forming unit 12. The correlation calculating unit 20′ includes a reference pixel memory 24, a focus pixel memory 25, and an absolute value calculating unit 26. The reference pixel memory 24 stores pixel values of the image signal of the present frame obtained at the input terminal 11 and when one frame period has passed, the stored data is moved to the focus pixel memory 25. In the absolute value calculating unit 26, the pixel value of the focus pixel read from the focus pixel memory 25 is compared with a pixel value of the reference pixel read from the reference pixel memory 24 and the absolute value of the difference is calculated.

After this, the detected difference data is supplied to the correlation determining unit 30. The correlation determining unit 30 includes a comparator unit 31 that compares the supplied difference with a set threshold to obtain an evaluation value. As the evaluation value, as one example a binary value is set so that the correlation is “high” when the difference is equal to or below the threshold and so that the correlation is “low” when the difference exceeds the threshold.

The evaluation value obtained at the correlation determining unit 30 is supplied to a pixel selecting unit 110. The pixel selecting unit 110 includes a gate unit 111 that selects the binary value output from the correlation determining unit 30. As a configuration for controlling the gate unit 111, the pixel selecting unit 110 includes an motion orientation calculating unit 112, a spatial gradient determining unit 113, and a comparator unit 114. The motion orientation calculating unit 112 calculates the relative position of the focus pixel and the reference pixel from the data stored in the reference pixel memory 24 and the data stored in the focus pixel memory 25 and calculates the orientation of motion from the relative position.

When the orientation of motion has been calculated, the spatial gradient determining unit 113 reads the pixel data of the reference pixel and the adjacent pixel in the opposite orientation to the orientation of motion from the reference pixel memory 24 and calculates the difference in pixel values between the pixel data of the reference pixel and the adjacent pixel data.

The spatial gradient determining unit 113 also reads the pixel data of the focus pixel and the adjacent pixel in the opposite orientation to the orientation of motion from the focus pixel memory 25 and calculates the difference in pixel values between the pixel data of the focus pixel and the adjacent pixel data.

The comparator unit 114 determines if the difference with the adjacent pixel in the opposite orientation to the orientation of motion exceeds a threshold at both the focus pixel and the reference pixel. When both differences exceed the threshold, the evaluation value supplied to the gate unit 111 is allowed to pass. When the difference does not exceed the threshold at either of the focus pixel and the reference pixel, the evaluation value supplied to the gate unit 111 is prevented from passing.

The evaluation values that have passed the gate unit 111 included in the pixel selecting unit 110 are supplied to an evaluation value table calculating unit 50, are totaled by an evaluation value totaling unit 51, and the totaled result is stored in an evaluation value table memory 52. After this, the data stored in the evaluation value table memory 52 is supplied as evaluation value table data from an output terminal 12a to a circuit that forms the next stage. Note that the number of pixels where it has been determined, in the determination by the pixel selecting unit 110 which uses the threshold, that a spatial gradient is present is counted by a counter (not shown).

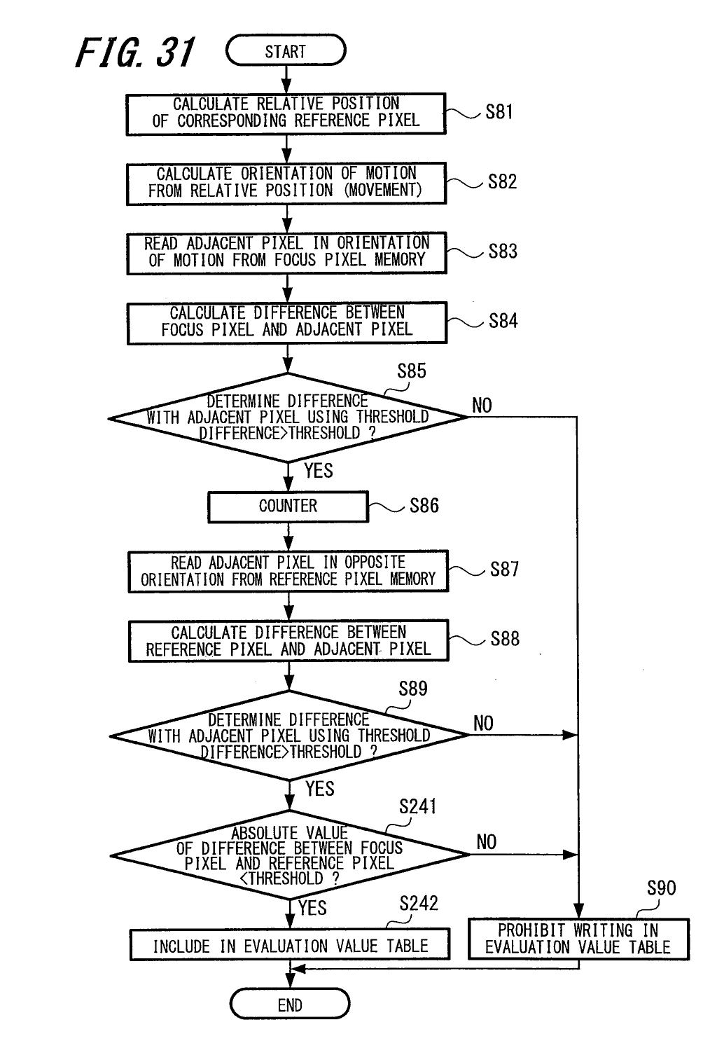

FIG. 31 is a flowchart showing a processing operation with the configuration shown in FIG. 30.

As shown in FIG. 31, the processing carried out with the configuration shown in FIG. 30 includes: candidate detecting processing based on the pixel correlation detected by the correlation calculating unit 20′ and the correlation determining unit 30 and also processing where the pixel selecting unit 110 selects a candidate obtained at the correlation determining unit 30. This flowchart will now be described focusing on the processing by the pixel selecting unit 110.

First, the motion orientation calculating unit 112 calculates the relative position of the reference pixel and the focus pixel corresponding to such reference pixel (step S81) and calculates the orientation of motion from such relative position (step S82). After this, the pixel data of the adjacent pixel in the opposite direction to the orientation of motion is read from the focus pixel memory 25 (step S83) and the difference between the read adjacent pixel in the opposite orientation and the focus pixel is calculated (step S84). Once the difference with the adjacent pixel has been calculated, it is determined whether the difference exceeds a threshold set in advance (step S85), and when the threshold is not exceeded in such determination, the present evaluation value is prevented from passing the gate unit 111 and is prohibited from being written into the evaluation value table (step S90).

When it is determined in step S85 that the difference between the focus pixel and the adjacent pixel exceeds the threshold, a counter for a value showing that a spatial gradient is present counts up by one (step S86), the adjacent pixel in the opposite orientation to the orientation of motion is read from the reference pixel memory 24 (step S87), and the difference between the read adjacent pixel in the opposite orientation to the orientation of motion and the reference pixel is calculated (step S88). Once the difference with the adjacent pixel has been calculated, it is determined whether the difference exceeds a threshold set in advance (step S89), and when it is determined that the difference does not exceed the threshold, the present evaluation value is prevented from passing the gate unit 111 and is prohibited from being written in the evaluation value table (step S90).

In addition, it is determined whether the absolute value of the difference between the focus pixel and the reference pixel obtained at the correlation calculating unit 20′ is below a threshold (step S241). When this determination finds that the difference is below the threshold, the evaluation value is sent from the correlation determining unit 30 to the gate unit 111 included in the pixel selecting unit 100. When the difference is not below the threshold, the evaluation value is not sent to the gate unit 111 so that the evaluation value in question is not written into the evaluation value table memory 52 (step S90)

Also, when the difference is below the threshold in step S241, the evaluation value is sent from the correlation determining unit 30 to the gate unit 111 in the pixel selecting unit 110.

After the processing thusfar has been carried out, the number (i.e., frequency) of values that have been allowed in the pixel selection to pass the gate unit 111 out of the data sent from the correlation determining unit 30 to the gate unit 111 in the pixel selecting unit 110 (i.e., the data where there is pixel correlation) is written into the evaluation value table (step S242).

Note that in the flowchart shown in FIG. 31 also, although writing is carried out in the evaluation value table when the conditions are satisfied for both the determination of a spatial gradient at the focus pixel and the determination of a spatial gradient at the reference pixel, it is also possible to allow the evaluation value to pass the gate unit 111 and carry out writing in the evaluation value table when the conditions are satisfied in one of the determination of a spatial gradient at the focus pixel and the determination of a spatial gradient at the reference pixel.

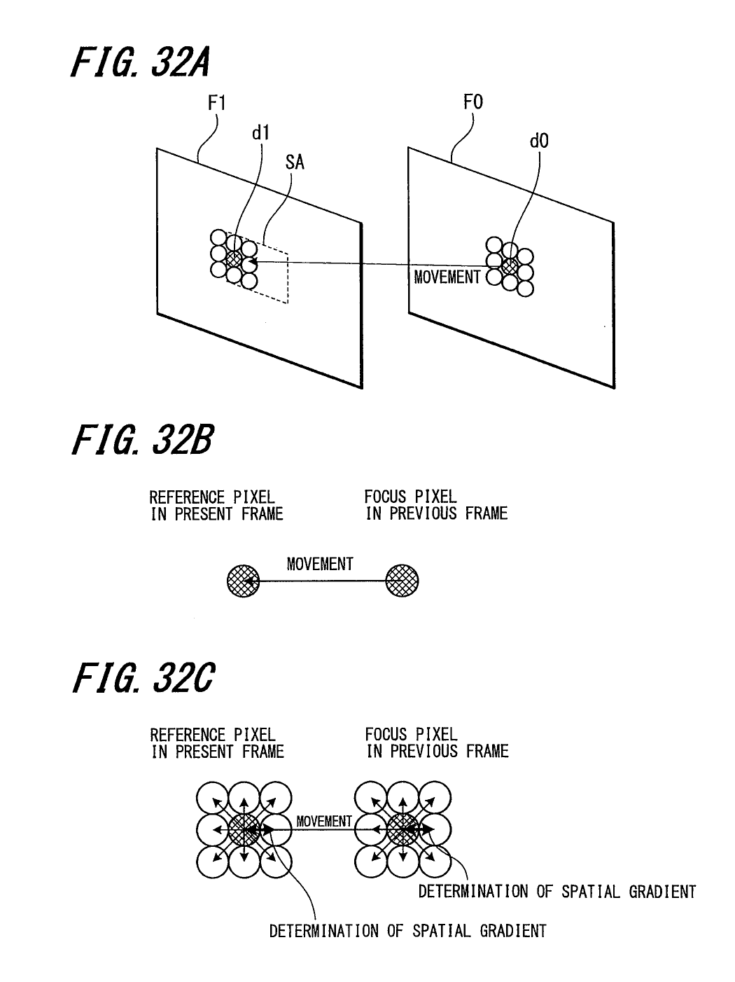

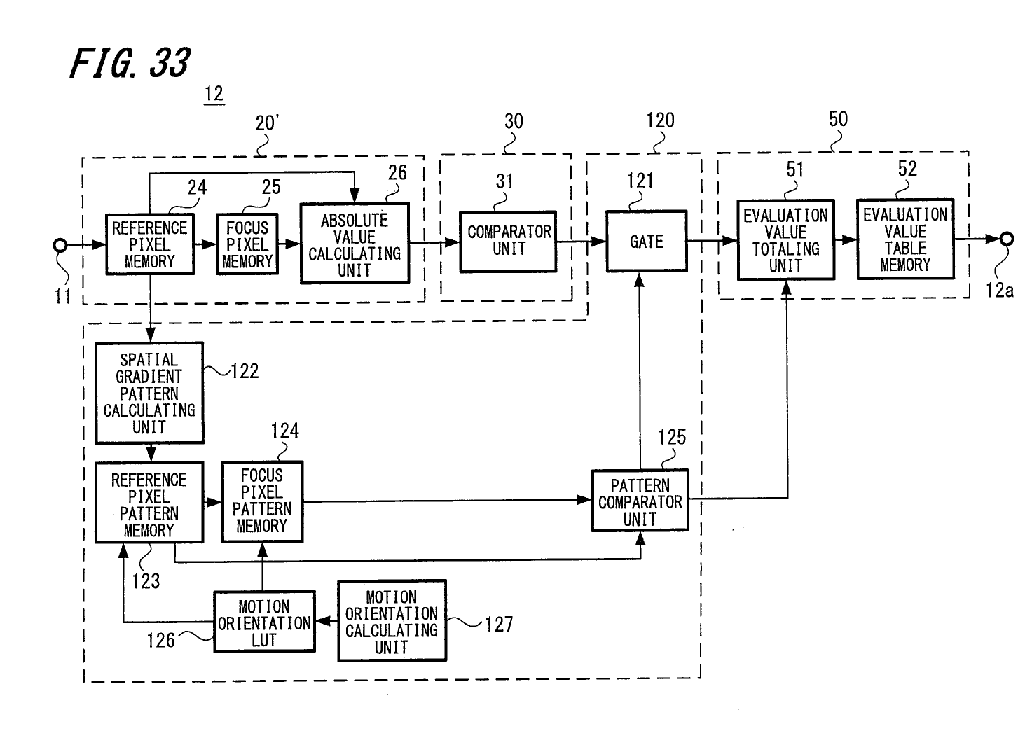

An overview of the processing with the configuration shown in FIG. 30 and the flowchart shown in FIG. 31 is given in FIGS. 32A, 32B, and 32C.

First, as shown in FIG. 32A, the focus pixel d0 is set in the previous frame F0 and a reference pixel d1 is set in the search area SA of the present frame F1 in the same way as in the embodiments described above. Also, as shown in FIG. 32B, the orientation of motion is determined from the relative position of the focus pixel d0 in the previous frame F0 and the reference pixel d1 in the same way as in the embodiments described above. In the example in FIG. 32B, horizontal movement to the left is shown.

In the present embodiment, when the orientation of motion has been determined, as shown by the arrows drawn with the thick line in FIG. 32C, the focus pixel and the pixel that is adjacent in the opposite orientation (in this example, horizontally to the right) to the orientation of motion out of the eight pixels in the range that are adjacent to the focus pixel are read out from the previous frame F0, and the difference between the read adjacent pixel and the focus pixel d0 is determined.

Among the pixels that are adjacent to the reference pixel also, the pixel that is adjacent in the opposite orientation (in this example, horizontally to the right) to the orientation of motion is read out, and the difference between the read adjacent pixel and the reference pixel d1 is determined.

In this determination, only when it has been determined that there is a spatial gradient for the adjacent pixel at the focus pixel and there is also a spatial gradient for the adjacent pixel at the reference pixel, the evaluation value of the reference pixel d1 at this time is written into the evaluation value table.

In this way, it is possible to make a suitable determination of whether a spatial gradient is present by determining a spatial gradient in the opposite orientation to the orientation of motion.

### 15. Alternative Example for the Fifth Embodiment

Although only the adjacent pixel in the opposite orientation to the orientation of motion is read and a difference thereof is determined in the example in FIGS. 30 and 31, it is also possible to read a plurality of adjacent pixels, such as both the adjacent pixel in the orientation of motion and the adjacent pixel in the opposite orientation to the orientation of motion, and determine the respective differences for such adjacent pixels.

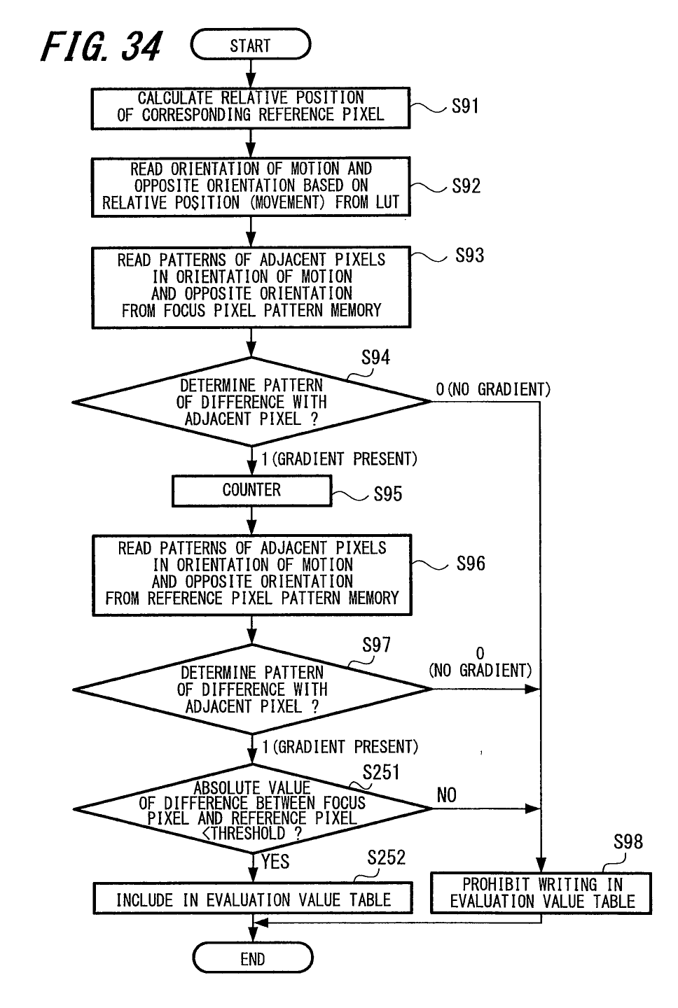

FIGS. 33 and 34 show the configuration and a flowchart when reading the adjacent pixel in the orientation of motion and the adjacent pixel in the opposite orientation to the orientation of motion and determining the respective differences for such adjacent pixels.

First, the configuration will be described with reference to FIG. 33. In the evaluation value table forming unit 12 shown in FIG. 33, the configuration of a pixel selecting unit 120 differs from that of the pixel selecting unit 100 included in the evaluation value table forming unit 12 shown in FIG. 22, but the other parts (that is, the correlation calculating unit 20′, the correlation determining unit 30, and the evaluation value table calculating unit 50) are the same as in the configuration shown in FIG. 22. In the evaluation value table forming unit 12 shown in FIG. 33, parts that are the same as in the evaluation value table forming unit 12 shown in FIG. 22 have been assigned the same reference numerals.

In the configuration in FIG. 33, the pixel selecting unit 120 includes a gate unit 121 and an evaluation value output from the correlation determining unit 30 is selected by the gate unit 121. As a configuration for controlling the gate unit 121, the pixel selecting unit 120 includes a spatial gradient pattern calculating unit 122, a reference pixel pattern memory 123, a focus pixel pattern memory 124, a pattern comparator unit 125, an motion orientation LUT 126, and an motion orientation calculating unit 127.

Whenever the pixel data of a frame is supplied, the spatial gradient pattern calculating unit 122 expresses, for each pixel, whether a spatial gradient is present between the focus pixel and a peripheral pixel using the value “0” or “1”, and stores such values as flags in the reference pixel pattern memory 123. After this, by referring to the flags, it is determined whether a spatial gradient is present based on an orientation where movement has been detected. Flags showing whether a spatial gradient is present at each pixel generated for the present frame (i.e., at each reference pixel) at a given time t can be used at a time t+1 when the next frame is obtained as flags showing whether a spatial gradient is present at each pixel in the previous frame (i.e., at each focus pixel). To d0 so, a configuration is used where the data stored in the reference pixel pattern memory 123 is moved to the focus pixel pattern memory 124.

In the motion orientation calculating unit 127, relationships between relative positions (movement) inside the search area and closest directions are calculated in advance, and the calculated data is stored as the motion orientation LUT 126. The values of the stored LUT are sent to the reference pixel pattern memory 123 and the focus pixel pattern memory 124, and (i) a spatial gradient pattern calculated by the spatial gradient pattern calculating unit 122 having considered the adjacent pixel in the same orientation as the orientation of motion and the adjacent pixel in the opposite orientation and (ii) patterns for the two orientations read out from the motion orientation LUT 126 are compared for both the reference pixel and the focus pixel at the pattern comparator unit 125. When, as the comparison result, it is determined that a spatial gradient is present at both the focus pixel and the reference pixel, control is carried out to allow the evaluation value to pass the gate unit 121. Conversely, when it is determined that a spatial gradient is not present, control is carried out to prevent the evaluation value from passing the gate unit 121. When it has been determined by the pattern comparator unit 125 that there is a spatial gradient, a counter (not shown) that counts up the number of pixels where there is a spatial gradient counts up by one.

FIG. 34 is a flowchart showing an example of processing with the configuration shown in FIG. 33.

As shown in FIG. 34, the processing carried out with the configuration shown in FIG. 33 includes: candidate detecting processing based on the pixel correlation detected by the correlation calculating unit 20′ and the correlation determining unit 30 and also processing where the pixel selecting unit 120 selects a candidate obtained at the correlation determining unit 30. This flowchart will now be described focusing on the processing by the pixel selecting unit 120.

First, the spatial gradient pattern calculating unit 122 calculates the relative position of the focus pixel in the previous frame and a reference pixel in the present frame (step S91) and determines the orientation of motion from the relative position. Data on the determined orientation of motion and data on the opposite orientation is read from the motion orientation LUT 126 (step S92), patterns of the adjacent pixels in the orientation of motion and the opposite orientation are read from the focus pixel pattern memory 124 (step S93), and the patterns of the respective differences with the adjacent pixels are determined (step S94). When this determination determines that a spatial gradient is not present at the focus pixel, the evaluation value is prevented from passing the gate unit 121 so that the evaluation value in question is not written into the evaluation value table memory 52 (step S98).

Conversely, when the determination determines that a spatial gradient is present, the counter that counts a value showing that a spatial gradient is present counts up by one (step S95), the patterns of the adjacent pixels in the orientation of motion and the opposite orientation are read from the reference pixel pattern memory 123 (step S96), and the patterns of the differences with the adjacent pixels are determined (step S97) When the determination determines that there is no spatial gradient at the reference pixel, the evaluation value is prevented from passing the gate unit 121 and the evaluation value in question is not written into the evaluation value table memory 52 (step S98).

It is also determined whether the absolute value of the difference between the focus pixel and the reference pixel obtained at the correlation calculating unit 20′ and the correlation determining unit 30 is below a threshold (step S251) When the determination finds that the difference is below the threshold, the evaluation value is sent from the correlation determining unit 30 to the gate unit 121 included in the pixel selecting unit 120. Conversely, when it is determined that the difference between the focus pixel and the reference pixel is not below the threshold, the evaluation value is not sent to the gate unit 121 and the evaluation value in question is not written in the evaluation value table memory 52 (step S98).

After this, the number (i.e., frequency) of values that have been allowed in the pixel selection to pass the gate unit 121 out of the data sent from the correlation determining unit 30 to the gate unit 121 of the pixel selecting unit 120 (i.e., the data where there is pixel correlation) is written into the evaluation value table (step S252).

Note that in the flowchart shown in FIG. 34, although writing is carried out in the evaluation value table when the conditions are satisfied for both the determination of a spatial gradient at the focus pixel and the determination of a spatial gradient at the reference pixel, it is also possible to allow the evaluation value to pass the gate unit 121 and carry out writing in the evaluation value table when the conditions are satisfied in one of the determination of a spatial gradient at the focus pixel and the determination of a spatial gradient at the reference pixel.

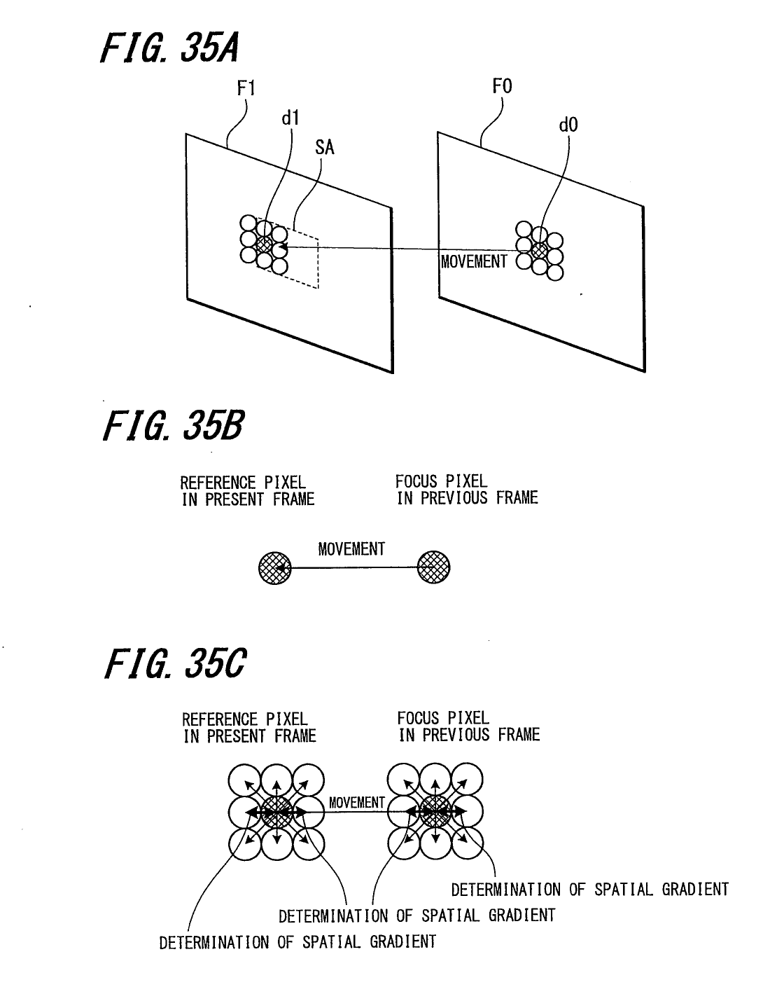

An overview of the processing with the configuration shown in FIG. 33 and the flowchart shown in FIG. 34 is given in FIGS. 35A, 35B, and 35C.

First, as shown in FIG. 35A, the focus pixel d0 is set in the previous frame F0 and the reference pixel d1 is set in the search area SA in the present frame F1 in the same way as in the embodiments described above. Also, as shown in FIG. 35B, the orientation of motion is determined from the relative position of the focus pixel d0 in the previous frame F0 and the reference pixel d1 in the same way as in the embodiments described above. In the example shown in FIG. 35B, horizontal movement to the left is shown.

In the present embodiment, when the orientation of motion has been determined, as shown by the arrows drawn with thick lines in FIG. 35C, the focus pixel and the pixel that is adjacent in the orientation of motion (that is, horizontally to the left) out of the eight pixels in the range that are adjacent to the focus pixel are read out from the previous frame F0, the pixel that is adjacent in the opposite orientation (in this example, horizontally to the right) to the orientation of motion is also read out, and the differences between the read adjacent pixels and the focus pixel d0 are determined.

Among the pixels adjacent to the reference pixel also, the pixel that is adjacent in the orientation of motion (that is, horizontally to the left) is read out, the pixel that is adjacent in the opposite orientation (in this example, horizontally to the right) to the orientation of motion is also read out, and the differences between the read adjacent pixels and the reference pixel d1 are determined.

In this determination, only when it has been determined that there is a spatial gradient with the adjacent pixels in both directions at the focus pixel and there is a spatial gradient with the adjacent pixels in both directions at the reference pixel, the evaluation value of the reference pixel d1 at this time is written into the evaluation value table.

### 16. Example of Evaluation Value Table Generated in the Fifth Embodiment

FIG. 36 shows an example of an evaluation value table formed by the processing in the fifth embodiment for a test image. This evaluation value table has been totaled by carrying out a determination of whether spatial gradients are present in the orientation of motion and the opposite orientation at both the focus pixel and the reference pixel. In this example test image also, there are two objects that are moving in each frame, and peaks showing the positions of the two moving objects correctly show the respective positions of the objects.

In this way, it is possible to make a suitable determination of whether a spatial gradient is present by determining spatial gradients in both the orientation of motion and the opposite orientation.

### 17. Modification to the Fifth Embodiment

Note that it is possible to determine whether a spatial gradient is present using a combination of other adjacent pixels with the adjacent pixel in the orientation of motion and the adjacent pixel in the opposite orientation to the orientation of motion.

For example, it is possible to determine whether a spatial gradient is present from adjacent pixels in the orientations of normals and adjacent pixels in the second closest orientation in addition to the adjacent pixel in the orientation of motion and the adjacent pixel in the opposite orientation to the orientation of motion.

FIG. 37 is a flowchart showing an example of processing that determines whether a spatial gradient is present from adjacent pixels in the orientations of normals and adjacent pixels in the second closest orientation in addition to the adjacent pixel in the orientation of motion and the adjacent pixel in the opposite orientation to the orientation of motion.

In the flowchart shown in FIG. 37, processing steps that are the same as in the flowchart in FIG. 34 have been assigned the same reference numerals. In the present embodiment, the read orientations in step S92′, step S93′ and step S96′ differ from the previous flowchart.

That is, the spatial gradient pattern calculating unit 122 calculates the relative position of the focus pixel in the previous frame and a reference pixel in the present frame (step S91) and determines the orientation of motion from the relative position. Data on the closest orientation to the determined orientation of motion, data on the opposite orientation, data on orientations of normals, and data on the second closest orientation are read from the motion orientation LUT 126 (step S92′), patterns of the adjacent pixels in the closest orientation to the orientation of motion, the opposite orientation, the orientations of normals, and the second closest orientation are read from the focus pixel pattern memory 124 (step S93′), and the patterns of the respective differences with the adjacent pixels are determined (step S94). When this determination determines that the threshold is not exceed by one or all of the differences and that a spatial gradient is not present at the focus pixel, the evaluation value is prevented from passing the gate unit 121 so that the evaluation value in question is not written into the evaluation value table memory 52 (step S98).

Conversely, when the determination determines that the threshold is exceeded in all of the orientations and a spatial gradient is present, the counter that counts a value showing that a spatial gradient is present counts up by one (step S95), the patterns of the adjacent pixels in the closest orientation to the orientation of motion, the opposite orientation, the orientations of normals, and the second closest orientation are read from the reference pixel pattern memory 123 (step S96′), and the patterns of the differences with the adjacent pixels are determined (step S97). When the determination determines that the threshold is not exceeded by one or all of the differences and that there is no spatial gradient at the reference pixel, the evaluation value is prevented from passing the gate unit 121 and the evaluation value in question is not written into the evaluation value table memory 52 (step S98).

It is also determined whether the absolute value of the difference between the focus pixel and the reference pixel detected by the correlation calculating unit 20′ is below a threshold (step S251). When the determination finds that the difference is below the threshold, the evaluation value is sent from the correlation determining unit 30 to the gate unit 121 included in the pixel selecting unit 120. Conversely, when it is determined that the difference is not below the threshold, the evaluation value is not sent to the gate unit 121 and the evaluation value in question is not written in the evaluation value table memory 52 (step S98).

After this, the number (i.e., frequency) of values that have been allowed in the pixel selection to pass the gate unit 121 out of the data sent from the correlation determining unit 30 to the gate unit 121 in the pixel selecting unit 120 (i.e., the data where there is pixel correlation) is written into the evaluation value table (step S252).

Note that in the flowchart shown in FIG. 37, although writing is carried out in the evaluation value table when the conditions are satisfied for both the determination of a spatial gradient at the focus pixel and the determination of a spatial gradient at the reference pixel, it is also possible to allow the evaluation value to pass the gate unit 121 and carry out writing in the evaluation value table when the conditions are satisfied in one of the determination of a spatial gradient at the focus pixel and the determination of a spatial gradient at the reference pixel.

An overview of an example of processing with the flowchart shown in FIG. 37 is given in FIGS. 38A, 38B, and 38C. FIGS. 38A and 38B are the same as FIGS. 25A and 25B, and FIG. 38A is a diagram showing the present frame in which the reference pixel is present and the previous frame in which the focus pixel is present.

As shown in FIG. 38C, for the reference pixel and the focus pixel, as shown by the arrows drawn with thick lines, the differences between the center pixel (that is, the reference pixel and the focus pixel) and the adjacent pixels in five orientations that are the closest orientation to the orientation of motion, the opposite orientation to the closest orientation, the orientations of two normals that are perpendicular to the closest orientation, and the second closest orientation are determined, and it is determined whether a spatial gradient is present.

Note that when determining whether a spatial gradient is present in the flowchart shown in FIG. 37, although it is determined that a spatial gradient is present when a difference that exceeds the threshold is detected for every adjacent pixel, as one example, it is also possible to determine that a spatial gradient is present when there is a difference that exceeds the threshold for the adjacent pixels in a predetermined number of orientations (for example, three or four orientations) out of the five orientations shown by the arrows drawn with the thick lines in FIG. 38C.

### 18. Sixth Embodiment

A sixth embodiment of the present invention will now be described with reference to FIGS. 39 to 46.

The present embodiment also relates to a motion vector detecting apparatus that detects motion vectors from moving image data. This motion vector detecting apparatus is the same as the various embodiments described above in that an evaluation value table is formed from pixel value correlation information and motion vectors are determined from the data of such evaluation value table.

The overall configuration and overall processing of the motion vector detecting apparatus are the same as the configuration shown in FIG. 3 and the flowchart shown in FIG. 4 described earlier in the first embodiment.

In the present embodiment, the evaluation value table forming unit 12 in the motion vector detecting apparatus shown in FIG. 3 is configured as shown in FIG. 39. In the evaluation value table forming unit 12 shown in FIG. 39, parts that are the same as in the evaluation value table forming unit 12 in the first to fifth embodiments shown in FIGS. 5, 13, 19, and 30 and described earlier have been assigned the same reference numerals.

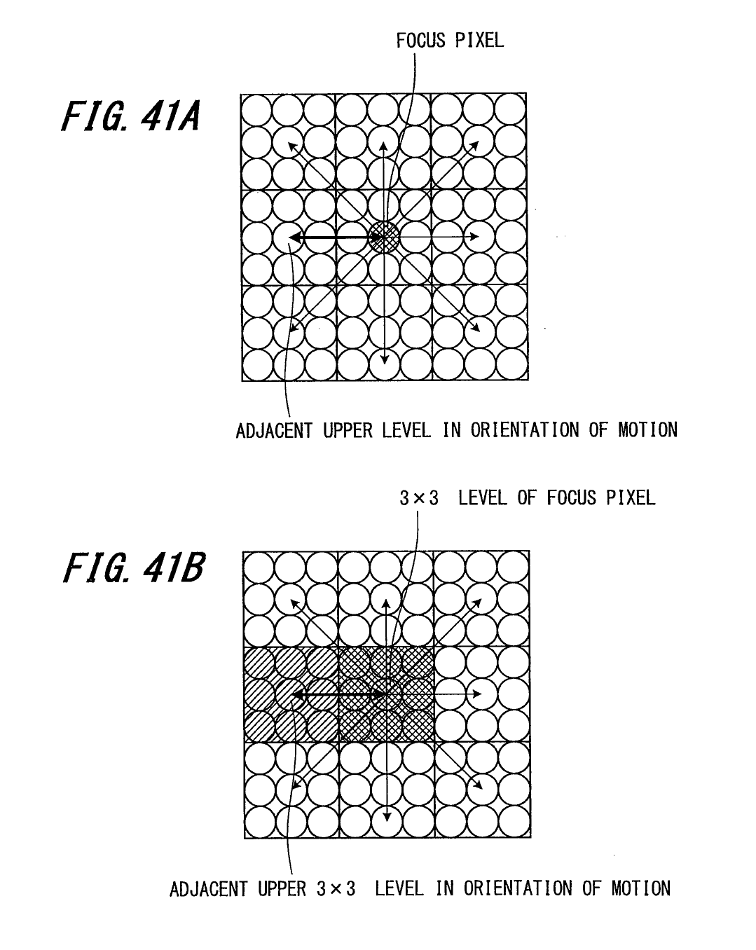

In the present embodiment, an adjacent pixel in the orientation of motion (i.e., a lower-level adjacent pixel) and an adjacent pixel in the orientation of motion that is separated by a predetermined number of pixels (i.e., a higher-level adjacent pixel) are read and the respective differences for the lower-level adjacent pixel and the higher-level adjacent pixel are determined. The lower-level adjacent pixel and the higher-level adjacent pixel will be described later with reference to FIGS. 41A to 41B. The definitions of “focus pixel” and “reference pixel” are the same as those given above in the earlier embodiments. That is, a focus pixel is a pixel position of a point (standard point) used as a standard for determining a motion vector and a reference pixel is a pixel within a search area in an earlier or later frame than the focus pixel.

The example configuration in FIG. 39 will now be described. An image signal obtained at the input terminal 11 is supplied to a correlation calculating unit 20′ inside the evaluation value table forming unit 12. The correlation calculating unit 20′ includes a reference pixel memory 24, a focus pixel memory 25, and an absolute value calculating unit 26. The reference pixel memory 24 stores pixel values of the image signal of the present frame obtained at the input terminal 11 and when one frame period has passed, the stored data is moved to the focus pixel memory 25. In the absolute value calculating unit 26, the pixel value of the focus pixel read from the focus pixel memory 25 is compared with a pixel value of the reference pixel read from the reference pixel memory 24 and the absolute value of the difference is calculated.

After this, the detected difference data is supplied to the correlation determining unit 30. The correlation determining unit 30 includes a comparator unit 31 that compares the supplied difference with a set threshold to obtain an evaluation value. As the evaluation value, as one example a binary value is set so that the correlation is “high” when the difference is equal to or below the threshold and so that the correlation is “low” when the difference exceeds the threshold.

The evaluation value obtained at the correlation determining unit 30 is supplied to a pixel selecting unit 130. The pixel selecting unit 130 includes a gate unit 131 that selects the binary value output from the correlation determining unit 30. As a configuration for controlling the gate unit 131, the pixel selecting unit 130 includes an motion orientation calculating unit 132, a spatial gradient determining unit 133, and a comparator unit 134. The motion orientation calculating unit 132 calculates the relative position of the focus pixel and the reference pixel from the data stored in the reference pixel memory 24 and the data stored in the focus pixel memory 25 and calculates the orientation of motion from the relative position.

When the orientation of motion has been calculated, the spatial gradient determining unit 133 reads the reference pixel and the pixel data of the lower-level adjacent pixel and the pixel data of the higher-level adjacent pixel from the reference pixel memory 24 and calculates the differences in pixel values between the pixel data of the reference pixel and the adjacent pixel data.

The comparator unit 134 determines if the differences with the lower-level adjacent pixel and the higher-level adjacent pixel in the orientation of motion exceed a threshold at both the focus pixel and the reference pixel, and when the differences exceed the threshold, the evaluation value supplied to the gate unit 131 is allowed to pass. When the difference does not exceed the threshold with any of the higher-level and lower-level at the focus pixel and the reference pixel, the evaluation value supplied to the gate unit 131 is prevented from passing.

The evaluation values that have passed the gate unit 131 in the pixel selecting unit 130 are supplied to an evaluation value table calculating unit 50, are totaled by an evaluation value totaling unit 51, and the totaled result is stored in an evaluation value table memory 52. Also, the number of pixels that have been supplied to the gate unit 131 in the pixel selecting unit 130 where there is a spatial gradient is counted by a counter (not shown). After this, the data stored in the evaluation value table memory 52 is supplied as evaluation value table data from an output terminal 12a to a circuit that forms the next stage.

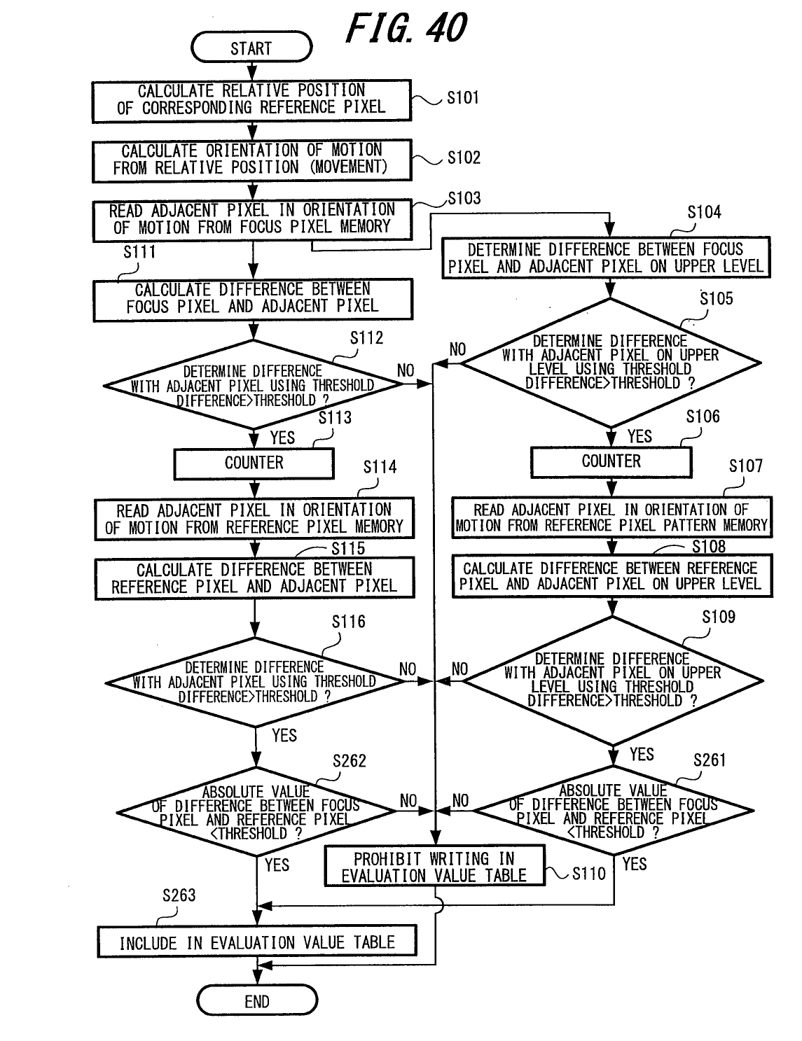

FIG. 40 is a flowchart showing a processing operation with the configuration shown in FIG. 39.

As shown in FIG. 40, the processing carried out with the configuration shown in FIG. 39 includes: candidate detecting processing based on the pixel correlation detected by the correlation calculating unit 20′ and the correlation determining unit 30 and also processing where the pixel selecting unit 130 selects a candidate obtained at the correlation determining unit 30. This flowchart will now be described focusing on the processing by the pixel selecting unit 130.

First, the motion orientation calculating unit 132 calculates the relative position of the reference pixel and the focus pixel corresponding to such reference pixel (step S101) and calculates the orientation of motion from such relative position (step S102). After this, the motion orientation calculating unit 112 reads the pixel data of the adjacent pixels in the orientation of motion (i.e., the lower-level adjacent pixel and the upper-level adjacent pixel) from the focus pixel memory 25 (step S103).

Hereinafter, the processing of the upper-level and the processing of the lower-level are carried out in parallel.

First, in the processing of the upper-level (i.e., the right side in FIG. 40), the difference between the focus pixel and the upper-level adjacent pixel is calculated (step S104). It is determined whether the calculated difference between the focus pixel and the upper-level adjacent pixel exceeds a threshold (step S105), and when the threshold is not exceeded, the processing proceeds to step S110 where the present evaluation value is prevented from passing the gate unit 131 and is prohibited from being written into the evaluation value table.

In step S105, when it has been determined that the difference exceeds the threshold, a counter for a value showing that a spatial gradient is present on the upper level counts up by one (step S106), the upper-level adjacent pixel in the orientation of motion is read from the reference pixel memory 24 (step S107), and the difference between the read upper-level adjacent pixel and the reference pixel is calculated (step S108) Once the difference with the upper-level adjacent pixel has been calculated, it is determined whether the difference exceeds a threshold set in advance (step S109), and when it is determined that the difference does not exceed the threshold, the present evaluation value is prevented from passing the gate unit 131 and is prohibited from being written in the evaluation value table (step S110).

In addition, it is determined whether the absolute value of the difference between the focus pixel and the reference pixel obtained at the correlation calculating unit 20′ is below a threshold (step S261). When this determination finds that the difference is below the threshold, the evaluation value is sent from the correlation determining unit 30 to the gate unit 131 in the pixel selecting unit 130. When the difference is not below the threshold, the evaluation value is not sent to the gate unit 131 (step S110).

In the processing of the lower-level (i.e., the left side in FIG. 40), the difference between the focus pixel and the lower-level adjacent pixel is calculated (step S11). It is determined whether the calculated difference between the focus pixel and the lower-level adjacent pixel exceeds a threshold (step S112), and when the threshold is not exceeded, the processing proceeds to step S110, the present evaluation value is prevented from passing the gate unit 131 and is prohibited from being written into the evaluation value table.

In step S112, when it has been determined that the difference exceeds the threshold, a counter for a value showing that a spatial gradient is present on the lower level counts up by one (step S113), the lower-level adjacent pixel in the orientation of motion is read from the reference pixel memory 24 (step S114), and the difference between the read lower-level adjacent pixel and the reference pixel is calculated (step S115) Once the difference with the lower-level adjacent pixel has been calculated, it is determined whether the difference exceeds a threshold set in advance (step S116), and when it is determined that the difference does not exceed the threshold, the present evaluation value is prevented from passing the gate unit 131 and is prohibited from being written in the evaluation value table (step S110).

In addition, it is determined whether the absolute value of the difference between the focus pixel and the reference pixel detected by the correlation calculating unit 20′ is below a threshold (step S262). When this determination finds that the difference is below the threshold, the evaluation value is sent from the correlation determining unit 30 to the gate unit 131. When the difference is not below the threshold, the evaluation value is not sent to the gate unit 131 (step S110).

After the processing thusfar has been carried out, when it has been determined that there are differences that exceed the threshold for both the upper-level adjacent pixel and the lower-level adjacent pixel at both the focus pixel and the reference pixel, the number (i.e., frequency) of values that have been allowed to pass the gate unit 131 out of the data sent from the correlation determining unit 30 to the gate unit 131 of the pixel selecting unit 130 (i.e., the data where there is pixel correlation) is written into the evaluation value table (step S263)

Note that in the flowchart shown in FIG. 40 also, although writing is carried out in the evaluation value table when the conditions are satisfied for both the determination of a spatial gradient at the focus pixel and the determination of a spatial gradient at the reference pixel, it is also possible to allow the evaluation value to pass the gate unit 131 and carry out writing in the evaluation value table when the conditions are satisfied in one of the determination of a spatial gradient at the focus pixel and the determination of a spatial gradient at the reference pixel.

Also, although selection is carried out by the pixel selecting unit 130 in the flowchart shown in FIG. 40 based on the result of calculating the differences with the adjacent pixels and determining whether a spatial gradient is present using the same conditions for the upper level and the lower level at the focus pixel and the reference pixel, it is possible to change the selection conditions between the upper level and the lower level. For example, it is possible to use a configuration that carries out only a determination of correlation between the focus pixel and the reference pixel on the lower level and carries out selection based on whether a spatial gradient is present at the reference pixel and the focus pixel on the upper level. In addition, when selecting is carried out according to whether a spatial gradient is present, it is possible to use a configuration that selects a pixel not only when a spatial gradient is present at both the reference pixel and the focus pixel but also when a spatial gradient is present at only one of the reference pixel and the focus pixel. In addition, in the opposite case, it is possible to use a configuration that carries out only a determination of correlation between the focus pixel and the reference pixel on the upper level and carries out selection based on whether a spatial gradient is present at the reference pixel and the focus pixel (or at one of the reference pixel and the focus pixel) on the lower level.

An overview of the processing with the configuration shown in FIG. 39 and the flowchart shown in FIG. 40 is given in FIGS. 41A to 43.

First, in FIG. 41A, examples of the adjacent pixels on the upper level and adjacent pixels on the lower level at the focus pixel are shown. In this example, as described in the first to fifth embodiments, the adjacent pixels on the lower level are pixels that are directly adjacent to the focus pixel. That is, as shown in FIG. 41A, when the pixel in the center is the focus pixel, the pixels that are directly adjacent to this pixel are set as the adjacent pixels on the lower level, with an adjacent pixel in one of the orientations being selected in accordance with the orientation of motion.

On the other hand, a predetermined number of pixels are set as a unit called a “block”, and the adjacent pixels on the upper level for the focus pixel are set as pixels at positions that are one block away. In the example in FIG. 41A, one block is defined as nine pixels in three horizontal rows and three vertical columns, and the center pixel in an adjacent block is set as the upper-level adjacent pixel. For example, when the orientation of motion is horizontally to the left, the center pixel in the block horizontally to the left is set as the adjacent pixel in the orientation of motion on the upper level. The selected adjacent pixel and the focus pixel are compared and the difference therebetween is obtained.

Alternatively, as shown in FIG. 41B, it is possible to calculate the average of the luminance values in a block of nine pixels to which the focus pixel belongs, to calculate the average of the luminance values of the nine pixels in a block that is adjacent in the orientation of motion, and to obtain the difference on the upper level in the orientation of motion for the focus pixel from the difference between the respective averages.

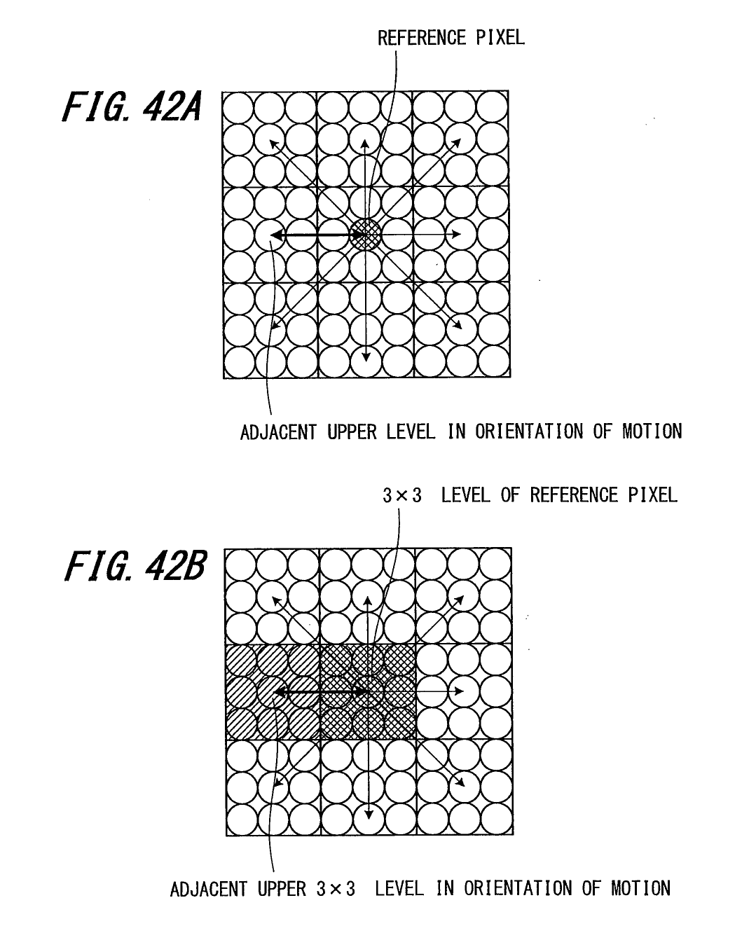

FIGS. 42A and 42B show an example for the reference pixel. For the reference pixel also, a lower-level adjacent pixel is a pixel that is directly adjacent to the reference pixel. That is, as shown in FIG. 42A, when the pixel in the center is the reference pixel, the pixels that are directly adjacent to this pixel are set as the adjacent pixels on the lower level, with an adjacent pixel in one of the orientations being selected in accordance with the orientation of motion.

On the other hand, a predetermined number of pixels are set as a unit called a “block”, and the adjacent pixels on the upper level for the reference pixel are set as pixels at positions that are one block away. In the example in FIG. 42A, one block is defined as nine pixels in three horizontal rows and three vertical columns, and the center pixel in an adjacent block is set as the upper-level adjacent pixel. For example, when the orientation of motion is horizontally to the left, the center pixel in the block horizontally to the left is set as the adjacent pixel in the orientation of motion on the upper level. The selected adjacent pixel and the reference pixel are compared and the difference therebetween is obtained.

Alternatively, as shown in FIG. 42B, it is possible to calculate the average of the luminance values in a block of nine pixels to which the reference pixel belongs, to calculate the average of the luminance values of the nine pixels in a block that is adjacent in the orientation of motion, and to obtain the difference on the upper level in the orientation of motion for the reference pixel from the difference between the respective averages.

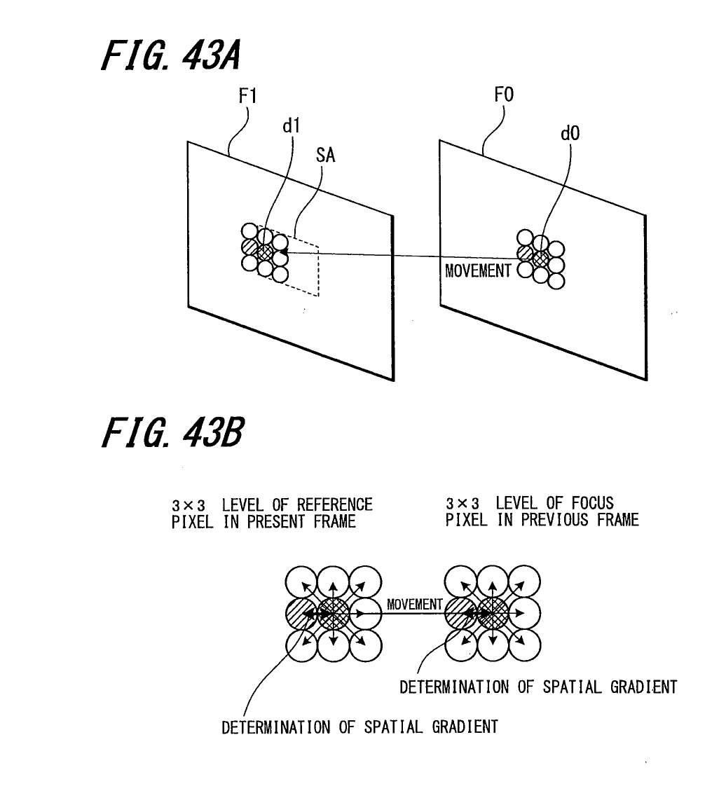

After setting the adjacent levels in this way, when calculating an evaluation value table with the focus pixel d0 of the previous frame F0 and the reference pixel d1 of the present frame F1 set as shown in FIG. 43A, the adjacent pixels on the adjacent levels in the orientation of motion are read at both the focus pixel and the reference pixel and it is determined whether there is a spatial gradient, as shown in FIG. 43B. The circle symbols in FIGS. 43A and 43B are pixels or blocks on one level and the range of the search area SA shown in FIG. 43A may be changed between the lower level and the upper level.

### 19. Example Where an LUT is Used in the Sixth Embodiment

Although it is determined whether there is a spatial gradient by reading the adjacent pixels on the respective levels in the orientation of motion and comparing the differences with a threshold in the example in FIGS. 39 and 40, in the present embodiment also, it is possible to use a configuration where an LUT and a pattern memory are used and writing in the evaluation value table is restricted based on a comparison with the LUT and the pattern memory.

FIG. 44 shows an example configuration of the evaluation value table forming unit 12 when an LUT and a pattern memory are used.

In the evaluation value table forming unit 12 shown in FIG. 44, the configuration of a pixel selecting unit 140 differs from that of the pixel selecting unit (the pixel selecting unit 100, 120 or the like shown in FIGS. 22 and 33) of the evaluation value table forming unit 12 in the embodiments described earlier, but the other parts (that is, the correlation calculating unit 20′, the correlation determining unit 30, and the evaluation value table calculating unit 50) are the same as in the configurations shown in FIGS. 22 and 33. In the evaluation value table forming unit 12 shown in FIG. 44, parts that are the same as in the evaluation value table forming unit 12 shown in FIGS. 22 and 33 have been assigned the same reference numerals.

In the configuration shown in FIG. 44, the pixel selecting apparatus 140 includes a gate unit 141 and an evaluation value output from the correlation determining unit 30 is selected by the gate unit 141. As a configuration for controlling the gate unit 141, the pixel selecting unit 140 includes a spatial gradient pattern calculating unit 142, a reference pixel pattern memory 143, a focus pixel pattern memory 144, a pattern comparator unit 145, an motion orientation LUT 146, and an motion orientation calculating unit 147.

Whenever the pixel data of a frame is supplied, the spatial gradient pattern calculating unit 142 expresses, for each pixel, whether a spatial gradient is present between the focus pixel and a peripheral pixel using the value “0” or “1”, and stores such values as flags in the reference pixel pattern memory 143. After this, by referring to the flags, it is determined whether a spatial gradient is present based on an orientation where movement has been detected. Flags showing whether a spatial gradient is present at each pixel generated for the present frame (i.e., at each reference pixel) at a given time t can be used at a time t+1 when the next frame is obtained as flags showing whether a spatial gradient is present at each pixel in the previous frame (i.e. at each focus pixel). To do so, a configuration is used where the data stored in the reference pixel pattern memory 143 is moved to the focus pixel pattern memory 144.

In the motion orientation calculating unit 147, relationships between relative positions (movement) inside the search area and closest directions are calculated in advance, and the calculated data is stored as the motion orientation LUT 146. Spatial gradient patterns on the lower level and spatial gradient patterns on the upper level are stored in the motion orientation LUT 146. The values of the stored LUT are sent to the reference pixel pattern memory 143 and the focus pixel pattern memory 144, and (i) a spatial gradient pattern calculated by the spatial gradient pattern calculating unit 142 having considered the adjacent pixel in the same orientation as the orientation of motion and the adjacent pixel in the opposite orientation and (ii) patterns for the two orientations read out from the motion orientation LUT 146 are compared for both the reference pixel and the focus pixel on both the lower level and the upper level by the pattern comparator unit 145. When, as the comparison result, it is determined that a spatial gradient is present at both the focus pixel and the reference pixel, control is carried out to allow the evaluation value to pass the gate unit 141. Conversely, when it is determined that a spatial gradient is not present, control is carried out to prevent the evaluation value from passing the gate unit 141. When it has been determined by the pattern comparator unit 145 that there is a spatial gradient, the counter (not shown) that counts up the number of pixels where there is a spatial gradient counts up by one.

FIG. 45 is a flowchart showing an example of processing by the configuration shown in FIG. 44.

As shown in FIG. 45, the processing carried out with the configuration shown in FIG. 44 includes: candidate detecting processing based on the pixel correlation detected by the correlation calculating unit 20′ and the correlation determining unit 30 and also processing where the pixel selecting unit 140 selects a candidate obtained at the correlation determining unit 30. This flowchart will now be described focusing on the processing by the pixel selecting unit 140.

First, the spatial gradient pattern calculating unit 142 calculates the relative position of the focus pixel in the previous frame and a reference pixel in the present frame (step S121) and determines the orientation of motion from the relative position. Data on the determined orientation of motion is read from the motion orientation LUT 146 (step S122), patterns of the adjacent pixels on the lower level and the upper level in the orientation of motion are read from the focus pixel pattern memory 144 (step S123), and the patterns of the differences with the adjacent pixels on the respective levels are determined (step S124). When this determination determines that a spatial gradient is not present at the focus pixel, the evaluation value is prevented from passing the gate unit 141 so that the evaluation value in question is not written into the evaluation value table memory 52 (step S128).

Conversely, when the determination on the two levels determines that a spatial gradient is present, the counter that counts a value showing that a spatial gradient is present counts up by one (step S125), the patterns of the adjacent pixels on the lower level and the upper level in the orientation of motion are read from the reference pixel pattern memory 143 (step S126), and the patterns of the differences with the adjacent pixels on the respective levels are determined (step S127). When the determination determines that there is no spatial gradient at the reference pixel, the evaluation value is prevented from passing the gate unit 141 and the evaluation value in question is not written into the evaluation value table memory 52 (step S128).

It is also determined whether the absolute value of the difference between the focus pixel and the reference pixel detected by the correlation calculating unit 20′ is below a threshold (step S271). When the determination finds that the difference is below the threshold, the evaluation value is sent from the correlation determining unit 30 to the gate unit 141 in the pixel selecting unit 140. Conversely, when it is determined that the difference between the focus pixel and the reference pixel is not below the threshold, the evaluation value is not sent to the gate unit 141 and the evaluation value in question is not written into the evaluation value table memory 52 (step S128).

After the processing thusfar, the number (i.e., frequency) of values that have been allowed in the pixel selection to pass the gate unit 141 out of the data sent from the correlation determining unit 30 to the gate unit 141 included in the pixel selecting unit 140 (i.e., the data where there is pixel correlation) is written into the evaluation value table (step S252).

In this way, it is also possible to use the LUT and the pattern memory to determine whether there is a spatial gradient on each level.

Note that in the flowchart shown in FIG. 45 also, although writing is carried out in the evaluation value table when the conditions are satisfied for both the determination of a spatial gradient at the focus pixel and the determination of a spatial gradient at the reference pixel, it is also possible to allow the evaluation value to pass the gate unit 141 and carry out writing in the evaluation value table when the conditions are satisfied in one of the determination of a spatial gradient at the focus pixel and the determination of a spatial gradient at the reference pixel.

Also, although selection is carried out by the pixel selecting unit 140 based on the result of calculating the differences with the adjacent pixels and determining whether a spatial gradient is present using the same conditions for the upper level and the lower level at the focus pixel and the reference pixel, it is also possible to change the selection conditions between the upper level and the lower level. For example, it is possible to use a configuration that carries out only a determination of correlation between the focus pixel and the reference pixel on the lower level and carries out selection based on whether a spatial gradient is present at the reference pixel and the focus pixel on the upper level. In addition, when selecting based on whether a spatial gradient is present, it is possible to use a configuration that selects pixels not only when a spatial gradient is present at both the reference pixel and the focus pixel but also when a spatial gradient is present at only one of the reference pixel and the focus pixel. In addition, in the opposite case, it is possible to use a configuration that carries out only a determination of correlation between the focus pixel and the reference pixel on the upper level and carries out selection based on whether a spatial gradient is present at the reference pixel and the focus pixel (or at one of the reference pixel and the focus pixel) on the lower level.

### 20. Example of an Evaluation Value Table Generated in the Sixth Embodiment

FIG. 46 shows an example of an evaluation value table formed for the test image shown in FIG. 10 with a configuration that restricts writing in the evaluation value table based on determinations of differences with the adjacent pixels in the orientation of motion using the levels described in FIGS. 39 and 40.

As shown in FIG. 46, by determining whether a spatial gradient is present using the levels, an evaluation value table is formed in which peak positions corresponding to the two objects in the test image are correctly determined. Accordingly, it is possible to correctly detect motion vectors and the like.

Note that the sixth embodiment has been described by way of an example where it is determined whether a spatial gradient is present using different levels from a comparison with adjacent pixels on the lower level and the upper level in the orientation of motion. However, similar to the first to fifth embodiments described above, it is also possible to use processing that carries out a determination for adjacent pixels in the opposite orientation to the orientation of motion, the orientations of normals, or the closest orientation and the second closest orientation to the orientation of motion and in such case to determine whether a spatial gradient is present from a comparison with adjacent pixels on the lower level and the upper level in the respective orientations.

### 21. Configuration and Example Operation of Motion Vector Detecting Unit

Next, examples of the configuration and operation of the motion vector detecting unit 13 in a motion vector detecting apparatus having the configuration shown in FIG. 3 will be described with reference to FIGS. 47 and 48.

FIG. 47 shows an example of the motion vector detecting unit 13 shown in FIG. 3.

In the motion vector detecting unit 13, evaluation value table data is supplied to an input terminal 13a. As one example, the evaluation value table data is data on an evaluation value table for motion vectors obtained by the processing in one of the first to third embodiments described above, and is data produced by totaling motion vectors that are possible candidate vectors inside one frame.

For example, the data is supplied from the evaluation value table memory 52 included in the evaluation value table calculating unit 50 shown in FIG. 5 and is supplied to an evaluation value table data converting unit 111.

The evaluation value table data converting unit 111 converts the supplied evaluation value table data to data such as frequency values or derivative values thereof. The converted data is subjected to processing by a frequency order sorting unit 112 that rearranges the candidate vectors inside one frame in order of frequency. The evaluation value table data where the candidate vectors have been rearranged in order of frequency is supplied to a candidate vector evaluating unit 113. Here, among the candidate vectors that have been rearranged in order of frequency, a predetermined number of candidate vectors in order starting from the highest-order candidate vector are supplied to the candidate vector evaluating unit 113. As one example, the candidate vectors from the first candidate vector with the highest frequency to the tenth candidate vector are extracted out of the candidate vectors with the highest frequencies in one frame and are supplied to the candidate vector evaluating unit 113.

The candidate vector evaluating unit 113 carries out processing that further evaluates the respective high-frequency candidate vectors that have been supplied according to decided conditions. In this evaluating processing, it is possible to carry out evaluation according to determined conditions, such as where candidate vectors among the predetermined number of candidate vectors with the highest frequency values are still excluded if the frequency value is no greater than a predetermined threshold value and is therefore not so high.

Alternatively, as another example, it is possible to evaluate the reliability of the candidate vectors using data used in pixel selection at the evaluation value table forming unit 12 (see FIG. 3), i.e., the circuit that comes before the motion vector detecting unit 13. When data used during the pixel selection is used to evaluate the reliability of the candidate vectors, as one example, data on the selected focus pixel used during pixel selection at the pixel selecting unit 40 in FIG. 5 or the like is used. The data on the selected focus pixel is obtained from the evaluation value table forming unit 12 and the candidate vectors are evaluated by evaluating which candidate vectors are most optimal when viewed from the respective focus pixels that have been selected.

Based on the evaluation results for the respective candidate vectors obtained in this way by the candidate vector evaluating unit 113, a candidate vector reliability determining unit 114 selects a candidate vector with high reliability out of the candidate vectors and data on the candidate vector with high reliability is output from an output terminal 13b.

Reliability data on the candidate vector output from the output terminal 13b is supplied to the motion vector deciding unit 14 shown in FIG. 3.

FIG. 48 is a flowchart showing one example of the processing by the motion vector detecting unit 13 shown in FIG. 47 when extracting the candidate vectors from the evaluation value table data.

First, processing that sorts the candidate vectors shown on the evaluation value table data in order of frequency is carried out (step S111). Out of the evaluation value table that has been rearranged in order of frequency, a predetermined number of candidate vectors in order from the vector with the highest frequency are fetched. As one example of this predetermined number, it is possible to fetch the candidate vectors in order up to the tenth vector starting from the vector with the highest frequency (step S112).

After this, processing that evaluates whether the fetched plurality of candidate vectors are suitable as candidate vectors and discards unsuitable candidate vectors as necessary is carried out (step S113). For example, evaluation processing is carried out that determines the magnitudes of the frequency values of the respective fetched candidate vectors and lowers the evaluation values of candidate vectors with frequency values that are no greater than a threshold. A variety of processing could conceivably be used as this evaluation processing for candidate vectors, and the evaluation processing used will affect the precision with which candidate vectors are fetched.

Based on the result of the evaluation processing, the reliability is determined for the respective candidate vectors and only the candidate vectors with high reliability, that is candidate vectors that have a high probability of being assigned to the image are supplied to the motion vector deciding unit 14 (see FIG. 3) that forms the next stage (step S114).

### 22. Configuration and Example Operation of Motion Vector Deciding Unit

Next, examples of the configuration and operation of the motion vector deciding unit 14 in the motion vector detecting apparatus with the configuration shown in FIG. 3 will be described with reference to FIGS. 49 to 51.

FIG. 49 shows one example configuration of the motion vector deciding unit 14 shown in FIG. 3. The motion vector deciding unit 14 carries out processing that assigns one out of the plurality of candidate vectors supplied from the motion vector detecting unit 13 preceding the motion vector deciding unit 14 to each pixel inside one frame.

In this example, when the respective pixel positions are set as the focus pixel, a fixed block that is a region including a predetermined number of pixels in the periphery of the focus pixel is set and motion vectors are determined.

The configuration shown in FIG. 49 will now be described. Data on candidates for the motion vectors and an image signal for such candidate vectors are supplied to an input terminal 14a of the motion vector deciding unit 14. One frame in the image signal is supplied to and stored in a reference pixel memory 211 that is a frame memory. The image signal that has been stored in the reference pixel memory 211 is moved to a focus pixel memory 212 after each frame period. Accordingly, the image signal stored in the reference pixel memory 211 and the image signal stored in the focus pixel memory 212 are always signals that are one frame period apart.

After this, at a data reading unit 213, pixel signals of a fixed block of a predetermined size that is centered on the focus pixel are read from the image signal stored in the focus pixel memory 212. In the same way, at the data reading unit 213, pixel signals of a fixed block of a predetermined size that is centered on the reference pixel are read from the image signal stored in the reference pixel memory 211. Next, the data reading unit 213 determines the pixel positions of the focus pixel and the reference pixels to be read by the data reading unit 213 from the data on the candidate vectors supplied from the motion vector detecting unit 13 (see FIG. 3). That is, in the example case where there are ten candidate vectors, ten reference pixels that are the movement destinations for the ten candidate vectors from the focus pixel are determined.

After this, the image signal of the fixed region centered on the focus pixel and the image signal of the fixed region centered on the reference pixel that have been read by the data reading unit 213 are supplied to an evaluation value calculating unit 214 and the differences between the pixel signals in both fixed regions are detected. By doing so, the evaluation value calculating unit 214 determines the image signals for the fixed regions of all of the reference pixels connected by the candidate vectors to the focus pixel currently being evaluated and compares such pixel signals with the pixel signals in the fixed region centered on the focus pixel.

After this, the evaluation value calculating unit 214 selects the reference pixel with the fixed region that most closely resembles the pixel signals of the fixed region centered on the focus pixel.

Data on the candidate vector that connects the selected reference pixel and the focus pixel is sent to a vector determining unit 215. The vector determining unit 215 carries out deciding processing that assigns the candidate vector in question as the motion vector from the focus pixel and the decided candidate vector is output from the output terminal 15.

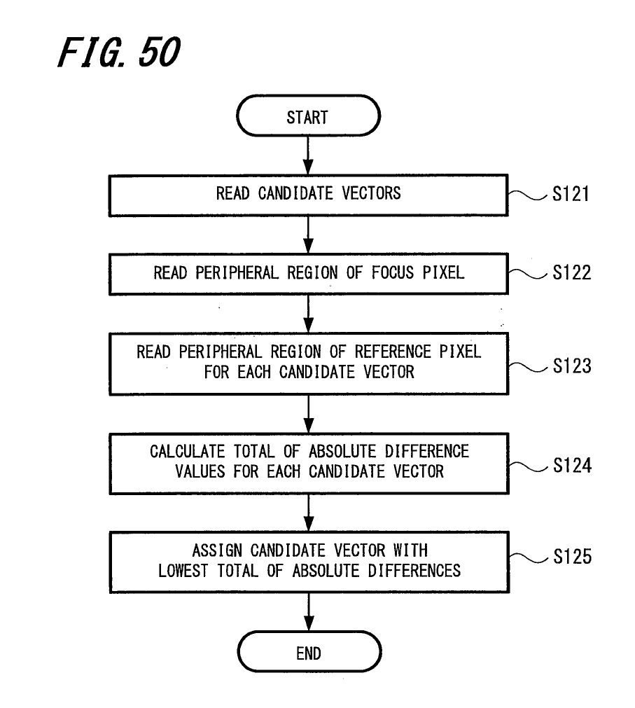

The flowchart in FIG. 50 shows an example operation of a vector deciding (assigning) processing shown in FIG. 49.

This operation will now be described in order in accordance with FIG. 50. First, the candidate vectors are read out based on the data of the evaluation value table (step S121). The coordinate position of the focus pixel is determined for the read candidate vectors, and the pixel (focus pixel) at this position and the pixels in a fixed block including the peripheral pixels of the focus pixel are read out from a focus pixel memory 212 (step S122). Also, the coordinate positions of the reference pixels for the read candidate vectors are determined, and the pixels at such positions (reference pixels) and the pixels in a fixed block including the peripheral pixels of the reference pixel are read out from the reference pixel memory 211 (step S123).

After this, the differences between the pixel levels (pixel values: in this example, luminance values) of the pixels in the respective fixed blocks and the pixel levels of pixels inside a fixed block set for the focus pixel are calculated, and absolute values of such differences are added for entire blocks to calculate totals for the absolute differences (step S124). The processing thusfar is carried out for the reference pixels shown by all of the candidate vectors for the present focus pixel.

After this, the reference pixel with the lowest total is found out of the totals for the absolute differences obtained by the comparison with the focus pixel for the plurality of reference pixels. In this processing, once the reference pixel with the lowest total has been determined, the candidate vector that connects the determined reference pixel and the focus pixel is assigned and decided as the motion vector for the focus pixel (step S125).

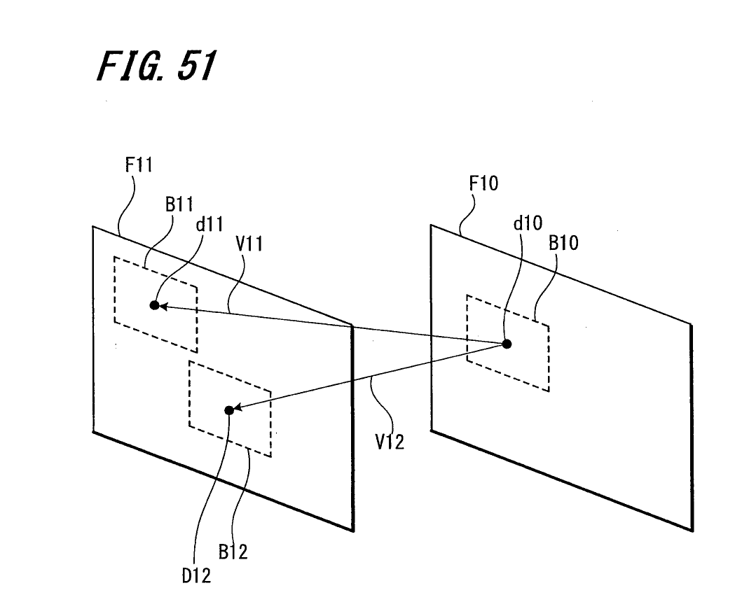

FIG. 51 is a diagram showing an overview of the processing with the configuration shown in FIG. 49 and the flowchart shown in FIG. 50.

In this example, the focus pixel d10 is present in the frame F10 (the focus frame) and a plurality of candidate vectors V11, V12 are present between such frame and the next frame F11 (the reference frame) on the time axis. The frame F11 includes reference pixels d11, d12 that are connected to the focus pixel d10 with the candidate vectors V11, V12.

For the state shown in FIG. 51, in step S122 in FIG. 50, the fixed block B10 with a predetermined number of pixels centered on the focus pixel d10 is set in the frame F10 and the pixel values inside the fixed block B10 are determined. In the same way, in step S123 in FIG. 50, the fixed blocks B11, B12 with a predetermined number of pixels centered on the reference pixels d11, d12 are set in the frame F11 and the pixel values inside the fixed blocks B11, B12 are respectively determined.

After this, the differences between the pixel values of the pixels in the fixed block B11 and the pixel values of the pixels in the fixed block B10 are calculated, absolute values of the differences are found, and these absolute values are added up for the entire block to produce a total of absolute differences. In the same way, the differences between the pixel values of the pixels in the fixed block B12 and the pixel values of the pixels in the fixed block B10 are calculated, absolute values of the differences are found, and these absolute values are added up for the entire block to produce a total of absolute differences. After this, the totals of the absolute differences are compared to see which is the lower value. When it is determined in this comparison that the total of absolute differences when the fixed block B11 is used is the lower of the two, for example, the candidate vector V11 that connects the reference pixel d11 in the center of the fixed block B11 and the focus pixel d10 is selected. The selected candidate vector V11 is assigned as the motion vector of the focus pixel d10.

Note that although a case where there are two candidate vectors has been described in FIG. 51 to simplify the description, in reality there are cases where a larger number of candidate vectors are present for a single focus pixel. Also, although only one focus pixel is shown to simplify the description, in reality a plurality of representative pixels in one frame or alternatively all pixels are used as focus pixels.

With the processing that decides a vector by selecting one of the candidate vectors as described above, a vector where the state of the pixels around the focus pixel and the state of the pixels around the reference pixel are similar is selected, which means that motion vectors can be suitably assigned to the respective pixels.

In particular, by combining the above processing with the evaluation value table forming processing of the embodiments described above, it is possible to extract candidate vectors using an evaluation value table in which the candidates are suitably narrowed and carry out deciding processing on such suitable candidate vectors so that motion vectors are assigned extremely suitably.

### 23. Modifications to the Embodiments

Note that aside from being carried out with the configurations and flowcharts described earlier in this specification, the processing in the respective embodiments of the present invention described above may be combined as appropriate with the processing in other embodiments. Also, although processing that determines a spatial gradient at the focus pixel was described in the first embodiment, the processing in the first embodiment may be carried out only on reference pixels.

In the respective embodiments of the present invention described above, aside from a configuration where it is determined whether a spatial gradient is present and predetermined values are included in an evaluation value table only for pixels where a spatial gradient is present, it is also possible to use a configuration that changes the values included in the evaluation value table for each pixel using the magnitude of the spatial gradient and/or pixel value correlation information.

Also, although the selection processing for the focus pixel was not described in detail in the embodiments described above, as one example it is possible to use a configuration where all of the pixels in one frame are set in order as the focus pixel and motion vectors are detected for the respective pixels. Alternatively, according to an embodiment of the present invention, representative pixels may be selected in one frame as focus pixels and motion vectors may be detected for the selected pixels.

Also, although examples where the present invention is applied to a motion vector detecting apparatus have been described in the embodiments above, this motion vector detecting apparatus may be combined with various types of image processing apparatus. For example, according to an embodiment of the present invention, the motion vector detecting apparatus may be combined with an encoding apparatus that carries out high-efficiency encoding so that data can be encoded using motion vector data. Alternatively, according to another embodiment of the present invention, the motion vector detecting apparatus may be combined with an image display apparatus that displays image data that has been input (or received) and/or an image recording apparatus that records images, with the motion vector data being used to increase the image resolution.

It is also possible to convert the various component elements that carry out motion vector detection according to an embodiment of the present invention to a program, to install such program in various types of information processing apparatus such as a computer that carries out various types of data processing, and to execute the same processing as described above when executing processing that detects motion vectors from an image signal input into the information processing apparatus.

It should be understood by those skilled in the art that various modifications, combinations, sub-combinations and alterations may occur depending on design requirements and other factors insofar as they are within the scope of the appended claims or the equivalents thereof.

What is claimed is:

1. A motion vector detecting apparatus comprising:
an evaluation value information forming unit configured to form, based on pixel value correlation information on correlation between (i) a focus pixel in one frame on a time axis out of moving image data including a plurality of frames and (ii) a reference pixel in a search area in another frame, evaluation value information on motion vectors where it has been evaluated that the reference pixel is a potential movement destination candidate for the focus pixel, the evaluation value information on the motion vectors being generated from the pixel value correlation information that has been one of generated and limited using a movement direction of the pixels;
a motion vector extracting unit configured to extract motion vectors as candidates from a plurality of motion vectors based on the evaluation value information formed by the evaluation value information forming unit; and
a motion vector deciding unit configured to decide motion vectors to be assigned to pixels in a frame from the motion vectors extracted as the candidates by the motion vector extracting unit.

2. A motion vector detecting apparatus according to claim 1, wherein
the evaluation value information forming unit generates the evaluation value information based on (i) a movement direction of a focus pixel for which a motion vector is determined and (ii) a state of a spatial gradient between the focus pixel and an adjacent pixel that is adjacent to the focus pixel.

3. A motion vector detecting apparatus according to claim 2, wherein
the evaluation value information forming unit determines whether a spatial gradient is present based on (i) the movement direction of the focus pixel for which a motion vector is determined and (ii) the state of the spatial gradient between the focus pixel and an adjacent pixel that is adjacent to the focus pixel, and includes only the pixel value correlation information for pixels where there is a spatial gradient in the evaluation value information.

4. A motion vector detecting apparatus according to claim 3, wherein
the evaluation value information forming unit fetches an adjacent pixel in the same frame in a direction that substantially matches a direction of the motion vector extracted by the motion vector extracting unit when looking from one of the focus pixel and a reference pixel that is a movement destination candidate, and determines whether a spatial gradient is present at one of the focus pixel and the reference pixel from a difference between the fetched adjacent pixel and the one of the focus pixel and the reference pixel.

5. A motion vector detecting apparatus according to claim 1, wherein
the evaluation value information forming unit generates the evaluation value information based on (i) a movement direction of the focus pixel for which a motion vector is determined and (ii) a state of a spatial gradient between a reference pixel that is a movement destination candidate for the focus pixel and an adjacent pixel that is adjacent to the reference pixel.

6. A motion vector detecting apparatus according to claim 1, wherein
the evaluation value information forming unit generates the evaluation value information based on (i) a movement direction of the focus pixel for which a motion vector is determined, (ii) a state of a spatial gradient between the focus pixel and an adjacent pixel that is adjacent to the focus pixel, and (iii) a state of a spatial gradient between a reference pixel that is a movement destination candidate for the focus pixel and an adjacent pixel that is adjacent to the reference pixel.

7. A motion vector detecting apparatus according to claim 1, wherein
the evaluation value information forming unit generates the evaluation value information based on (i) an orientation of motion of the focus pixel for which a motion vector is determined and (ii) a state of a spatial gradient between at least one of the focus pixel and the reference pixel and adjacent pixels that are adjacent thereto in peripheral orientations for the focus pixel.

8. A motion vector detecting apparatus according to claim 7, wherein
the evaluation value information forming unit generates the evaluation value information using (i) a state of a spatial gradient between at least one of the focus pixel and the reference pixel and an adjacent pixel in a closest orientation to movement thereof and (ii) a state of a spatial gradient between at least one of the focus pixel and the reference pixel and an adjacent pixel in a second closest orientation to the movement thereof.

9. A motion vector detecting apparatus according to claim 8, wherein
the state of a spatial gradient for the adjacent pixels is a state of a spatial gradient for a closest orientation to movement of at least one of the focus pixel and the reference pixel and adjacent pixels in orientations of normals to the closest orientation.

10. A motion vector detecting apparatus according to claim 1, wherein
the evaluation value information forming unit generates the evaluation value information based on a state of a spatial gradient of at least one of the focus pixel and the reference pixel in an opposite direction to movement of the focus pixel for which a motion vector is determined.

11. A motion vector detecting apparatus according to claim 10, wherein
the state of a spatial gradient is a spatial gradient between one of the focus pixel and the reference pixel and an adjacent pixel thereof in the opposite direction to the movement.

12. A motion vector detecting apparatus according to claim 1, wherein
the evaluation value information forming unit generates the evaluation value information based on a movement direction of a focus pixel for which a motion vector is being determined, a state of a spatial gradient on levels at the focus pixel, and a state of a spatial gradient on levels at a reference pixel that is a movement destination candidate.

13. A motion vector detecting apparatus according to claim 1, wherein
the motion vector extracting unit sorts motion vectors indicated by the evaluation value information into order of frequency and extracts a predetermined number of motion vectors in order starting from a highest-order motion vector as the candidates.

14. A motion vector detecting apparatus according to claim 1, wherein
the motion vector deciding unit assigns motion vectors out of the motion vectors extracted as the candidates by the motion vector extracting unit to one of every pixel and representative pixels in a frame, determines correlation between (i) a pixel position assigned the motion vectors and a peripheral region thereof and (ii) a region of a motion destination, and sets motion vectors for regions with highest correlations as the motion vectors of the pixels.

15. A motion vector detecting method comprising the steps of:
forming, based on pixel value correlation information on correlation between (i) a focus pixel in one frame on a time axis out of moving image data including a plurality of frames and (ii) a reference pixel in a search area in another frame, evaluation value information on motion vectors where it has been evaluated that the reference pixel is a potential movement destination candidate for the focus pixel, the evaluation value information on the motion vectors being generated from the pixel value correlation information that has been one of generated and limited using a movement direction of the pixels;
extracting motion vectors as candidates from a plurality of motion vectors based on the evaluation value information formed in the step of forming the evaluation value information; and
deciding motion vectors to be assigned to pixels in a frame from the motion vectors extracted as the candidates in the step of extracting the motion vector.

16. A program for causing an information processing apparatus to carry out:
evaluation value information forming processing for forming, based on pixel value correlation information on correlation between (i) a focus pixel in one frame on a time axis out of moving image data including a plurality of frames and (ii) a reference pixel in a search area in another frame, evaluation value information on motion vectors where it has been evaluated that the reference pixel is a potential movement destination candidate for the focus pixel, the evaluation value information on the motion vectors being generated from the pixel value correlation information that has been one of generated and limited using a movement direction of the pixels;
motion vector extracting processing for extracting motion vectors as candidates from a plurality of motion vectors based on the evaluation value information formed by the evaluation value information forming processing; and
motion vector deciding processing for deciding motion vectors to be assigned to pixels in a frame from the motion vectors extracted as the candidates by the motion vector extracting processing.
